(19) United States
(12) Patent Application Publication
(10) Pub. No.: US 2006/0257925 A1
(43) Pub. Date: Nov. 16, 2006

(54) Method for isolating intracellular antibodies able to neutralize protein interactions

(75) Inventors: Michela Visintin, Roma (IT); Antonino Cattaneo, Roma (IT)

Correspondence Address: Albert Wai-Kit Chan;Law Offices of Albert Wai-Kit Chan, World Plaza Suite 604, 141-07 20th Avenue, Whitestone, NY, 11357, US

(73) Assignee: LINE GENOMICS S.P.A., Roma (IT)

(21) Appl. No.: 10/536,263

(22) PCT Filed: Nov. 21, 2003
(86) PCT No.: PCT/IT03/00764

§ 371 Date: Aug. 1, 2005

(30) Foreign Application Priority Data
Nov. 21, 2002 (IT) RM2002 A 000588

(51) Int. Cl. C40B 30/06; C40B 50/06

(52) U.S. Cl. 435/7.1; 435/254.2; 530/388.1

(57) ABSTRACT

A method is described for isolating neutralizing intracellular antibodies of an interaction between a protein ligand x and a protein ligand y inside a cell. A method to identify a protein ligand x able to bind to a known y ligand using intracellular antibodies able to disrupt the interaction between x and y is also described. A method for the isolation of a set of antibody fragments against a significant proportion of the protein-protein interactions of a given cell (interactome) or against the protein interactions that constitute an intracellular pathway or network is also described.

The present invention concerns a method for the isolation of stable intracellular antibodies, able to neutralize protein interactions. In particular, the invention concerns an antibody fragment library for isolating and expressing functional antibodies in the intracellular environment (intracellular antibodies), capable of interacting with specific target proteins in the intracellular environment. The invention concerns a method for the isolation of a set of antibody fragments against significant portion of the protein-protein interactions of a given cell (interactome) or against the protein interactions that constitute an intracellular pathway or network.

It is known that that antibodies can be used to interfere in a highly specific manner with biological processes inside the cell (Cattaneo and Biocca 1997) (Cattaneo and Biocca 1999) (Biocca, Neuberger et al. 1990). A specific intracellular expression can result in the inhibition of target protein function (protein knock-out). In this way, a phenotype of interest can be conferred to a cell or to an organism by a suitable intracellular antibody. In particular, protein knock-out represents an advantageous method to approach and resolve the bottleneck in functional genomics (from genes to function). In fact, genomic and proteomic programs provide a wealth of information for the identification of genes and proteins but not of their function. The solution of the problem of previous art could facilitate the identification and validation of target proteins for drug development as well. Protein knock-out has remarkable advantages over alternative methods (gene knock-out or RNA knock-out, antisense, ribozymes or RNAi) (Rossi 1999; Capecchi 1989; Fire 1999; Tavernarakis, Wang et al. 2000) since:
the protein is directly correlated with its biological function;
it permits post-transduction modified versions of the protein to be knocked out or the protein's compartmentalized subpopulations;
it allows modulation of knock-out intensity (gradual knock-out or knock down).

Since protein function very often depends on specific protein-protein interactions, antibodies or antibody fragments able to interfere with protein-protein interactions will allow selective and specific protein function neutralization, while allowing other functions of the same protein, depending on other protein interactions.

Intracellular antibody technology can be extremely useful for functional genomics since it exploits:
a virtually unlimited repertory of antibodies against any protein;
the possibility to direct these antibodies to sites where the protein exerts its function inside the cell, and
the possibility to obtain a specific and localized protein knock-out.

However, its application to functional genomics and to global proteomics requires the technology be implemented in a high-throughput process. This is why intracellular antibody technology is presently not applicable to functional genomics.

Intracellular antibody technology uses genes for specific antibodies that are suitably modified and obtained from the natural immune system (mouse or human) or from antibody libraries (synthetic or natural) exposed on the surfaces of filamentous phages as antibody fragments (phage display technologies, ScFv).

In terms of affinity, stability and solubility, the quality of antibody fragments isolated with phage display technology is proportional to the size of the library used for in vitro selection (Vaughan, Williams et al. 1996), given that the probability of finding an antibody with the properties of interest is proportional to the diversity of the library. This is why it is necessary to have large antibody libraries in order to obtain high-affinity antibodies capable of recognizing any antigen (Griffiths, Malmqvist et al. 1993) (Griffiths, Williams et al. 1994) (Sheets, Amersdorfer et al. 1998) (Vaughan, Williams et al. 1996) (Sblattero and Bradbury 2000). These libraries are tested with the antigens of interest, ligated in the solid phase; the antibodies are then selected by sequential cycles of absorption, washing, elution and growth. This selection procedure, however, does not ensure that selected antibodies are suitable for intracellular expression, since not all antibodies are able to function in the intracellular environment. At the current state of the art, the performance of antibodies suited for intracellular expression is not predictable a priori (Biocca, Ruberti et al. 1995; Proba, Worn et al. 1998), since the intracellular physicochemical conditions (cytoplasm and nucleus) differ greatly from those in which the antibodies are naturally found and normally synthesized (endoplasmic reticulum and secretory pathways).

Hence, an application of the technology to functional genomics requires a robust and predictable method to select a priori antibodies capable of functioning in the intracellular environment. An improvement has been achieved with the selection method based on a double-hybrid system (IACT or Intracellular Antibody Capture Technology) (Visintin et al. 1999; Visintin et al. 2002) and described in international patent application PCT WO 00/54057. Antibodies in the IACT format are able to interact with the corresponding antigen and result to be effective and functional when expressed as ordinary intracellular antibodies in the final user system. The IACT selection strategy is effectively diagnostic and predictive for the identification of functional intracellular antibodies starting from large libraries. The IACT technology has also been used in a derived procedure to rapidly and effectively identify the epitopes recognized by antibodies selected on their respective antigens (in vivo epitope mapping, IVEM, patent application RM2000A00561) (Visintin et al. 2002).

However, the development of IACT does not yet allow intracellular antibody technology to be applied to functional genomics, which requires a parallel throughput of at least 500 to 1000 genes to several thousand genes. Moreover, the IACT procedure does not ensure that selected antibody fragments are able to neutralize the function of the target protein. Only a subset of the selected antibodies, at most, will have the property of being neutralizing antibodies.

The solution to this problem constitutes the object of the invention, allowing a rapid, effective high-volume processing from genes to validated intracellular antibodies that are then expressed in appropriate cell models to study and neutralize the function of corresponding proteins.

In a specific implementation, the procedure described in this invention allows the direct isolation of antibody fragments able to specifically disrupt protein-protein interactions, thereby having the ability to selectively and specifically neutralize protein function. Therefore, the procedure described allows to isolate antibody fragments being validated intracellularly and protein function neutralizing.

As already mentioned, the use of IACT to isolate validated intracellular antibodies is severely limited by low cell transformation efficacy (yeast or mammal) where double-hybrid selection is operated, which, in turn, does not allow the introduction of antibody libraries (of scFv or single domain antibodies) with a diversity greater than 10⁵ antibodies, a range far from that required to ensure a significant probability of finding a clone with the desired properties (10¹⁰-10¹¹).

Presently, the IACT step is preceded by an enrichment of the library to reduce the diversity to levels compatible with the transformation in cells for the double-hybrid selection (FIG. 1) by using:
one or two absorption cycles on antigen columns in the solid phase in the case of a phage antibody library, or
immunization of a mouse with the antigen if the antibody library is prepared from mouse lymphocytes.

These steps are extremely costly and slow. Furthermore, for the first step a good phage display library is needed. In both cases the enrichment step requires the availability of a protein coded by the gene of interest. This creates a highly significant bottleneck since the functional genomics programs provide the genes (cDNA, EST, ORF, etc.) but not the protein. The possible pipelines at the current state of the art are, therefore, limited by the fact that for each group of genes of interest an ad hoc preselection must be carried out each time.

The solution to this problem is offered by the construction of an antibody library expressed directly in the double-hybrid rather than in the phage display format. The entire procedure to obtain intracellular antibodies starting from the genes as input is facilitated, shortened, accelerated and rendered more parallel since the genes of interest could be directly inserted into the vector for IACT selection or its modifications, thus short-circuiting the need to express and purify the corresponding proteins.

A further implementation with respect to the IACT system is to ensure the isolation of neutralizing intracellular antibodies. In fact, the IACT system ensures only the isolation of biologically functional antibodies in an intracellular environment but does not select for neutralizing antibodies.

### DESCRIPTION OF THE INVENTION

In the following, an intracellular antibody is a synthetic or recombinant antibody in a single chain format (scFv), FAb or single domain (dAb) antibody, able to fold and to be functional in an intracellular environment (i.e. cytoplasm, nucleus).

A library of intracellular antibodies shall comprise: a) library of intracellular antibodies in which the antibody genes are V regions derived from i) mouse lymphocytes; ii) lymphocytes derived from patients with autoimmune disease; iii) lymphocytes derived from healthy people; b) a library of intracellular antibodies of point a) obtained with the method of the genetic recombination by two homologous recombination sites (BIG-SPLINT); c) a library of intracellular antibodies engineered on particular frameworks designed on the basis of the intracellular consensus sequences present in intracellular antibodies.

A specific object of the invention is a method to isolate intracellular antibodies able to neutralize an interaction between a known protein ligand x and a known protein ligand y inside a cell, comprising the steps of:

a) obtaining a recombinant yeast strain wherein:

i) the protein ligand x and the protein ligand y are expressed, but
ii) at least one of x or y is expressed in an inducible manner, and
iii) the interaction between the protein ligand x and the protein ligand would lead to the production either of a repressor of an essential function of the yeast cell or of a toxic agent, so that non viable yeast cells would be obtained;
   b) constructing an expression library of intracellular antibodies in the recombinant yeast strain of point a);
   c) selecting transformed yeast clones by inducing the expression of both ligand x and ligand y, and
   d) isolating recipient yeast clones able to grow.

Another object of the invention is a method to isolate intracellular antibodies able to neutralize an interaction between a known protein ligand x and a known protein ligand y inside a cell, comprising the steps of:

a) obtaining an expression library of intracellular antibodies in a yeast strain with mat-a or mat-alpha sexual competence;

b) obtaining a recombinant yeast strain having a sexually competence opposite to that of the yeast strain in point a) wherein:

i) the protein ligand x and the protein ligand y are expressed, but
ii) at least one of x or y is expressed in an inducible manner, and
iii) the interaction between the protein ligand x and the protein ligand would lead to the production either of a repressor of an essential function of the yeast cell or of a toxic agent, so that non viable yeast cells would be obtained;
   c) exposing yeasts of point a) and recombinant yeasts of point b) to conditions able to promote sexual mating and the expression of the ligands x and y;
   d) selecting transformed yeast clones by inducing the expression of both ligand x and ligand y; and
   e) isolating recipient yeast clones able to grow.

In a preferred embodiment the recombinant yeast strain is obtained by:

a) cloning a first sequence encoding the protein ligand x and a second sequence encoding the protein ligand y into a yeast expression vector, each first and second sequence being under the control of each one of two portions of a bidirectional promoter, the first sequence being fused to a sequence encoding a first molecule, and the second sequence being fused to a sequence encoding a second molecule, so that when the protein ligand x and the protein ligand y interact said first molecule and said second molecule interact too in a way to induce the production either of a repressor of an essential function of the yeast cell or of a toxic agent;

b) transforming the recipient yeast strain with the vector of point a); and

c) selecting transformed yeasts.

Preferably the expression vector in yeast comprises as a bidirectional promoter the promoters Gal 1 and Gal 10.

Preferably the first and the second molecule leads to the production of a repressor able to shut down the transcription of the yeast HIS3 gene.

Preferably the expression library of intracellular antibodies in yeast is obtained from mouse or human lymphocytes.

Preferably the expression library of intracellular antibodies in yeast is obtained in a scFv or in a single domain antibody format.

It is another object of the invention an intracellular antibody able to neutralize an interaction between a protein ligand x and a protein ligand y inside a cell obtainable according to the method described. Preferably the intracellular antibody neutralizes the interaction between p65 RelA and p65 RelA; alternatively between p65 RelA and p50 NF-κB1; alternatively between Aβ 1-42 and Aβ 1-42; alternatively between JX-TK TrkA and PTB p66 Shc; alternatively between Synuclein and Synphilin.

It is another object of the invention a nucleotide sequence encoding the intracellular antibody as above defined.

It is another object of the invention a yeast expression vector for cloning a sequence encoding a protein ligand x and a sequence encoding a protein ligand y able to interact each other, comprising a bidirectional promoter wherein the first promoter portion is 5′ to 3′ followed by appropriate restriction cloning sites for the sequence encoding the protein ligand x and a first sequence encoding a first molecule; and the second promoter portion is 5′ to 3′ followed by appropriate restriction cloning sites for the sequence encoding the protein ligand y and a second sequence encoding a second molecule, so that when the protein ligand x and the protein ligand y interact, said first molecule and said second molecule interact too in a way to induce the production either of a repressor of an essential function of the yeast cell or of a toxic agent.

It is another object of the invention a method to simultaneously identify both a protein ligand x able to bind to a known protein ligand y inside an eukaryotic cell, and an intracellular antibody able to neutralize said interaction between the protein ligand x and the known protein ligand y, comprising the steps of:

a) obtaining an expression library of intracellular antibodies in a yeast strain with mat-a or mat-alpha sexual competence;

b) obtaining a recombinant yeast strain having a sexually competence opposite to that of the yeast strain in point a) wherein:

i) the protein ligand y is expressed in an inducible manner, and
ii) the interaction between the protein ligand x and the protein ligand y would lead to the production either of a repressor of an essential function of the yeast cell or of a toxic agent, so that non viable yeast cells would be obtained;
   c) cloning into a suitable yeast expression vector a cDNA library containing the sequence encoding the protein ligand x;
   d) transforming the yeast strain of point b) with the cDNA library of point c),
   e) selecting transformed yeasts;
   f) submitting the yeasts of point a) and the yeasts of point e) to such conditions to promote sexual reproduction and the expression of the bidirectional promoter in an environment able to induce the expression of the protein ligand x and protein ligand y;
   g) selecting viable yeast clones in which the interaction between the protein ligand x and the protein ligand y is disrupted by the intracellular antibody.

It is another object of the invention a method to simultaneously identify both a protein ligand x able to bind to a known protein ligand y inside an eukaryotic cell, and an intracellular antibody able to neutralize said interaction between the protein ligand x and the known protein ligand y, comprising the steps of:

a) obtaining an expression library of intracellular antibodies in a yeast strain with mat-a or mat-alpha sexual competence;

b) cloning a cDNA library containing the sequence encoding the protein ligand x and a sequence encoding the protein ligand y into a yeast expression vector, the cDNA library sequences being under the control of one of two portions of a bidirectional inducible promoter, the cDNA library sequences being fused to a sequence encoding a first molecule; and the sequence encoding the protein ligand y being under the control of the other of two portions of the bidirectional promoter, and being fused to a sequence encoding a second molecule, so that when the protein ligand x and the protein ligand y interact said first molecule and said second molecule interact too, in a way to induce the production either of a repressor of an essential function of the yeast cell or of a toxic agent;

c) transforming a yeast strain having a sexually competence opposite to that of the yeast strain in point a) with the recombinant yeast expression vector of point b);

d) selecting transformed yeasts;

e) submitting the yeasts of point a) and the yeasts of point d) to such conditions to promote sexual reproduction and the expression of the bidirectional promoter in an environment able to induce the expression of the protein ligand x and protein ligand y;

g) selecting viable yeast clones in which the interaction between the protein ligand x and the protein ligand y is disrupted by the intracellular antibody.

### DEATAILED DESCRIPTION OF THE INVENTION

The authors have developed an intracellular antibody library according to a method comprising the following steps (FIG. 2):

a) recovering DNA encoding the immunoglobulin natural V regions of B cells from spleen cells or peripheral lymphocytes by isolation of RNA, synthesis of complement DNA and amplification of DNA encoding light and heavy chains of immunoglobulins;

b) cloning said DNA using primers designed to contain restriction sites suitable for an expression vector comprising: 1) an antibiotic resistance gene different from the vector that expresses the protein x and y ligands, i.e. ampicillin; 2) a nutritional marker different from the vector that expresses the x and y protein ligands, i.e. LEU2; 3) replication origins for both E. coli (i.e. ColE1, f1) and for the yeast (i.e. 2μ); 4) a polylinker suitable for the insertion of an antibody library; 5) one or more nuclear localization signals downstream from the sequence encoding the scFv, but also FAb and antibody domains;

c) characterizing the library obtained by colony PCR-fingerprinting, and

d) selecting the SPLINT by IACT (SPLINT-2HY) on a known panel of antigens.

The vector of item b) is the vector pVP16/mv1 (FIG. 3).

To overcome the limitation posed by the low efficiency of yeast transformation the authors set up a technology, named BIG-SPLINT (FIG. 4a, FIG. 4b), that uses recombination events to obtain a larger intracellular library after creating smaller primary libraries. A recombination strategy has been described as an alternative to create scFv fragment libraries expressed in phages (Sblattero and Bradbury, 2000; PCT WO 00311246), but it was never been applied to get intracellular antibody libraries in eukaryotic cells. The event of recombination is applied to the SPLINT intracellular library and is based on a modification of the pVP16 vector so as to clone two lox recombination sites (lox P and lox P511) between VH and VL genes (pVP/16mv1-lox vector, FIG. 5). This system introduces a gene encoding the CRE recombinase induced by the GAL1 promoter only in the presence of galactose, integrated in the yeast genome. Initially, two mini-libraries are obtained in two pVP16/mv1-lox vectors that differ only in their nutritional and antibiotic markers. The VH and VL chains are then recombined after transformation (or mating) in the yeast strain containing the CRE recombinase gene, whose activity is induced only after the introduction of the two scFv libraries in the yeast strain (FIG. 4a, FIG. 4b).

The invention overcomes the previous technical problems by completely avoiding protein manipulation steps in the process “gene-intracellular antibody”, thus allowing the isolation of intracellular antibodies against any of proteins encoded by a genome, and permitting the isolation of intracellular antibodies against all protein-protein interactions in a cell.

The SPLINT technology of the invention is predictive for sequences preferred by antibodies in intracellular environments, thus augmenting the knowledge of the structure adopted by intracellular antibodies in physiologically incompatible environments, and leading to the formulation of a family of consensus sequences of antibody scaffolds validated for intracellular expression.

A preferred embodiment of the invention makes use of antibody sequences already validated by the IACT procedure according to the following method:

SUPER-SPLINT

As the selection procedures for intracellular antibodies are implemented, information is acquired on validated intracellular antibody sequences. Therefore various SPLINT generations (SUPER-SPLINT) may be obtained by using validated antibody sequences with the current IACT technology, as disclosed in the WO0054057 application, thus augmenting the intracellular stability and affinity of antibodies selected in vivo. The so called SUPER-SPLINT library is then obtained by grafting CDR (complementarity determining region) libraries on antibody scaffolds designed on the basis of information acquired from the study of validated intracellular antibodies. In this way, the size of the input library is smaller, thus permitting the antibody diversity to be increased in an antibody structure that is more targeted to intracellular expression.

The SPLINT libraries constitute an unlimited source of antibodies for a variety of uses in diagnosis, research, industry and therapy and, in general, for all those applications requiring more stable antibodies.

The SPLINT technology can be adapted to other cell types besides yeast, including E. coli and mammalian cells, so as to avoid the possible limitation of having antibodies against proteins expressed by the host cell.

The SPLINT technology offers a new field of application for intracellular antibodies not possible before, in the so-called inverse functional genomics or AntiGENomics (FIG. 6), that leads to the identification of proteins involved in a cellular function of interest. In this format, intracellular antibody libraries derived by SPLINT (SUB-SPLINT) are used in suitable cell lines, for example mammalian cell lines, to induce a phenotype of interest and to identify the proteins responsible for the underlying biological processes. The AntiGENomics method thus allows the identification of the proteins involved in a given biological function, and solves a typical bottleneck of proteomic screenings, namely to assign a function to the proteins identified.

The invention is now described according to following examples.

### FIGURES

FIG. 1. Diagram of IACT technology. The intracellular antibodies can be isolated after combination between the two-hybrid system and the phage display technology or after immunization of a mouse and the subsequent construction of a scFv or antibody domains (Tomlinson and Holliger, 2000) (Wu and Yazaki, 2000; Kortt et al., 2001; Todorovska et al., 2001) (Tanaka et al., 2003)) library on a vector that has expressed an activation domain. After in vivo selection in the yeast cell, the positive testing clones are isolated and the scFv can be used for in vitro and in vivo applications.

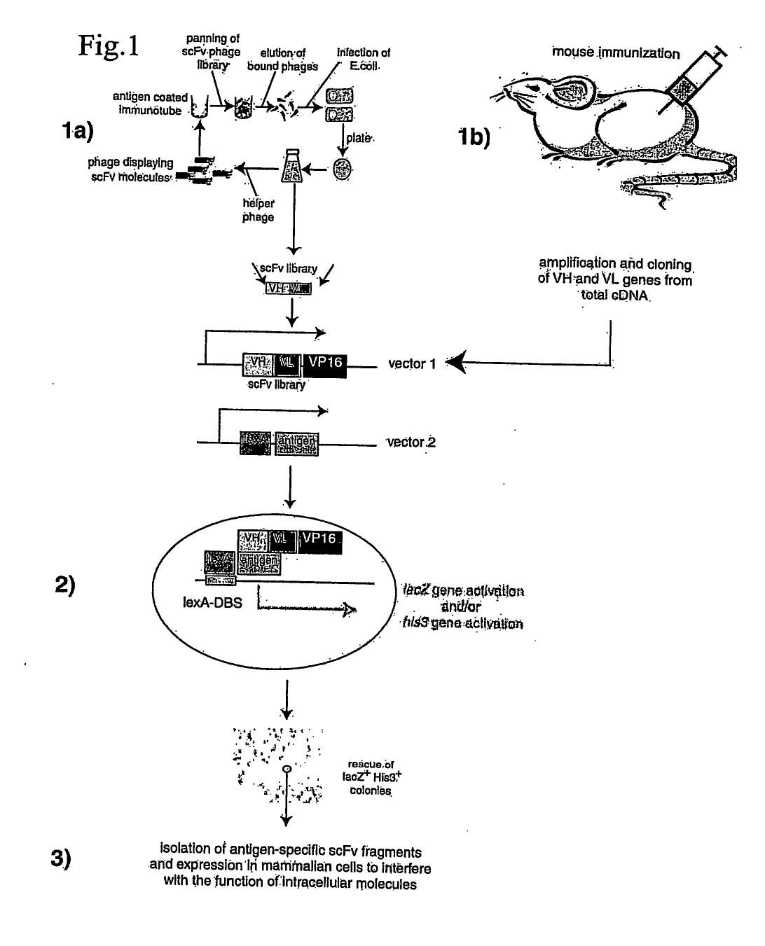

FIG. 2. Diagram of the construction of a SPLINT library: the antibody variable regions can be cloned directly from a non-immunized mouse on a vector that expresses the activation domain and two NLS fused in tandem after the scFv antibody fragment. The SPLINT library is then inserted in the yeast strain in an episomal form and can then be used for IACT screening immediately after transformation of the antigen to be used as bait.

FIG. 3. Diagram of the plinker220 and pVP16mv1 vectors. The vectors presents 2 NLS fused at the 3′ and 5′ ends of scFv for pLinker220 or 2 NLS fused in tandem after the scFv in pVP16mv1. The scFv library is transcribed by the ADH1 promoter. Downstream from the library, there is an ADH term termination sequence. The vector also contains the sequence that encodes the ampicillinase gene (bla), the gene sequence LEU2 (nutritional marker for selection in yeast), an E. coli origin of replication f1 and an yeast origin of replication 2μ.

FIG. 4 a-b. Diagram of the technology used to create a BIG-SPLINT library. In this system, two SPLINT libraries cloned in two pVP16mv1 vectors are used that differ only in antibiotic resistance to E. coli. The vectors present lox sites for heterologous recombination between the antibody chains. The gene encoding the CRE recombinase can be inserted or as a gene expressed by an inducible Gal1 promoter cloned in an episomal vector or can be present in the yeast strain previously constructed for this purpose.

FIG. 5. Diagram of the pVP16mv1-lox and pVP16 m2 kan vectors. The two vectors are conceptually identical to the pVP16mv1 vector. The only difference is that upstream and downstream from the scFv-VP16 construct there are two lox511-loxPWT sequences that are recognized by the CRE enzyme that starts to recombine the variable chains directly in the intracellular environment.

FIG. 6. Diagram of the AntiGENomics technology. The technology uses in vivo selection of a cDNA library created from a cell line and the SPLINT antibody library. After isolation of a large panel of Ag-scFv pairs, the isolated genes are identified and the scFv they recognize are sequenced. These scFv are then expressed as a cell-specific library (SUB-SPLINT) in vivo, in the target cell of interest and used to recapture in vivo the proteins expressed in the cell, either directly or after a phenotypic selection. The intracellular scFv-protein complexes are then immunoprecipitated using the scFv sequence tag and analyzed using classic proteomic techniques such as 2Degel and MS.

FIG. 7. Diagram of the vectors pMIC-BD1 and pMIC-BD2. The following vectors were constructed to express the antigen used as bait downstream from a DNA-binding domain (lexA). The two vectors differ only in the lack of NLS in pMIC-BD2, which was removed before mutagenesis. The ADH1 promoter promotes the transcription of the lexA-Ag fusion protein. Downstream from this construct there is an ADH1 term destruction sequence. The vector also has the sequence that encodes the chloramphenicol (cam) gene, the TRP1 gene sequence (nutritional marker for selection in yeast), an origin of replication f1 in E. coli and an origin of replication 2μ for the yeast.

FIG. 8. Diagram of the construction of the anti-GFP library. A mouse is immunized with the GFP protein. The mouse spleen is then used as a source of lymphocytes to extract the RNA encoding the immunoglobulin variable chains. Once the cDNA has been prepared, the variable chains are amplified with specific degenerated primers. The anti-GFP library in the scFv format is then cloned in the pVP16mv1 vector and screened against the GFP cloned in the pBMIC-BD1 vector.

FIG. 9. X-gal assay and PCR-BSTNI fingerprinting on anti-CH2-Shc clones isolated from the hyperimmune library obtained after immunization of mice with GFP protein and selected with the IACT method.

FIG. 10. The figure shows the various cloning steps of the SPLINT library: in the first panel to the left one can see the analysis of total RNA extracted from the nonimmunized mouse spleen. To the right, one can see the RT-PCR product reamplified with a mix of primers specific for the variable chains. The purpose of this step is to evaluate the quality of the cDNA before proceeding to amplification programmed with the various primer pairs (see table I). Below, one can see the analysis of the amplifications for the VH and VL with each degenerated primer pair. Lastly, after having quantified each single amplification for the VH and for the VL, each amplified product is mixed in equal concentrations; the final result is illustrated in the upper right photograph.

FIG. 11. Photograph of the VH and VL chain pull-through.

FIG. 12. a. Photograph of the SPLINT library assembly in the scFv format. b. PCR-BstNI fingerprinting of the SPLINT library after electroporation in the DH5αF′ strain.

FIG. 13. X-gal assay and PCR-BstNI fingerprinting on anti-SH2-Shc clones isolated from the SPLINT library selected with the IACT method.

FIG. 14. X-gal assay and PCR-BstNI fingerprinting on anti-K-RAS clones isolated from the SPLINT library selected with the IACT method.

FIG. 15. X-gal assay for secondary screening on anti-SH2-SHc and anti-K-RAS clones with respective antigens used as baits.

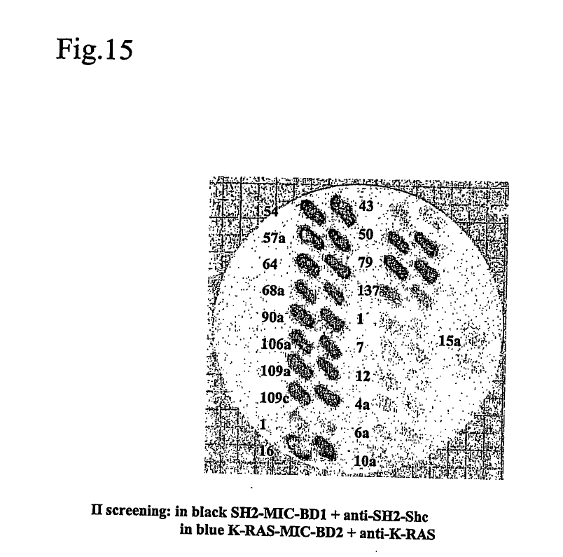

FIG. 16. X-gal assay and PCR-BstNI fingerprinting on anti-Syk clones isolated from the SLPINT library selected with the IACT method.

FIG. 17. Rescue scFv plasmids are reintroduced into original selection strain and into different bait strains to verify specificity. The isolated plasmid expressing the scFvs (i.e. anti-LTβ4) are reintroduced into strains containing target antigen (LTβ4) and another unrelated antigen (lamin). As an example clones b and h result to be specific only for LTβ4 and fail to interact with lamin antigen, thus confirming their specificity for LTβ4.

FIG. 18. Anti-LTβ4 scFv fragment specifically recognized LTβ4 and fail to recognize the UTβ4 bait. The thymosins are a family of small proteins entirely composed of a single WH2 domain, a ˜35 residue actin monomer-binding motif, that is found in many different regulators of the actin cytoskeleton. The lymphoid-specific thymosin encodes for an extra-six-residue NH2-terminal extension. Five antibody fragments obtained from the LTβ4 screening were tested for their ability to bind UTβ4. As shown in figure, all the scFvs tested result to be specific only for the lymphoid form and not for the ubiquitous one.

FIG. 19. Diagram of the method used with SPLINT in the three-hybrid system (see explanation in Results).

FIG. 20. Diagram of the pBiDi3HY, pBiDi3HYlexA-VP16 and pSLINT vectors. pBiDi3HYlexA-VP16 contains a bidirectional promoter for the expression of two cDNA libraries (1 and 2). Library cDNA1 is expressed as a fusion protein with lexA, whereas library cDNA2 is expressed as a fusion vector with VP16. Both libraries have two different stop sequences. The vector expresses as a nutritional marker for selection in the TRP1 yeast. The vector also has the sequence encoding the chloramphenicol gene (cam), an origin of replication f1 in E. coli and an origin of replication 2μ for the yeast. pSPLINT is a vector identical to pVP16mv1 but without the VP16 activation domain. This vector is used only to express scFv in the intracellular environment.

FIG. 21. Western blot analysis of lexA and VP16 proteins expressed upon induction with galactose in pBiDi3HYlexA-VP16 vector. After blotting, lexA was detected with the anti-lexA polyclonal antibody (Invitrogen) and VP16 with the anti-VP16 polyclonal antibody (Clontech).

FIG. 22. Western blot analysis of lexA-p65 and VP16-p65 fusion proteins expressed upon induction with galactose in pBiDi3HYlexA-VP16 vector. After blotting, lexA-p65 was detected with the anti-lexA polyclonal antibody (Invitrogen) and VP16-p65 with the anti-VP16 polyclonal antibody (Clontech).

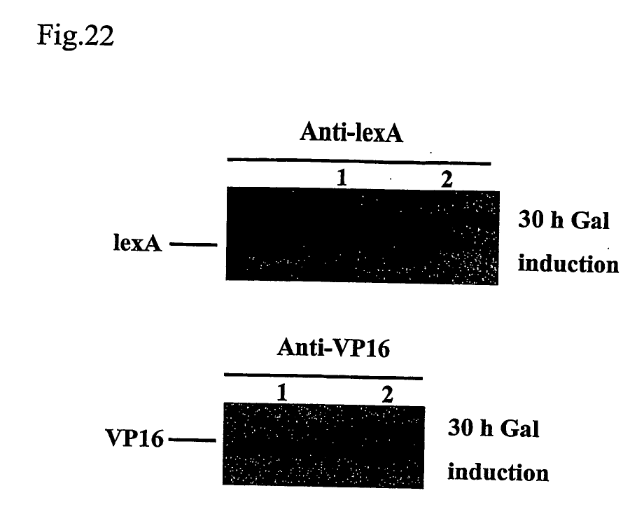

FIG. 23. p65 monomer-anti-p65 scFvs interactions in the yeast IACT system. L40 yeast cells were cotransformed with lexA-p65 bait vector and/or lamin bait with anti-p65 A1 or anti-p65 A2-VP16 fusions in pLinker220 vector. Yeast colonies were grown on -his plates and scored for β-gal assay. Clone A2 display a positive interaction with p65 monomer, thus indicating its specificity with the target protein. On the contrary, clone A1 was only able to recognize DNA-binding domain lexA.

FIG. 24. Immunofluorescence microscopy of the anti-p65 A2 scFv transiently transfected in HEK cells. Cells were reacted with the anti-SV5 tag monoclonal antibody followed by incubation with an anti-FITC-conjugated anti-mouse (Vector).

FIG. 25. HEK2973T cells were transiently transfected with anti-p65 A2 cloned in scFvex cyto-SV5 vector. Cell lysates were assayed for expression of p65 and p50 proteins (controls, c) and immunoprecipitation analysis with anti-p65 A2 or an irrelevant antibody. p65 protein was detected with anti-p65 (upper lane) and anti-p50 (lower lane) polyclonal antibody (Santa Crutz).

### VECTORS

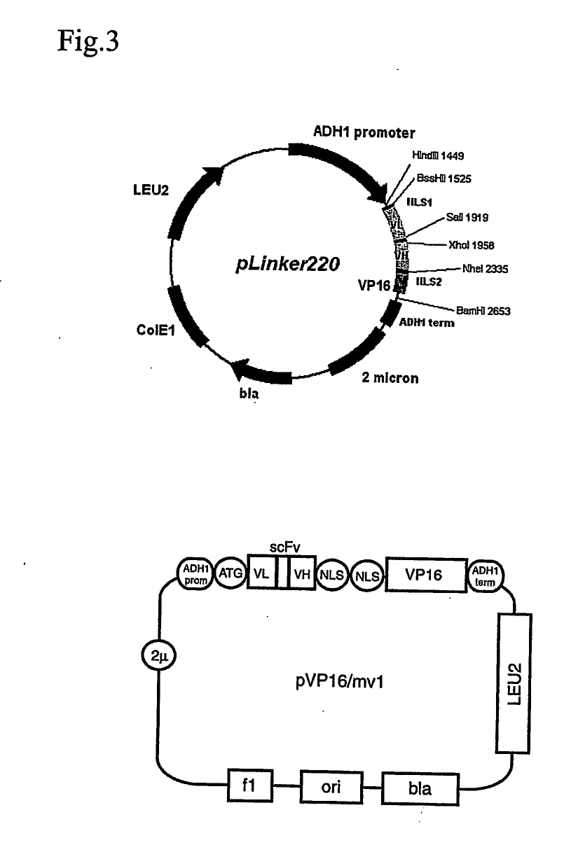

plinker220 (FIG. 3).

The vector for the expression of the scFvs or a library of scFv fragments was designed to contain a polylinker that can be used to clone antibody fragments that contain at their termini unique restriction sites identical to those present on the polylinker. To create this vector, the polylinker of the pDAN3 vector was cloned (Sblattero et al. 2000) in VP16* (Hollenberg et al. 1995). To obtain this vector, the VP16* vector was cut with the NcoI enzyme, treated with Calf Intestinal Phosphatase (CIP) and purified with a 0.75% agarose gel preparation. The pDAN3 polylinker (where a scFv was cloned beforehand) was amplified using the following oligonucleotides:

oligonucleotide POLY BACK:
TCGATTTCCACCATGGCGCCGAAAAAAAAGAGAAAAGTGGCCCAGCCGAG
CGCGCATGCCGATATTGTG
Oligonucleotide POLY FOR:
TTCTTGGGTGCCATGGCGGAGCTCGAAACGCTAGCTGAGGAGACGGTGAC
CGTGGT

The amplified fragment was then digested with the NcoI restriction enzyme and purified with 1.5% agarose gel. The two fragments were ligated using T4 DNA ligase. To confirm the perfect orientation of the insert and to confirm cloning, the vector was sequenced. The VP16 activation domain was then modified by removing several nonessential amino acids. To do this, the plinker200 was used as a template and VP16 was amplified using the following nucleotides:

VP16-220 back:
TCGAGCGGTACCGCTAGCGTTTCGAGCTCCGCCATGG
MIC-AD2 for:
CGGCCAGTGAATTCCTACTACCCACCGTACTCGTCAAT

The fragment containing the VP16 activation domain was then digested using the restriction enzymes NheI and EcoRI and cloned in the modified VP16 vector, cut in the same fashion, treated with Calf Intestinal Phosphatase (CIP) and purified with a 0.75% agarose gel preparation. The two fragments were ligated using T4 DNA ligase. The resulting vector was then called plinker220.

pVP16/mv1 (FIG. 3)

The expression vector of the scFvs or a library of scFv fragments, pVP16/mv1, was designed to contain a polylinker that can be used to clone antibody fragments containing at their termini unique restriction sites identical to those present on the polylinker. The two nuclear location signals were shifted to permit their tandem expression downstream from the scFv and immediately upstream from the VP16 activation domain. This shift yields a scFv without steric hindrance at its 5′ end, thus augmenting the specificity and folding of the antibody fragment fused to the VP16 activation domain at its 3′ end. pVP16/mv1 was constructed in the following way:

oligonucleotide MIC-AD1 back:
CAAACCGAAAAGCTTATGAGCGCGCATGCCGATATC

and a mixture of mouse VL oligonucleotides for the mix (Orlandi et al., 1992) were used to amplify a light chain cloned in plinker220. MIC-AD1 back contains the ATG start transcription codon and the restriction sites HindIII and BssHIII, while the mix of VL mouse oligonucleotides for the mixture contains the restriction site Sail. The DNA fragment amplified with these nucleotides was cut using the enzymes HindIII and SalI and purified with a 1.5% agarose gel preparation. The plinker220 vector was cut in the same fashion, treated with Calf Intestinal Phosphatase (CIP) and purified with a 0.75% agarose gel preparation. The two fragments were ligated using T4 DNA ligase. The resulting vector was then called pMIC-AD1.

pMIC-AD1 was used to prepare the final pVP16/mv1 vector. The following oligos were used:

MIC-AD2 back
CAAACCGCTAGCGCACCCAAGAAGAAGCGGAAGGTCGCACCCAAGAAGAA
GCGGAAGGTCCCAGGTGTACCGAGCTCG.

This nucleotide contains two nuclear location sequences (NLS) and the NheI restriction site.

MIC-AD2 for:
CGGCCAGTGAATTCCTACTACCCACCGTACTCGTCAAT.

This nucleotide contains the EcoRI restriction site.

The following nucleotides were used to amplify the VP16 activation domain from the plinker220 vector and to add upstream from it the two NLS encoded in tandem. The resulting DNA fragment was cut using NheI-EcoRI and purified with a 1.5% agarose gel preparation. The plinker220 vector was cut in the same fashion, treated with Calf Intestinal Phosphatase (CIP) and purified with a 0.75% agarose gel preparation. The two fragments were ligated using T4 DNA ligase to create the pVP16/mv1 vector.

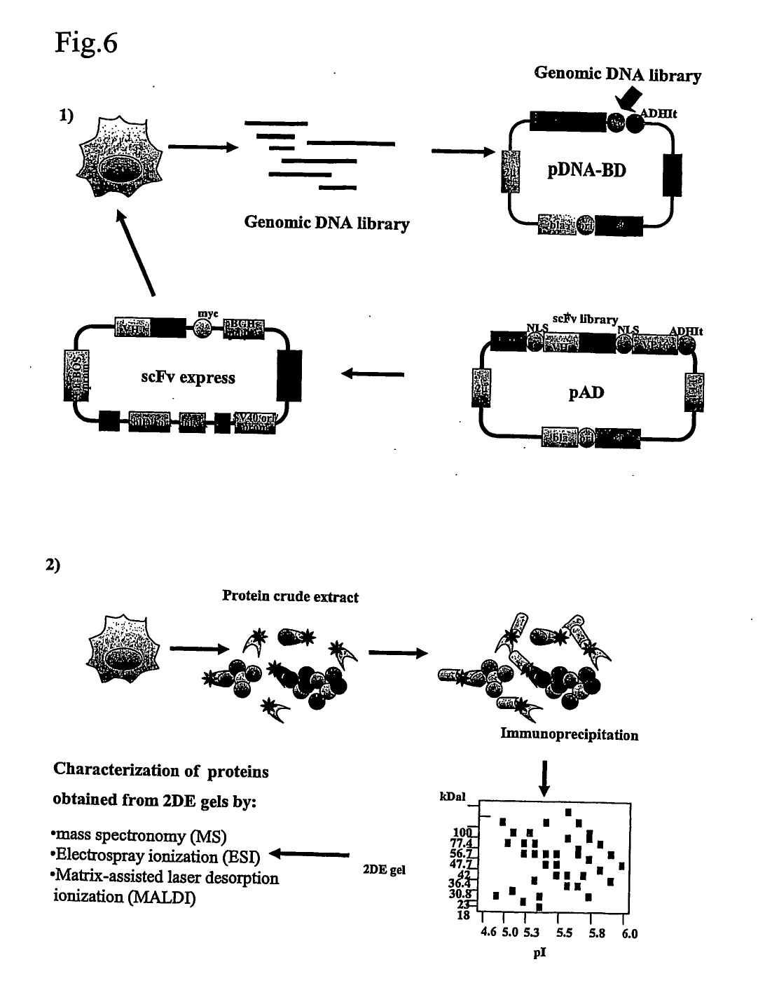

pMIC-BD 1 (FIG. 7)

The expression vectors pVP16/mv and pMIC-BD were designed to selectively change the resistance for expression in E. coli. The introduction of two different antibiotic resistances (ampicillin and chloramphenicol, respectively) permits the removal of the bait plasmid from the cotransformed cells with the two plasmids, thus eliminating the need for classic segregation in yeast, which is very long and costly.

The vector for the antigen expression in yeast was designed to contain a prokaryotic marker selectable by the antibiotic chloramphenicol. The pMIC-BD1 vector was constructed so: the sequence containing the region encoding the DNA-binding domain lexA, the transcription stop sequence of the ADH1 gene and a part of the TRP1 yeast gene was isolated from the pBTM116 vector (Bartel, Chien et al. 1993) by digesting the plasmid with HindIII. The fragment was purified with 1.5% agarose gel. The expression vector used as a backbone, pBD-GAL4 Cam (Stratagene), was also cut using HindIII, dephosphorylated with Calf Intestinal Phosphatase (CIP), purified with 0.75% agarose gel and ligated with the lexA-ADHIt-TRP1 fragment to create the pMIC-BD1. The correct orientation of the insert was confirmed by sequence analysis.

pMIC-BD2 (FIG. 7)

The lexA protein cloned in pMIC-BD1 was changed to abolish the nuclear location signal present inside the protein.

```
wt-lexA
GTT ACC GTT AAG CGC CTG AAA AAA CAG GGC AAT
  V T V K R L K K Q G N
mut-lexA
GTT ACC GTT AAG GGC CTG GAA AAA CAG GGC AAT
  V T V K G L E K Q G N
(Rhee et al., 2000).
```

The CGC and AAA codons of the region encoding lexA were then mutated in the following way:

lexA-NLS back oligonucleotide
AAGATGAAAGCGTTAACGGCCAGGCAACAAGAGGTG

that contains the restriction site HpaI, and

lexA-NLS for
AACGACAATTGGTTTAAACTCGCTATTTTCTGGCAACAGTTCGACTTTAT
TGCCCTGTTTTTCCAGGCCCTTAACGGT

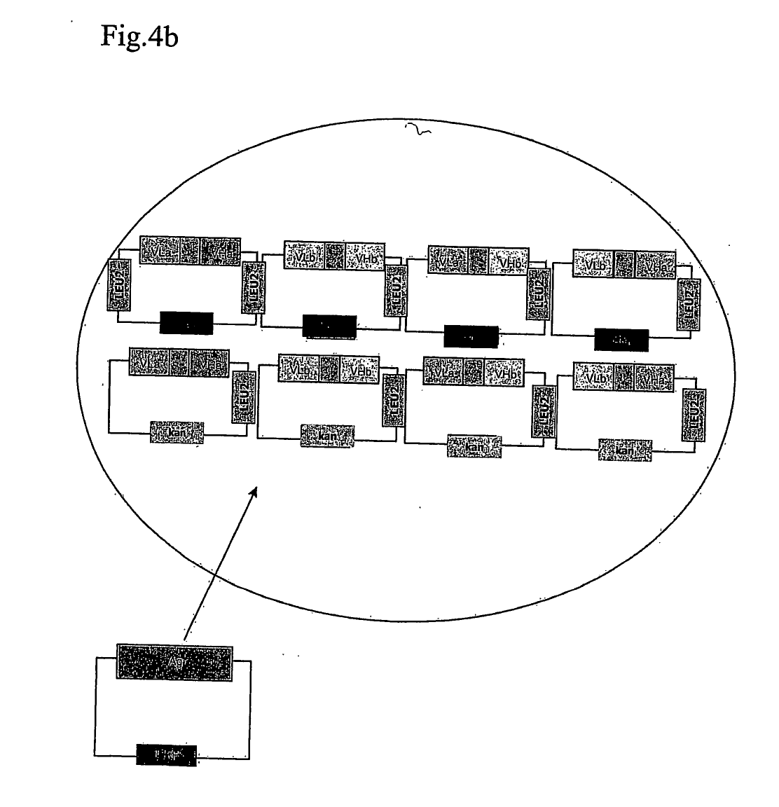

that contains the two mutations and the PmeI restriction sites were used to amplify a part of lexA. The DNA fragment amplified with these oligonucleotides was cut with enzymes HpaI and PmeI and purified with a 2% agarose gel preparation. The pMIC-BD1 vector was cut in the same fashion, treated with Calf Intestinal Phosphatase (CIP) and purified with a 0.75% agarose gel preparation. The two fragments were ligated using T4 DNA ligase. The resulting vector was then called pMIC-BD2.
pVP16mv1-lox and pVP16mv2-kan (FIG. 5)

As described in Sblattero D. et al 2000, the following recombination sequences were inserted in the pVP16mv1 vectors:

loxP511
ATA ACT TCG TAT AAT GTA TAC TAT ACG AAG TTA T
loxPWT
ATA ACT TCG TAT AAT GTA TGC TAT ACG AAG TTA T

The polylinker of the vector is modified so:

loxP511 linker
TCC GGA GGG TCG ACC ATA ACT TCG TAT AAT GTA TAC TAT ACG AAG TTA TCC TCG AGC GGT ACC
BspEI SalI loxP511 XhoI KpNI

The first lox site (loxP511) is added by pull-through of the variable chains VL and VH. The primers for variable chain pull-through were:

VH PTL lox back
GGA GGG TCG ACC ATA ACT TCG TAT AAT GTA TAC TAT
ACG AAG TTA TCC TCG AGC GGT A
VH PTMIC for
CCA GGC CCA GCA GTG GGT TTG GGA TTG GTT TGC CGC TA
VL PTL lox for
ACC GCT CGA GGA TAA CTT CGT ATA GTA TAC ATT ATA
CGA AGT TAT GGT CGA CCC TCC
VL PTMIC back
CGC TGG ATT GTT ATT ACT CGC AGC AAG CGG CGC GCA
TGC C

The second lox site (loxPWT) is added directly on vector pVP16 at 3′ of the VP16 activation domain. The VP16 gene is amplified from pVP16mv1 with the following primers:

VP16loxPWT for (cutting with BamHI)
CTA TCT ATC TAg gat ccA TAA CTT CGT ATA GCA TAC
ATT ATA CGA AGT TAT CCC ACC GTA CTC GTC AAT
VP16 back (cutting with HindIII)
GGC TAA AGC TTA TTT AGG TGA CAC TAT

The amplification products are then directly added as fragment Hind III-Bam HI on the vectors cut with the same enzymes pVP16mv1 and pVP16mv1-kan. The kan gene+ColE1 are inserted in vector pVP16* as an amplification product amplified by the plasmid pZero-2 (Invitrogen) and cloned in the sites DraIII and AaTII.

Kan DraIII back
Ccg atc gga cac CAG GTG CTG TCA GAA GAA CTC GTC
AAG AAG GC
ColE1 AaTII for
AA TGA AAT GCA TCG GGA CGT CCT TCC GCT TCC TCG CTC
ACT GAC

Having cloned colE1 and the gene for kanamycin resistance, the vector is changed as previously described to obtain the pVP16mv2-kan vector.

Recombination of the variable chains takes place in vivo in the yeast cell. The CRE gene, which encodes recombinase, is transcribed by the Gal1 inducible promoter. pGal1-CRE can be a plasmid integrated in the yeast strain or an episomal vector can be introduced with antibiotic resistance (neomycin) that expresses CRE under the Gal1 promoter. CRE can, for example, be cloned in a pESC vector (Stratagene) controlled by the Gal1 promoter. In this vector, antibiotic resistance (G418, neomycin) can be cloned to promote selection of this plasmid in the yeast cell. Gene G418 is transcribed by the Gal10 promoter, which is a bidirectional promoter with respect to Gal1. Both promoters are induced in the presence of galactose in a culture medium, thus permitting the control of CRE enzyme recombinase expression.

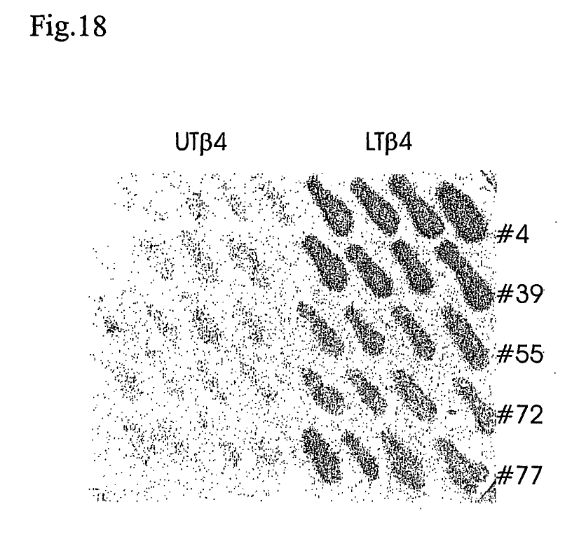

pBiDi3HY Vector (FIG. 18):

to construct pBiDi3HY vector 2 vectors were used. The pESC-TRP vector (Stratagene) was PvuII cutted to isolate the bidirectional promoters Gal1-Gal10. The pMIC-BD1 vector was SphI cut and DNA polymerase I, Large (Klenow) fragment was subsequently used to remove the 3′ overhangs to form blunt ends. The vector was also dephosphorylated with calf intestinal alkaline phosphatase to prevent recircularization of cloning vector. Cloning of Gal1-Gal10 PvuII digested into pMIC-BD1 SphI cut and blunt generated pBiDi3HY.

pBiDi3HYlexA-VP16 Vector (FIG. 18):

the DNA fragment VP16 was amplified from VP16* vector (Hollenberg et al., 1995) and cloned between the BamHI/ApaI of pBiDi3HY plasmid.

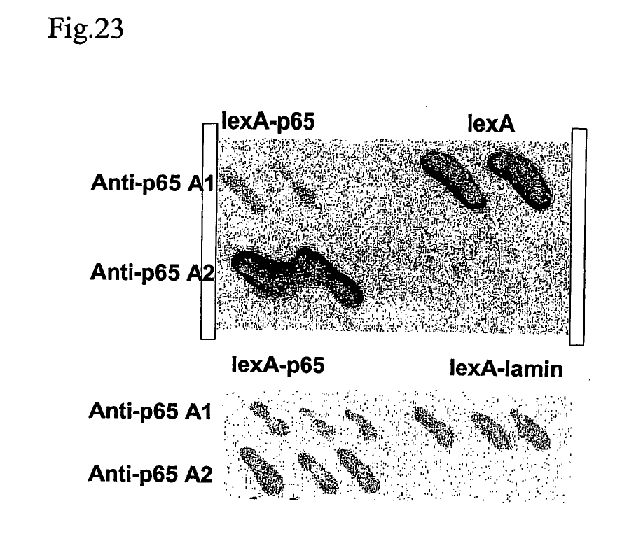

The DNA fragment lexA was amplified from pMIC-BD1 and cloned between the EcoRI/SpeI of pBiDi3HY-VP16 vector. The final vector pBiDi3HY-lexA-VP16 was sequenced and the expression of lexA and VP16 proteins was verified by western blot analysis of yeast crude extract after induction of promoters with galactose 20% (see FIG. 23).

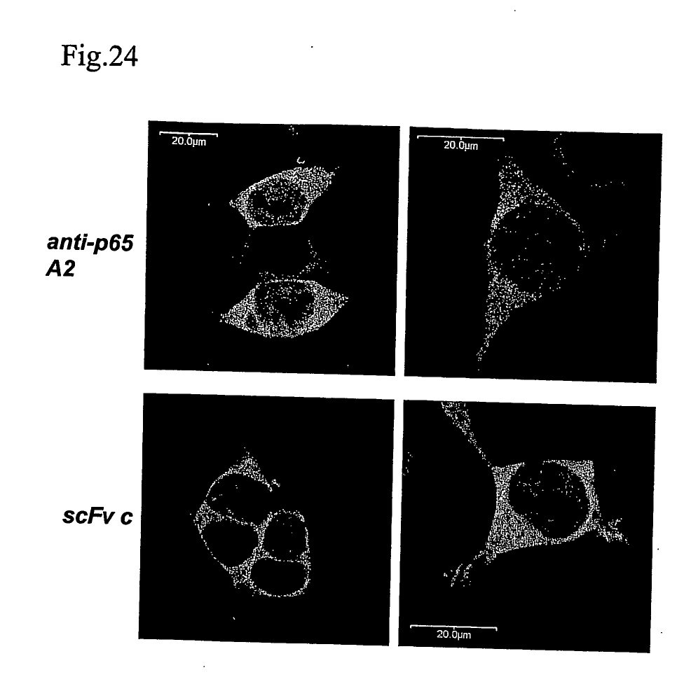

pBiDi3HYlexAP65-VP16p65 vector: the member of NF-kB/Rel family p65 protein, was cloned as C-terminal fusion protein with lexA and VP16 domains. The DNA fragment p65 was amplified from pRSV NF-kB relA (p65) plasmid and cloned into SpeI to produce lexA-p65 fusion protein and between ApaI/SalI to produce VP16-p65 fusion protein. The expression of both p65 fusion proteins were verified by western blot analysis and sequences (see FIG. 24).

All clones were sequenced, using the Epicentre Sequitherm Excel II kit (Alsbyte, Mill Valley, Calif.), with a Li-Cor 4000L automatic sequencer (Lincoln, Nebr.).

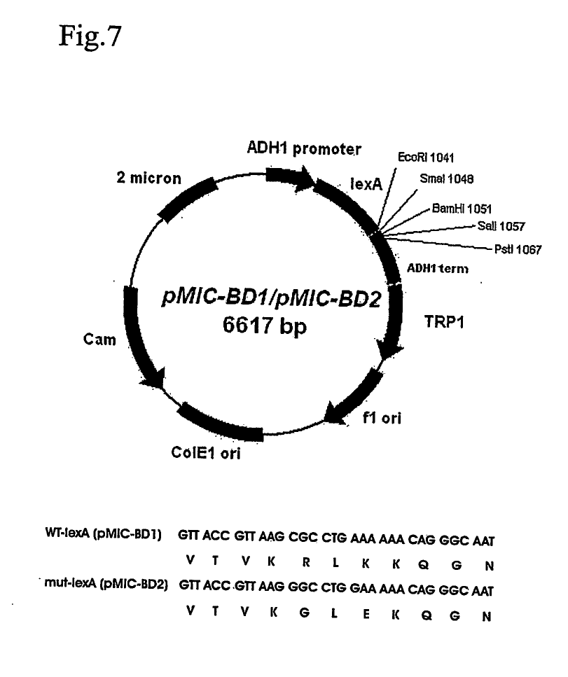

Construction of a Library of an Immunized Mouse (Anti-GFP) (FIG. 8)

In the preparatory work leading to this invention, within the development of IACT technology, antibody libraries were constructed from the spleens of mice immunized against various antigens of interest, including EGFP (green fluorescent protein) (Prasher et al., 1992), human protein Aβ1-42 and others. The selection of these libraries against the immunized antigens does not constitute a novel aspect but is mentioned because it introduces the unexpected result described in the paragraph below.

Protein EGFP was expressed in E. coli and purified according to a standard protocol developed by (Baird et al., 1999). EGFP was then conjugated with BSA (bovine serum albumin) to augment its immunogenicity in so far as GFP is a highly compacted protein. 0.7 mg of the purified protein (both native and conjugated GFP) were used for the initial immunization of three mice. The subsequent boosts contained 1.0-1.7 mg of the purified protein (˜200-500 μg of purified protein per mouse).

After about 2 months, the immunized mouse sera was analyzed by ELISA. The results showed that the mice presented a high titer of antibodies against GFP (we can find specific anti-GFP antibodies in analyzed sera also at higher dilutions, i.e. 1:10000). The spleens were then removed and used for RNA extraction.

The immunoglobulin variable regions were amplified using V-region PCR (Orlandi et al., 1992), using the following primers (Table I):

TABLE I

Panel of degenerated primers used for the
construction of SPLINT libraries

VH mouse BACK:

| | |
|---|---|
| TTA TCC TCG AGC GGT ACC GAK GTR MAG CTT CAG GAG TC | HB1 |
| TTA TCC TCG AGC GGT ACC GAG GTB CAG CTB CAG CAG TC | HB2 |
| TTA TCC TCG AGC GGT ACC CAG GTG CAG GTG AAG SAS TC | HB3 |
| TTA TCC TCG AGC GGT ACC GAG GTC CAR CTG CAA CAR TC | HB4 |
| TTA TCC TCG AGC GGT ACC CAG GTY CAG CTB CAG CAR TC | HB5 |
| TTA TCC TCG AGC GGT ACC CAG GTY CAR CTG CAG CAG TC | HB6 |
| TTA TCC TCG AGC GGT ACC CAG GTC CAC GTG AAG CAG | HB7 |
| TTA TCC TCG AGC GGT ACC GAG GTG AAS STG GTG GAA T | HB8 |
| TTA TCC TCG AGC GGT ACC GAV GTG AWG YTG GTG GAG TC | HB9 |
| TTA TCC TCG AGC GGT ACC GAG GTG CAG SKG GTG GAG TC | HB10 |
| TTA TCC TCG AGC GGT ACC GAK GTG CAM CTG GTG GAG TC | HB11 |
| TTA TCC TCG AGC GGT ACC GAG GTG AAG CTG ATG GAR TC | HB12 |
| TTA TCC TCG AGC GGT ACC GAG GTG CAR CTT GTT GAG TC | HB13 |
| TTA TCC TCG AGC GGT ACC GAR GTR AAG CTT CTC GAG TC | HB14 |
| TTA TCC TCG AGC GGT ACC GAA GTG AAR STT GAG GAG TC | HB15 |
| TTA TCC TCG AGC GGT ACC CAG GTT ACT CTR AAA GWG TST G | HB16 |
| TTA TCC TCG AGC GGT ACC CAG GTC CAA CTV CAG CAR CC | HB17 |
| TTA TCC TCG AGC GGT ACC GAT GTG AAC TTG GAA GTG TC | HB18 |
| TTA TCC TCG AGC GGT ACC GAG GTG AAG GTC ATC GAG TC | HB19 |
| VH mouse FOR: | |
| GAT TGG TTT GCC GCT AGC TGA GGA GAC GGT GAC CGT GGT | HF1 |
| GAT TGG TTT GCC GCT AGC TGA GGA GAC TGT GAG AGT GGT | HF2 |
| GAT TGG TTT GCC GCT AGC TGC AGA GAC AGT GAC CAG AGT | HF3 |
| GAT TGG TTT GCC GCT AGC TGA GGA GAC GGT GAC TGA GGT | HF4 |
| YL mouse BACK: | |
| AGC AAG CGG CGC GCA TGC CGA YAT CCA GCT GAC TCA GCC | LB1 |
| AGC AAG CGG CGC GCA TGC CGA YAT TGT TCT CWC CCA GTC | LB2 |
| AGC AAG CGG CGC GCA TGC CGA YAT TKT GMT VAC TCA GTC | LB3 |
| AGC AAG CGG CGC GCA TGC CGA YAT TGT GYT RAC ACA GTC | LB4 |
| AGC AAG CGG CGC GCA TGC CGA YAT TGT RAT GAC MCA GTC | LB5 |
| AGC AAG CGG CGC GCA TGC CGA YAT TMA GAT RAM CCA GTC | LB6 |
| AGC AAG CGG CGC GCA TGC CGA YAT TCA GAT GAY DCA GTC | LB7 |
| AGC AAG CGG CGC GCA TGC CGA YAT YCA GAT GAC ACA GA | LB8 |
| AGC AAG CGG CGC GCA TGC CGA YAT TGT TCT CAW CCA GTC | LB9 |
| AGC AAG CGG CGC GCA TGC CGA YAT TGW GCT SAC CCA ATC | LB10 |
| AGC AAG CGG CGC GCA TGC CGA YAT TST RAT GAC CCA RTC | LB11 |
| AGC AAG CGG CGC GCA TGC CGA YRT TKT GAT GAC CCA RAC | LB12 |
| AGC AAG CGG CGC GCA TGC CGA YAT TGT GAT GAC BCA GKC | LB13 |
| AGC AAG CGG CGC GCA TGC CGA YAT TGT GAT AAC YCA GGA | LB14 |
| AGC AAG CGG CGC GCA TGC CGA YAT TGT GAT GAC CCA GWT | LB15 |
| AGC AAG CGG CGC GCA TGC CGA YAT TGT GAT GAC ACA ACC | LB16 |
| AGC AAG CGG CGC GCA TGC CGA CAG GCT GTT GTG ACT CAG GAA TC | LBL |
| YL mouse FOR: | |
| GAA GTT ATG GTC GAC CCT CCG GAA CGT TTK ATT TCC AGC TTG G | LF1/2 |
| GAA GTT ATG GTC GAC CCT CCG GAA CGT TTT ATT TCC AAC TTT G | LF4 |
| GAA GTT ATG GTC GAC CCT CCG GAA CGT TTC AGC TCC AGC TTG G | LF5 |
| GAA GTT ATG GTC GAC CCT CCG GAA CCT AGG ACA GTC AGT TTG G | LFL |

To create a library that is as representative as possible, single amplifications were performed using each oligonucleotide described above according to the following schemes:

| | HB1 | HB2 | HB3 | HB4 | HB5 | HB6 | HB7 | HB8 | HB9 | HB10 | HB11 | HB12 | HB13 | HB14 | HB15 | HB16 | HB17 | HB18 | HB1 |
|---|---|---|---|---|---|---|---|---|---|---|---|---|---|---|---|---|---|---|---|
| HF1 | x | X | x | x | x | x | x | x | x | x | x | x | x | x | x | x | x | x | x |
| HF2 | x | X | x | x | x | x | x | x | x | x | x | x | x | x | x | x | x | x | x |
| HF3 | x | X | x | x | x | x | x | x | x | x | x | x | x | x | x | x | x | x | x |
| HF4 | x | X | x | x | x | x | x | x | x | x | x | x | x | x | x | x | x | x | x |

| | LB1 | LB2 | LB3 | LB4 | LB5 | LB6 | LB7 | LB8 | LB9 | LB10 | LB11 | LB12 | LB13 | LB14 | LB15 | LB16 | LBL |
|---|---|---|---|---|---|---|---|---|---|---|---|---|---|---|---|---|---|
| LF1/2 | x | x | x | x | x | x | x | x | x | x | x | x | x | x | x | x | |
| HF3 | x | x | x | x | x | x | x | x | x | x | x | x | x | x | x | x | |
| HF4 | x | x | x | x | x | x | x | x | x | x | x | x | x | x | x | x | |
| HF5 | x | x | x | x | x | x | x | x | x | x | x | x | x | x | x | x | |
| LFL | | | | | | | | | | | | | | | | | x |

This procedure allows verification of the library quality, without having to introduce a prevalence of determinate variable regions that are more easily amplified than others. In this specific case, 141 individual amplifications are carried out, starting from the cDNA obtained from the total RNA extracted from the immunized mouse spleen. The conditions used to amplify the variable chains were:

cDNA 0.5 μl; H₂O 30.5 μl; 10×PCR buffer 5 μl; dNTP 2.5 mM each 5 μl; MgCl₂ 25 mM 3 μl; Oligo1 (10 pmol/μl) 2.5 μl; Oligo 2 (10 pmol/μl); 2.5 μl Taq polymerase 1 μl are mixed.

Mineral oil (50-100 μl) is added to prevent evaporation in the test tube containing the reaction mixture. The tube is then placed in a thermocycler programmed as follows:

94° C.-5′, (94° C.-1′ 60° C.-1′ 72° C.-1′) for 30 cycles; 72° C.-10′; 4° C.-24 h.

After the variable regions have been amplified, they are analyzed on a 1.5% agarose gel and quantified. The same quantity of DNA for each amplified products is then used for cloning. A total of 10 μg of a variable chain is then used for each cloning.

An initial VL library is created.

The light chains were processed as follows:

VL DNA mix 10 μg; BssHII (NEB 20 U/μl) 1.5 μl; Buffer 3 (NEB) 10 μl; H₂O Q.S. (final V=100 μl).

The reaction mixture is incubated at 50° C. for 8 h. The digested chains are then purified with 1.5% gel using a purification kit (Gel extraction kit, Qiagen). The purified DNA is then digested using the SalI enzyme according to the following scheme: VL DNA mix BssHII 100 μl; SalI (NEB 20 U/μl) 1.5 μl; Buffer Sal (NEB) 2 μl; H₂O 78.5 μl.

The reaction mixture is incubated at 37° C. for 8 h. The digested chains are then purified with a 1.5% gel using a purification kit (Gel extraction kit, Qiagen). After purification, the DNA is quantified on 1.5% agarose gel and analyzed under spectrophotometry at a wavelength of 260 nm.

10 μg of the pVP16/mv1 vector are cut in the same fashion: pVP16/mv1 DNA10 μg; BssHII (NEB 20 U/μl) 1.5 μl; Buffer 3 (NEB) 10 μl; H₂O Q.S. (final V=100 μl).

The reaction mixture is incubated at 50° C. for 8 h. The digested chains are then purified with 0.75% gel using a purification kit (Gel extraction kit, Qiagen). The purified DNA is then digested using the SalI enzyme according to the following scheme: pVP16/mv1 BssHII 100 μl; SalI (NEB 20 U/μl) 1.5 μl; Buffer Sal (NEB) 20 μl; H₂O 78.5 μl.

The reaction mixture is incubated at 37° C. for 8 h. The digested vector is dephosphorylated with Calf Intestinal Phosphastase (CIF) and purified with 0.75% agarose gel. After purification, the DNA is quantified on 0.75% agarose gel and analyzed under spectrophotometry at a wavelength of 260 nm. pVP16/mv1 (BssHII-SalI-CIP) is then tested in E. coli to verify total digestion and dephosphorylation by electroporation of a known quantity of digested DNA incubated overnight with ligase or only in H₂O. After the vector background from a partial digestion of the vector or its religation has been verified (the background must be equal to or as close as possible to 0), pVP16/mv1 (BssHII-SalI-CIP) is then ligated with the light variable regions purified in a proportion of insert:vector=5:1.

About 6 μg of the vector is used in the ligase mixture. The ligase reaction is then left overnight at 16° C., the ligase is then inactivated for 10 min at 70° C.; the ligase mix is then purified in the following way: 1 purification step with phenol (1:1); 1 purification step with phenol-chloroform (1:1); 1 purification step with chloroform-isoamyl (25:24:1) DNA precipitation with 3 volumes of sodium acetate/ethanol (solution 1 ml NaAc pH 5.2+27.5 ml EtOH). Wash the precipitated DNA with 200 μl of 70% EtOH. The DNA pellet is then resuspended in 20-30 μl of distilled H₂O.

10-40 ng of the purified ligase is then used for each electroporation. DH5αF′ or TG1 is then made electrocompetent with the following method (Engberg et al., 1996) about 3-4 E. coli colonies are inoculated in 100 ml 2YT and grown at 37° C. until O.D. 0.8-1. Two 50-ml flacon tubes are filled and left on ice for about 10 min. Thereafter, all steps are carried out in the cold room at 4° C. The tubes are centrifuged for 8 min at 3500 rpm at 4° C. The supernatant is removed. Each pellet is resuspended in 2 ml of 10% iced glycerol buffer (10% sterile glycerol in distilled sterile H₂0). The resuspended bacteria are then brought to a volume of 50 ml in a glycerol buffer. The tubes are centrifuged for 8 min at 3500 rpm at 4° C. The supernatant is eliminated. The pellets are resuspended in 2 ml of 10% iced glycerol buffer and transferred to a falcon tube. The bacteria are then brought to a volume of 50 ml in a glycerol buffer. Two further washings are performed according to the scheme described from points 6 to 8. Lastly, the final pellet is resuspended in 1 ml and brought to 3 ml in 10% glycerol buffer. The tubes are centrifuged for 8 min at 3500 rpm at 4° C. The supernatant is removed. The final pellet is resuspended in 125 μl 10% glycerol buffer. The bacteria are then divided into aliquots (30 μl per tube) in 0.5 ml Eppendorf tubes and conserved for about 1 month at −80° C.

The electroporator is set to 1800 V and the electrocompetent cells, together with the cuvettes, are placed on ice and cooled for about 10-15 min.

For each electroporation, 30 μl of bacteria plus 1 μl of ligase mixture (10-40 ng DNA) are used. After transformation, the bacteria are resuspended in 1 ml of SOC medium+10 mM MgCl₂ and incubated for 1 h at 37° C. The bacteria are then seeded on LB+ampicillin plates. The next day, the efficacy of transformation is evaluated. To control the diversity of the VL library, 100 colonies are sampled at random from the plate and analyzed by PCR-fingerprinting using the BstNI restriction enzyme. After diversity has been confirmed, the bacteria are collected from the plate and frozen at −80° C. in 20% glycerol.

The assembly of the VH chains with the VL chains is performed directly on the VL library. About 10 μl is removed from the VL library glycerolate and inoculated in 50 ml LB+Amp overnight. The next day, the DNA for VH chain cloning is prepared. The heavy variable chains are processed as follows: VH DNA mix 10 g; XhoI (NEB 20 U/μl) 1.5 μl; NheI (NEB 20 U/μl) 1.5 μl; Buffer 2 (NEB) 10 μl; BSA (10 mg/ml) 1 μl; H₂O Q.S. (final V=100 μl). The reaction mixture is incubated at 37° C. for 8 h. The digested chains are then purified with a 1.5% gel using a purification kit (Gel extraction kit, Qiagen). After purification, the DNA is quantified on 1.5% agarose gel and analyzed under spectrophotometry at a wavelength of 260 nm.

10 μg of the VL library is cut in the same fashion: VH DNA mix 10 μg; XhoI (NEB 20 U/μl) 1.5 μl; NheI (NEB 20 U/μl) 1.5 μl; Buffer 2 (NFB) 10 μl; BSA (10 mg/ml) 1 μl; H₂O Q.S. (final V=100 μl). The reaction mixture is incubated at 37° C. for 8 h. The digested vector is dephosphorylated with Calf Intestinal Phosphastase (CIF) and purified with 0.75% agarose gel. After purification, the DNA is quantified on 0.75% agarose gel and analyzed under spectrophotometry at a wavelength of 260 nm. The VL library (XhoI-NheI-CIP) is then tested in E. coli to verify total digestion and dephosphorylation by electroporation of a known quantity of digested DNA incubated overnight with ligases or only in H₂O. After the vector background from a partial digestion of the vector or its rebinding is verified (the background must be equal to or as close as possible to 0), the library is then ligated with the heavy variable regions purified in a proportion of insert: vector=5:1.

Thereafter, the procedure is continued as described above by the preparation of the VL library. A good library should have about 10⁶-10⁷ different scFv/μg of the DNA used. The pVP16/mv1 vector library is then assayed with GFP bait (immunizing antigen).

The GFP bait was amplified from pEGFP-N1. The amplification primers of the GFP gene were: GFP sense: CCG GTC GAA TTC ATG GTG AGC AAG GGC GAG GAG and GFP antisense: TGA TCT GGA TCC GCG GCC GCT TTA AGT GAT CCC GGC. Since previous experiments showed that GFP alone was able to transactivate the transcription of the reporter genes in the yeast system, a mutant of the GFP deletion was used for this experiment. The literature reports that the removal of the last 8 amino acids of the GFP maintains the fluorescent activity of the protein and its conformation unchanged (Siegel and Isacoff, 1997).

The DNA fragment amplified with these oligonucleotides was then cut with enzymes EcoRI and BamHI and purified with a 1.5% agarose gel preparation. The pMIC-BD1 vector was cut in the same fashion, treated with Calf Intestinal Phosphatase (CIP) and purified with a 0.75% agarose gel preparation. The two fragments were ligated using T4 DNA ligase.

To verify transactivation of the bait GFP, self-activation of reporter gene transcription was tested according to the transformation steps shown below:

| | | YC selection | HIS3 | LacZ |
|---|---|---|---|---|
| bait | Prey | medium | phenotype | phenotype |
| LexA-GFP | | -W | / | white |
| LexA-GFP | | -WHUK | / | |
| LexA-GFP | VP16/mv1 | -WL | | white |
| LexA-GFP | VP16/mv1 | -WHULK | / | |

Having confirmed the non transactivation of the bait GFP and its good expression in the yeast strain (a yeast extract transformed with bait GFP is tested by western blot analysis using a primary antibody that recognizes the lexA protein), selection of the library in yeast cells is performed. L40 expressing bait GFP is transformed with 100 μg of scFv anti-GFP library according to the protocol described below:

Day 1: inoculation of L40 containing bait GFP in 5 ml of YC-UW overnight;

Day 2: inoculation of 100 ml of YC-UW with an aliquot of the overnight culture in order to have a dilution that allows the algorithmic growth phase to be reached the next day;

Day 3: the overnight culture is transferred in 1 l of heated YPAD to obtain a culture with an OD 600=0.3; the yeast is grown at 30° C. for 3 h, the cells are centrifuged at 1500 rpm for 5 min at room temperature; the yeast pellet is washed with 500 ml of 1×TE and then centrifuged at 1500 rpm for 5 min at room temperature; the pellet is resuspended in 20 ml of 1×LiAC, 0.5×TE and transferred to a fresh flask; 100 μg of scFv anti-GFP library and 1 ml of denatured salmon sperm are added; 140 ml of 1×LiAc, 40% PEG 3350, 1×TE; the product is mixed and incubated in a low-speed agitator for 30 min at 30° C.; 17.6 ml of DMSO are added and mixed. Thermal shock is performed for 10 min at 42° C. while agitating occasionally. The product is quickly cooled by adding 400 ml of YPA. The yeast is pelleted by centrifugation and washed once with 500 ml of YPA. After centrifugation, the pellet is resuspended in 1 l of YPAD preheated to 30° C. The product is incubated for 1 h at 30° C.; 1 ml of the culture is isolated and the pellet obtained by centrifugation of this ml is resuspended in 1 ml of YC-UWL. Dilutions of 1:10, 1:100, and 1:1000 are seeded on YC-UWL plates to calculate the efficiency of the transformation. The pellet obtained from the remaining culture is washed twice with YC-WHULK. The final pellet is resuspended in 10 ml of YC-WHULK. The aliquots are plated on YC-WHULK plates and after 3-4 days the colonies that have grown are analyzed to determine the interaction.

96 colonies grown on YC-WHULK and testing blue on beta-Gal assay were analyzed by PCR-fingerprinting analysis using the BstNI restriction enzyme. The analysis of digestion patterns and scFv sequences isolated from the HIS+lacZ+ colonies permit the isolation of about a dozen different scFv that recognize the bait (also further to a second screening in yeast cells, the same bait that expresses GFP with scFv isolated in L40 is transformed) for each selection. The isolated scFv were then cloned in a scFv expression vector (Persic, Righi et al. 1997) for expression in mammalian cells and simultaneously in pUC119CAT for expression and production of the protein in E. coli. The binding affinity of the proteins purified with the affinity column was analyzed using plasmonic surface resonance. On average, the scFv isolated with IACT have an affinity constant of 100-500 nM. The scFvs expressed in vivo in mammalian cells (COS, CHO, PC12, C6, etc.) bind the target protein and in most cases manage to dislocate the same from its cellular expression environment if they are expressed with localization signals differing from those of antigen expression. Also, neutralizing scFv can be found that inhibit antigen function or the antigen can be neutralized by taking it to another cell compartment using the Ag-Ab specific binding.

The results of this selection demonstrate that the enrichment obtained by immunization allows the construction of a library with a size adequate for yeast tnansformation and with a diversity wide enough to ensure the isolation of a panel of numerous antibodies against the immunizing protein.

Similar results have been obtained with a library created from the spleens of mice immunized against protein Aβ 1-42, a human protein, from which numerous antibodies against the immunizing protein were derived (see table 2).

At this point, a surprising and completely unexpected result emerged from the screening of the hyperimmune spleen-derived libraries with bait constructed from proteins not relevant to immunization.

Selection of a Hyperimmune SPLINT Library Against Antigens Different from that Used for Immunization

The libraries obtained from immunized mouse spleens (mice immunized with GFP), as described in the paragraph above, were screened against protein Shc (a protein that regulates cell growth, apoptosis and lifespan) and human Aβ1-42 (the highly amyloidogenic component accumulation linked to the pathogenesis of Alzheimer's disease).

A functional domain of the Shc protein (CH2-Shc) and the human Aβ1-42 were cloned in the pMJC-BD1 vector and expressed in yeast to control the capacity of the two antigens to transactivate the reporter genes.

Construction of the Baits:

CH2-Shc/MIC-BD1: the DNA fragment CH2-Shc was PCR amplified from pGEX4T1-p66Shc and cloned between EcoRI/BamHI restriction sites of pMIC-BD1 plasmid.

Aβ 1-42/MC-BD1: the DNA fragment of beta amyloid 1-42 domain was synthesize by primers annealing and then cloned into BamHI PstI restriction sites of pMIC-BD1 plasmid.

The pMIC-BD vector was constructed to be used in a yeast strain that kept the reporter genes under the control of the operator site for protein lexA. This vector also permits a rapid extraction of positive clones, after verification of an antibody-antigen interaction in a two-hybrid system that uses as a vector containing the activation domain an ampicillin-resistant plasmid in that it utilizes chloramphenicol as the phenotype marker in E. coli. All antigens were tested in vivo as described elsewhere (Visintin and Cattaneo 2001) (Visintin, Tse et al. 1999) and the expression of the fusion proteins was assayed after the proteins were extracted from the transformed yeast strain. All antigens were found to be expressed in optimum quantities in the yeast and not to transactivate the reporter genes (HIS3 and lacZ).

CH2-Shc was selected as the antigen for library screening. The efficiency of the transformation of the library was about 2.5×10⁴ clones/μg DNA. Unexpectedly, hundreds of positive colonies (Table III) were also obtained after the library was plated after the first day of transformation (see protocol in Visintin and Cattaneo 2001). The protocol used here was the same as that described above (see Construction of a library of an anti-GFP immunized mouse)

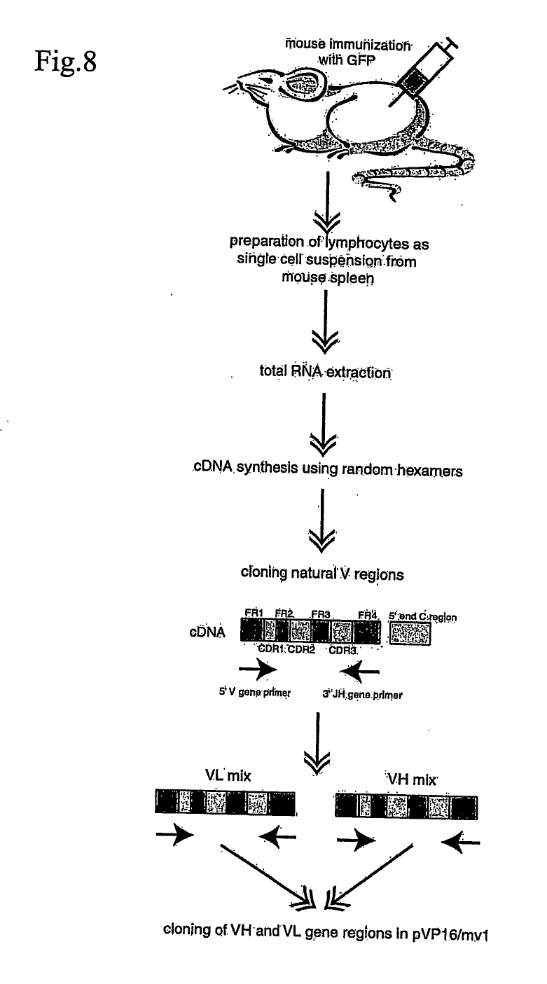

After about 15 min., the colonies turned blue on X-Gal assay, an indication that the observed interactions were quite strong. Twenty blue colonies were isolated and the plasmids containing the scFv fragments to be analyzed were rapidly isolated after extraction of total DNA from the yeast and transformed in E. coli. Analysis by PCR-BstNI-fingerprinting and a second two-hybrid screening yielded the following results (FIG. 9): 19 scFv, 9 classes of different scFv. Of the 9 classes of scFv, 8 tested specific against CH2-Shc and not against an irrelevant antigen (laminin) used for the screening. Likewise, in a separate selection from a library derived from a spleen hyperimmune for an unrelated antigen, and challenged with the Aβ 1-42 bait, a high number of different antibody domains against the Aβ 1-42 protein were isolated (data not shown, table III).

TABLE III
Selection of ICAbs with different antigen specificities.

| | | n. of | n. of | |
|---|---|---|---|---|
| | cfu/μg | His3⁺-lacZ⁺ | His3⁺-lacZ⁺ | n. |
| | SPLINT-DNA | rescued | analyzed | positive |
| Antigen | in L40 | clones | clones | clones |
| CH2-Shc | 2.4e10⁶ | 430 | 20 | 8 |
| SH2-Shc | 3.7e10⁶ | 189 | 20 | 5 |
| K-RAS | 4.4e10⁶ | 27 | 27 | 2 |
| Syk | 1.4e10⁶ | 3000 | 10 | 6 |
| UTβ4 | 3e10⁷ | 300 | 96 | 3 |
| LTβ4 | 2.1e10⁶ | 123 | 123 | 13 |
| Gephyrin | 2.6e10⁶ | 5824 | 50 | 5 |
| TFII-I | 1.29e10⁶ | 1000 | 96 | 4 |
| Aβ 1-42 | 1.2e10⁶ | 900 | 66 | 6 |
| ORF X5 | 6.8e10⁵ | 34 | 34 | 6 |
| SARS-CoV | | | | |

These results were obtained in just 1 month from the beginning of bait cloning (vector controls and rescreening included) and demonstrated the rapidity and precision of the system in obtaining antibodies against any protein of interest. The antibodies were then cloned in a phagemid vector to produce soluble scFv for the in vitro specificity tests ELISA and plasmon surface resonance.

The conclusion is that although the selection libraries were hyperimmune toward the respective immunizing antigens (and contained numerous antibodies against the immunizing proteins, as demonstrated in the paragraph above), they also represent an optimum source of intracellular antibodies against generic proteins. Hence, they represent SPLINT libraries and demonstrate that the spleen-derived libraries have unexpected properties required for SPLINT libraries, i.e. a size adequate for yeast cell transformation, although with a diversity wide enough to permit the isolation of antibodies against generic antigens.

The unexpectedly positive outcome obtained from a hyperimmune library, which should be enriched only for antibodies against immunizing antigens, laid the foundation for the experiment described below, i.e. the construction of a SPLINT library starting from a pool of mouse spleens that were not expressly immunized.

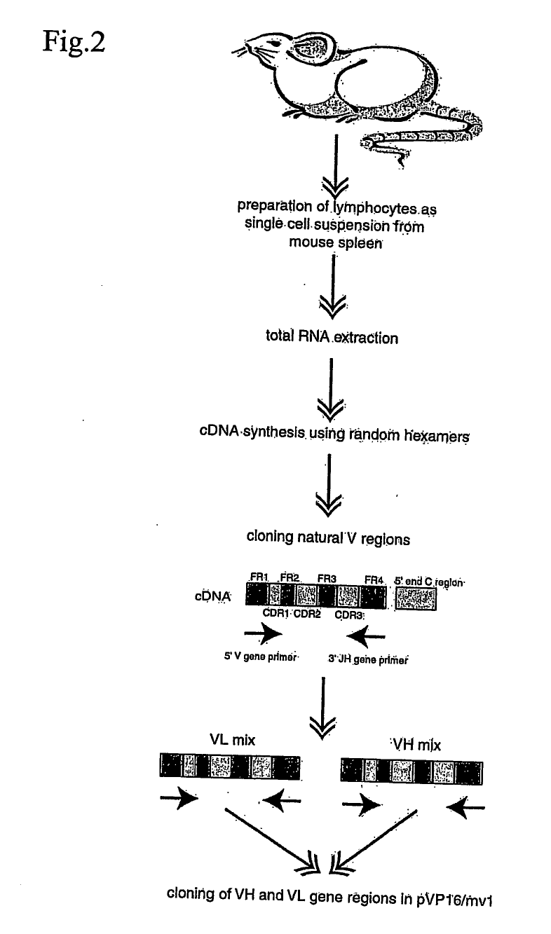

SPLINT Library from Non-Immune Mouse Lymphocytes (FIG. 2)

Construction of SPLINT Library

The spleen is rich in B cells and is an optimum tissue from which lymphocytes can be relatively easily extracted without needing to purify them by long and laborious methods. Mouse spleens (extracted from freshly sacrificed 3-6-month-old mice) were washed and cleaned in PBS and the lymphocytes released by pressing the spleen with a hypodermic needle and a sterile spatula. The cell suspension was then transferred to a sterile tube and left to deposit for 5 min. The supernatant was then removed and the cells washed twice in PBS and H₂O to remove the red blood cells. The cells were then immediately used for total RNA extraction. The total RNA was extracted using a kit (Rneasy Mini Kit, Qiagen) according to the manufacturer's protocols. After extraction, the RNA was quantified (about 30 μg from 10 mg of original tissue) and used for cDNA synthesis using random primers (GIBCO Br1). The synthesis of the DNA complementary to individual RNA filaments was obtained by using Superscript II Rnase H-Reverse Transcriptase enzyme (GIBCO Br1).

The following protocol was used for the production of cDNA: Random primers (3 μg/μl); 1 μl (100 μg); RNA total 5 μl; dNTP mix (10 mM each dATP, dGTP, dCTP, dTTP at physiologic pH) 1 μl; H₂O DEPC 5 μl. The mix is heated to 65° C. for 5 min, then rapidly cooled on ice. The content of the tube is collected after brief centrifugation and First-strand buffer 5×4 μl, DTT 0.1M 2 μl are added. The tube content is mixed and then incubated for 2 min at 42° C., after which 1 μl (200 U) of Superscript II is added and incubated for 50 min at 42° C. The reaction is inactivated at 70° C. for 15 min. 1 μl (2 U) of RNAseH is added to remove the residual RNA bound to the formed DNA and is left for 20 min at 37° C. The cDNA can then be used to amplify the variable chains.

To obtain cDNA from the immunoglobulin variable regions, the V regions were amplified by PCR using degenerated 5′ and 3′ primers (Table I) that permit the amplification of a greater number of variable chains.

The amplification primers of the variable chains are identical to those described in the section Construction of an anti-GFP immunized mouse library.

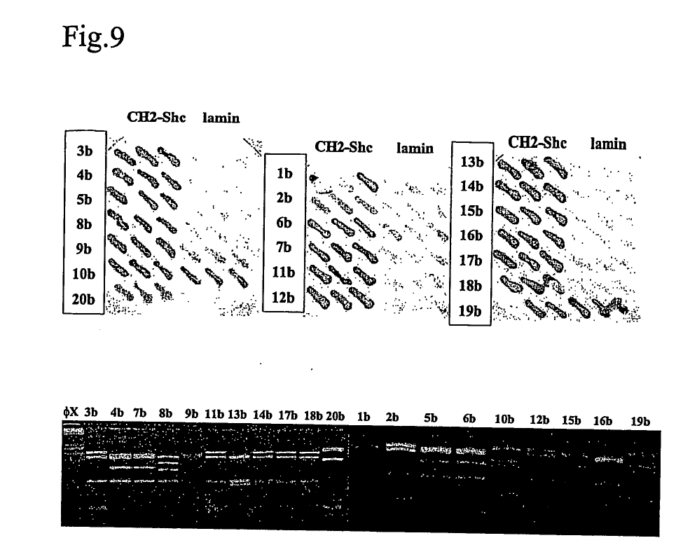

A total of 141 amplifications were performed to be certain that a major number of antibody families were expressed in the final library. The single antibody chain amplifications are shown in FIG. 10.

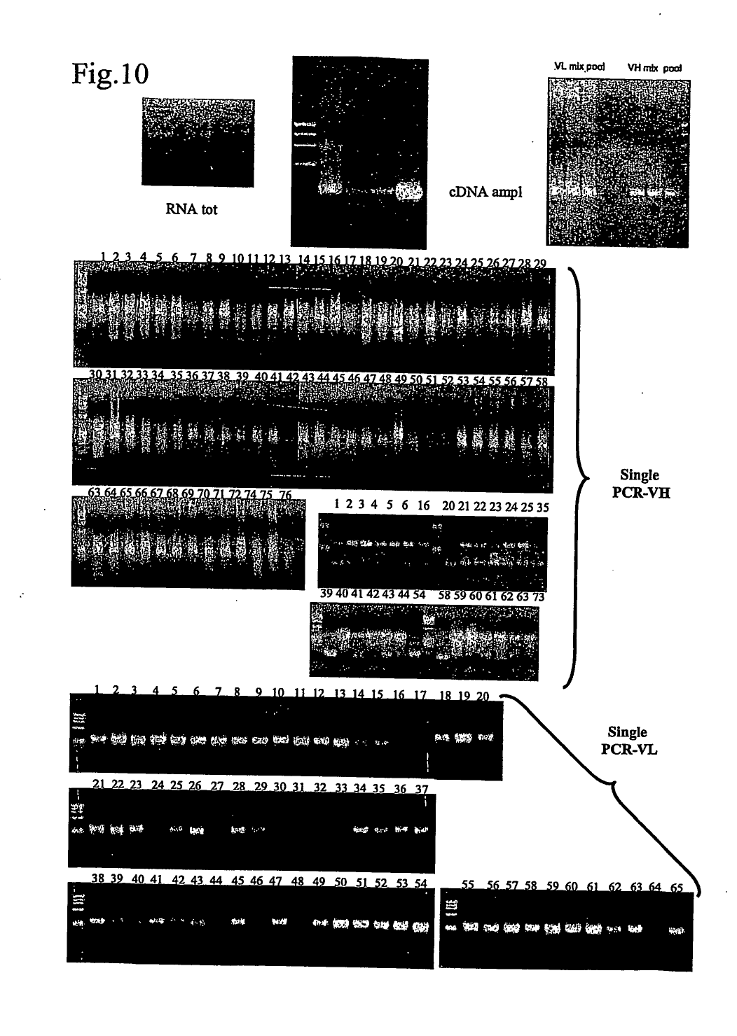

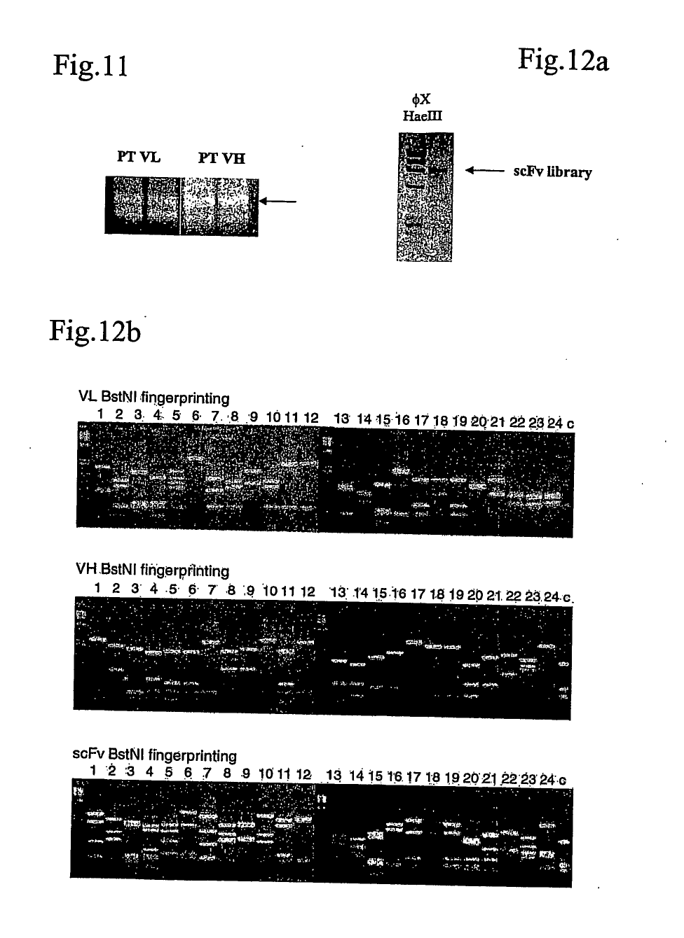

After all the VL and the VH variable regions have been amplified from the cDNA, they are reamplified to increase the quantity of DNA for cloning and to add extra sites to each terminus of the variable region previously amplified with the degenerated primers. After the variable chains (PTVL and PTVH) have undergone pull through, the amplified products are purified with gels (see FIG. 11). After purification, the PTVL and the PTVH are used for in vitro assembly. The pull through is used to insert a small polypeptide chain (called linker) that, after in vitro assembly, is in turn needed to reconstruct the single chain sequence (see FIG. 12). The assembly was done in a single step rather than in two steps as described in the section on anti-GFP library cloning because a problem was noted in sequential cloning of the variable chains in the VP16mv vector. A possible explanation for this is the poor transformability of the pLinker220 vector in E. coli and the possible partial amplification of several variable chain families that make cloning in this vector particularly difficult.

The primers used for pull through were:

VH PTL 220 BACK
GGA GGG TCG ACC AGC GGT TCT GGG AAA CCA GGT TCC
GGT GAA GGC TCG AGC GGTA
VH PTMIC FOR
CCA GGC CCA GCA GTG GGT TTG GGA TTG GTT TGC CGC TA
VL PTL 220 FOR
ACC GCT CGA GCC TTC ACC GGA ACC TGG TTT CCC AGA
ACC GCT GGT CGA CCC TCC
VL PTMIC BACK
CGC TGG ATT GTT ATT ACT CGC AGC AAG CGG CGC GCA
TGC C

The pull-through protocol was: VL 5 μl (˜100 ng); VL PTL 220 FOR 5 μl; VL PTMIC BACK 5 μl; MgCl₂ 2 μl; dNTPs 10 μl; buffer 10×10 μl; Taq polymerase 2 μl; H₂O 61 μl; VH 5 μl (˜100 ng); VH PTL 220 BACK 5 μl; VH PTMIC FOR 5 μL; MgCl₂ 2 μl; dNTPs 10 μl; buffer 10×10 μl; Taq polymerase 2 μl; H₂O 61 μl.

Mineral oil (50-100 μl) is added to prevent evaporation in the test tube containing the reaction mixture. The tube is then placed in a thermocycler programmed as follows:

94° C.-5′; (94° C.-30″, 60° C.-30″, 72° C.-30″) for 20 cycles; 72° C.-10′; 4° C.-24 h.

After the pull-though band for the VH and VL is isolated, the chains are purified with gel and the amplified products are used for in vitro assembly. In all, about 200 ng of DNA is used for the reaction (100 ng of PTVL and 100 ng of PTVH).

The assembly reaction primers are:

VH PT2 FOR
TGG TGA TGG TGA GTA CTA TCC AGG CCC AGC AGT GGG
TTT G
VL PT2 BACK
TAC CTA TTG CCT ACG GCA GCC GCT GGA TTG TTA TTA
CTC

The reaction is: PTVL 100 ng; PTVH 100 ng; VL PT2 BACK (100 μM) 0.5 μl; VH PT2 FOR (100 μl) 0.5 μl; dNTPs 10 μl; Buffer 10×10 μl; MgCl₂ 2 μl; Taq polymerase 2 μl; add H₂0 to 100 μl. Mineral oil (50-100 μl) is added to prevent evaporation in the test tube containing the reaction mixture. The tube is then placed in a thermocycler programmed as follows: 94° C.-5′; (94° C.-30″, 68° C.-30″, 72° C.-30″) for 8 cycles without primers and 12 cycles with primers; 72° C.-10′; 4° C.-24 h.

After assembly of the VH and the VL, the assembled scFv library is purified with gel as described above. After purification, the DNA is digested with enzymes NheI and BssH2 in the following way: DNA mix 10 μg; NheI (WEB 20 U/μl) 1.5 μl; Buffer 2 (NEB) 10 μl BSA (10 mg/ml) 1 μl; H₂O Q.S. (final V=100 μl), and left to digest for 4 h at 37° C. After digestion and purification with gel, the DNA is cut with BssH2: DNA mix 10 μg BssH2 (NEB 20 U/μl) 1.5 μl; Buffer 3 (NEB) 10 μl; H₂O Q.S. (final V=100 μl).

The reaction mixture is incubated at 50° C. for 4 h. The digested chains are then purified with 1.5% gel using a purification kit (Gel extraction kit, Qiagen). After purification, the DNA is quantified on 1.5% agarose using spectrophotometry at a wavelength of 260 nm. The library is then ligated in the vector pLinker220: about 200 ng of vector were used for this step; ligation was performed in gradient to optimize the reaction. The reaction mix is: pLinker220: 1 μl (200 ng); VL-VH assembly: 2 μl (250 ng); Ligase: 1 μl (400 U/μL); Buffer: 1 μl; H₂O: 5 μl; The reaction mixture is placed in an Eppendorf tube and incubated overnight in a beaker filled with water at 18° C. in the cold room. The next day, the reaction tube is removed from the cold room and 1 μl of ligase is added and left at room temperature for 2 h. After incubation, the reaction mix is purified with phenol-chloroform (as described above), resuspended in 10 μl of H₂0, and then electroporated in the bacterial strain.

For each electroporation, 30 μl of bacteria plus 1 μl of ligase mix is used (max. 100 ng per electroporation). After transformation, the bacteria are resuspended in 1 ml of SOC medium+10 nM MgCl2 and incubated for 1 h at 37° C., after which they are seeded on LB+ ampicillin plates. The next day, the efficiency of the transformation is evaluated. The library thus obtained was estimated to be about 4.10⁵ CFU.

At this point, the SPLINT library was used for the control test such as PCR-fingerprinting to test library diversity, antibody sequences taken randomly, western blot analysis to check the expression of the individual chains in yeast and screening on a panel of known antigens.

The results demonstrate that even from this initial SPLINT library intracellular antibodies against a wide variety of antigens can be isolated.

Description and List of Antigens (Table II):

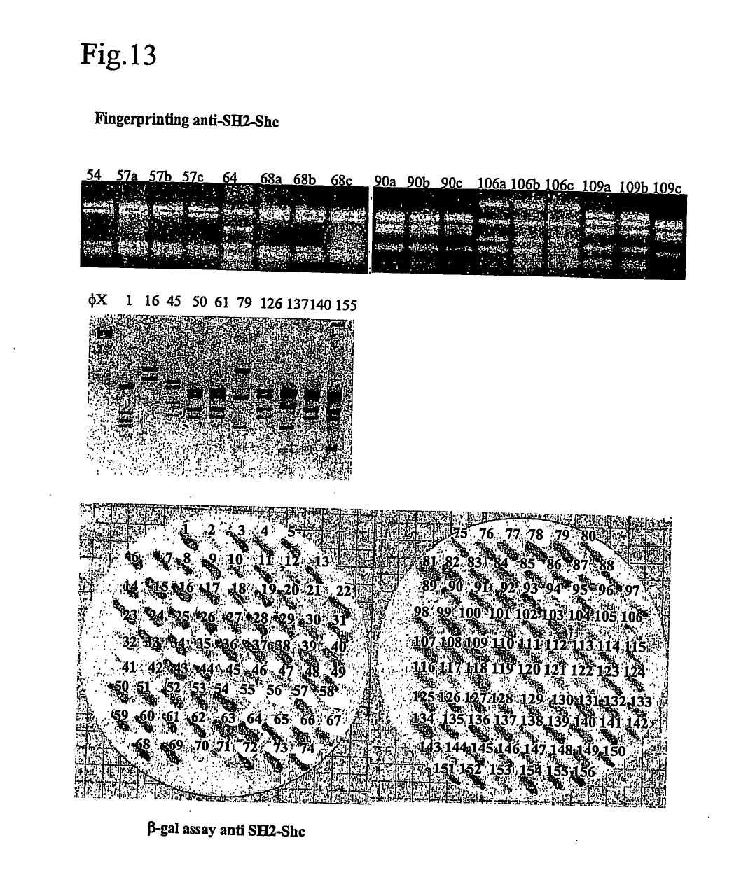

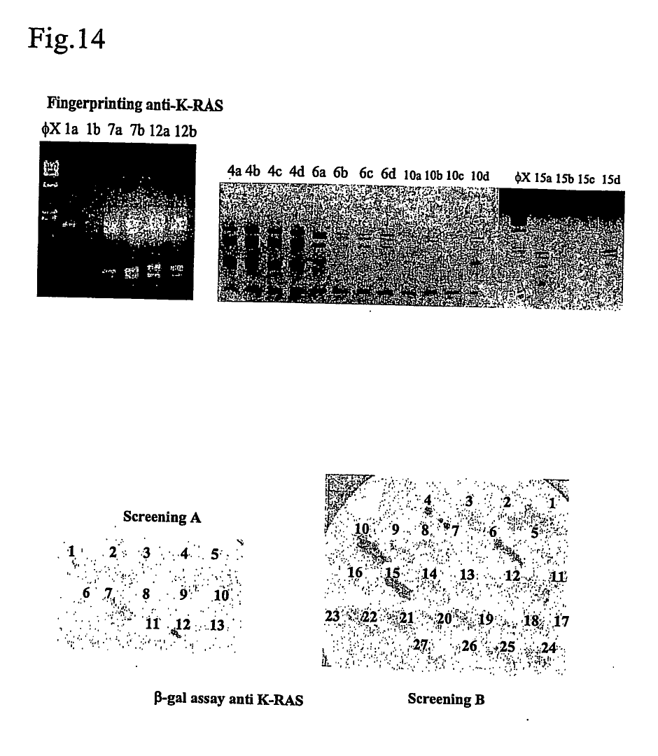

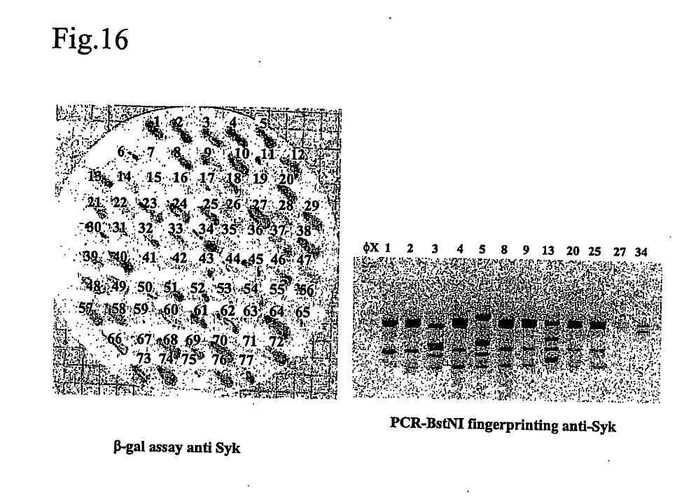

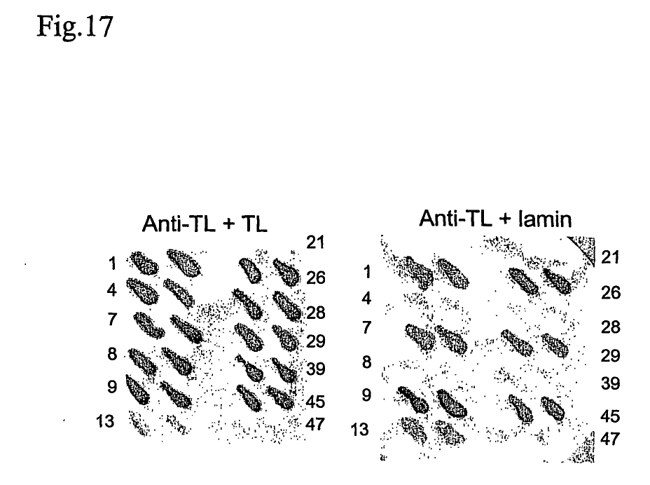

SPLINT was selected against the following antigens: two domains of Shc (FIG. 13, 15), K-RAS (FIG. 14, 15), Syk (FIG. 16), β4-thymosin ubiquitous, β4-thymosin lymphoid (FIG. 17, 18), amyloid β1-42, gephyrin, TFII-I and X5 ORF SARS-CoV proteins.

Construction of the Baits:

SHE2Shc/MIC-BD1: the DNA fragment SH2-Shc was PCR amplified from pGEX4T1-p66Shc and cloned between EcoRI/BamHI restriction sites of pMIC-BD1 plasmid.

CH2-Shc/MIC-BD1: the DNA fragment CH2-Shc was PCR amplified from pGEX4T1-p66Shc and cloned between EcoRI/BamHI restriction sites of pMIC-BD1 plasmid.

Syk/MIC-BD2: the Syk EcoRI/BamHI fragment from Syk/BTM116 (Visintin et al., 1999) was subcloned between EcoRI/BamHI restriction sites of pMIC-BD2 plasmid.

K-RAS/MIC-BD1 and K-RAS/MIC-BD2: K-RAS BamHI/PstI from K-RAS/BTM116 (Visintin et al., 1999) was subloned between BamHI/PstI restriction sites of pMIC-BD1 and pMIC-BD2 respectively.

LTβ4/MIC-BD1: the DNA fragment LTβ4 was amplified from LTβ4/pCI-neo vector and cloned between the EcoRI/BamHI restriction sites of pMIC-BD1 plasmid.

UTβ4/MIC-BD1: the DNA fragment LTβ4 was amplified from UTβ4/pCI-neo vector and cloned between the EcoRI/BamHI restriction sites of pMIC-BD1 plasmid.

Gephyrin/MIC-BD1: the DNA fragment of the 153-348 domain of gephyrin protein was amplified and cloned between the EcoRI/BamHI restriction sites of pMIC-BD1 plasmid. Before starting selection of SPLINT library all baits were tested for transactivation of reporter genes as described (Visintin and Cattaneo, 2001). All baits resulted to be non transactivating and thus used for the selections.

Aβ 1-42/MIC-BD1: the DNA fragment of β~ amyloid 1-42 domain was synthesize by primers annealing and then cloned into BamHnPstI restriction sites of pMIC-BD1 plasmid.

TFII-I 1-397/MIC-BD1: the DNA fragment of the 1-397 domain of TFII-I transcription factor was amplified from human TFII-I cDNA and cloned into Bam HI restriction site of pMIC-BD1 plasmid)

X5 ORF SARS-CoV/MIC-BD1: the DNA fragment of the X5 ORF of SARS-Coronavirus was synthesized by primers annealing and then cloned into EcoRI/SalI restriction sites of pMIC-BD1 plasmid.

Selection of scFv Intracellular Antibodies with Different Specificities by IACT.

To verify whether we could select from this library intracellular antibodies against signalling proteins, and other intracellular proteins, we screened the library against a panel of different baits (Table II). These include, two domains of Shc, K-RAS, Syk, β4-thymosin ubiquitous, β4-thymosin lymphoid, amyloid β1-42, gephyrin, TFII-I and X5 ORF SARS-CoV proteins.

Table II. Panel of different baits used for SPLINT-2HY selection.
Human p66Shc CH2 domain (CH2-Shc)
Human p66Shc SH2 domain (SH2-Shc)
Human K-RAS
Human Syk
Mouse β4-Thymosin ubiquitous (TUβ4)
Mouse β4-Thymosin lymphoid (TUβ4)
Human Amyloid β 1-42
Rat Gephyrin
Human TFII-I
X5 ORF SARS-CoV

The baits chosen for the validation of the SPLINT library include proteins of different species, of viral origin and of very different function and cellular location:

Two different domains (CH2 and SH2) of human p66^{Shc} adaptor protein (Ventura et al., 2002), which contains a unique amino-terminal proline-rich region (CH2) an NH2-terminal phosphotyrosine binding domain (PTB) followed by a collagen homology domain (CH1) and a COOH-terminal SH2 domain. By virtue of its PTB and SH2 domains, Shc proteins link receptor and nonreceptor tyrosine kinase activation to downstream cytoplasmic can bind to activated receptors that have been tyrosine-phosphorylated. This protein is implicated in pathways activated by environmental stresses and regulation of life-span.

Human K-Ras is a monomeric membrane-localized G protein of 21 kd that functions as a molecular or nuclear events. The ras-signaling pathway is an attractive target for anticancer therapy because of its important role in carcinogenesis.

Syk protein-tyrosine kinase has been implicated in a variety of hematopoietic cell responses, in particular immunoreceptor signaling events that mediate diverse cellular responses including proliferation, differentiation, and phagocytosis. Syk appears also to play a general physiological function in a wide variety of cells including neuronal cells in which it is suggested to play an important role in signaling steps to neurite extension (Yanagi et al., 2001).

Thymosin β4 encodes both an ubiquitous actin-binding protein (UTβ4) with demonstrated capacity to inhibit neutrophilic infiltration, and a splice-variant limited to lymphoid tissue (LTβ4) that was shown to be activation-responsive expressed by dendritic epidermal T cells, and other intraepithelial lymphocyte, to down-regulate local inflammation (Girardi, 2003).

Gephyrin is a 93 kDa protein that copurified with the glycine receptor (GlyR,) and was found to be localized at the postsynaptic side of glycinergic synapses (Prior et al., 1992) (Sassoe-Pognetto and Fritschy, 2000; Craig and Lichtman, 2001).

The major constituent of senile plaques in Alzheimer's disease is a 42-aa peptide, referred to as beta-amyloid (Abeta). Abeta is generated from a family of differentially spliced, type-1 transmembrane domain (TM)-containing proteins, called APP, by endoproteolytic processing. The major, relatively ubiquitous pathway of APP metabolism in cell culture involves cleavage by alpha-secretase, which cleaves within the Abeta sequence, thus precluding Abeta formation and deposition. Amyloid beta-peptide (1-42) (Butterfield, 2002) may be central to the pathogenesis of AD (Sinha and Lieberburg, 1999).

TFII-I is an inducible multifunctional transcription factor that is activated in response to a variety of extracellular signals and translocates to the nucleus to turn on signal-induced genes (Roy, 2001).

Severe acute respiratory syndrome (SARS) is a life-threatening form of atypical pneumonia SARS-CoV genome is ˜29.7 kb long and contains 14 open reading frames (ORFs) flanked by 5′ and 3′-untransleted regions. Coronaviruses encode a number of non-stuctural proteins. These non-structural proteins, which vary widely among the different coronavirus species, are of unknown function and seems to be dispensable for virus replication (Rota et al., 2003; Snijder et al., 2003; Zeng et al., 2003).

DNA sequences coding for each of these proteins, fused to lexA protein to create antigen-specific baits, were introduced by transformation into yeast cells expressing the SPLINT library and IACT selection was performed as described (Visintin et al., 2002). It should be noted that no manipulation whatsoever of the corresponding protein was performed. Double trasformants were selected for histidine prototropy and lacZ activity. In the search for antigen-binding scFv fragments, about 10-20 His+/lacZ+ different clones for each antigen were analyzed in a second two-hybrid screening, except for UTβ4, LTβ4, Ab1-42, Gephyrin and TFII-I (Table II) whose screening was more exhaustive (more than 90 His+/lacZ+ different clones). Specifically binding clones were obtained in each case, demonstrated that bait-specific single chain antibodies could be expressed in the cytoplasm and in the nucleus of yeast cells (Table III). Subsequent secondary screening confirmed that true positives coild be identified that interact specifically with the original bait, but not with other lexA fusions (lexA-lamin).

8 clones for CH2-Shc, 5 clones for SH2-Shc, 2 for K-RAS, 6 for Syk, 11 for LTβ4, 2 for UTβ4 and 6 for gephyrin, 6 for Aβ 1-42, 4 for TFII-I and 6 for X5 ORF SARS-CoV were identified that interact with their antigens but did not interact with lexA-Lamin.

A subset of antibody fragments obtained from LTβ4 screening were also analyzed for binding to UTβ4 (FIG. 18).

The lymphoid-specific thymosin encodes for a six-residue NH2-terminal extension relative to the ubiquitous form of thymosin. In order to verify if it would be possible to isolate scFv specific only for the lymphoid form we tested five antibody fragments obtained from the LTβ4 screening that were shown to have the most different aminoacid sequences among the scFv isolated, for their ability to bind UTβ4. All the scFvs tested result to be highly specific for the lymphoid form and failed to bind the ubiquitous one (FIG. 18). The parallel selection of SPLINT on UTβ4 resulted to be very stringent; very few different fingerprinting-patterns were found among 96 analyzed clones. Moreover it was shown that the selection of SPLINT against the UTβ4 bait was able to isolate scFvs whose aminoacid sequences correspond to some scFvs previously isolated against LTβ4, thus indicating that the selection of SPLINT against LTβ4 was exhaustive enough for fishing out specific antibodies against both forms of the thymosin protein.

In conclusion, the results obtained confirmed that indeed the SPLINT library constructed represents a good source for validated intracellular antibodies, against a wide variety of different proteins. The procedure to isolate such antibodies, which depends directly from the format of the llibrary, requires no manipulation whatsoever of the target protein, thus obviating the need for protein expression and purification, that represents a significant experimental bottleneck for increasing the throughput of antibody isolation. The procedure described, that depends on the construction of the SPLINT library, allows isolating stable validated antibodies directly from gene sequences.

Improving the Stringency of Selections.

The results summarized in Table III shows that for each target protein chosen, a number of different antigen-specific antibodies could be isolated directly from gene sequences. The procedure has been experimentally optimized and refined and is very robust, rapid and efficient.

In order to fish out very strong binders and to improve the stringency of selections, if required, we also tested our SPLINT library by using a modified bait, fused with a mutant lexA protein. The bacterial LexA protein of pMIC-BD1 vector was modified (mLexA) to abolish its intrinsic NLS, as previously described (Rhee et al., 2000) (FIG. 7). In this way, only the antibody/antigen complex formed in the cytoplasm has the information to be targeted to the nucleus. To check whether it should be possible to screen SPLINT also with antigen expressed only in the yeast cytoplasm (as in the case with the pMIC-BD2 vector) we chose the protein K-RAS as target antigen. The choice of RAS was also due to the apparent difficulty of isolating intracellular antibodies in the standard selection procedure (Table III). In this modified selection procedure, the interaction between the antigen and the scFv must occur in the cytoplasm, because the antigen is expressed in yeast cells without the intrinsic nuclear localization signal of lexA. ScFv and antigen interact in the cell cytoplasm before the complex is translocated into the nucleus and activates transcription. We tried in parallel the selection of K-RAS as lexA-bait fusion protein with or without nuclear localization signal. In both cases we obtained the same number of functional intracellular antibodies.

This indicates that the technology was strong enough to allow the selection of scFv with such an affinity to bring the antibody-antigen complex into the nucleus and to activate the transcription of reporter genes.

As a general comment, the selection with K-RAS either with or without NLS, gave very few positive clones if compared with other antigens (Table II)). It should be noted that very few positive clones were also obtained in other reported IACT selection strategies when RAS was used as a bait (Tanaka and Rabbitts, 2003). This might indicate that the antigen has difficulty entering into the nucleus, and this difficulty interferes with the normal selection procedure. Alternatively, interference with the endogenous RAS protein might explain this low number of colonies obtained from this selection.

In conclusion we established that functional antigen-specific ICAbs were selected from the natural SPLINT library against a wide spectrum of very different protein antigens, including viral proteins. It should be noted that the optimized selection procedure, ensure that the selected antibodies are all functional also when expressed in mammalian cells. Indeed IACT selection predicts the property of being a functional intrabody in all cases (Visintin et al., 2002) (Tse et al., 2002). This was confirmed for a number of the ICAbs selected from SPLINT, which showed good solubility and half life when expressed in mammalian cells (data not shown). Thus, SPLINT libraries represent a rich and good source for antibodies to function in the intracellular environment.

BIG SPLINT: Increasing the Size of SPLINT

Library size is a critical variable for the isolation of antibody fragments. However, the true diversity of a library is not easily determinable; this in fact depends not only on the number of independent counted clones but also on the number of clones that actually express scFv proteins.

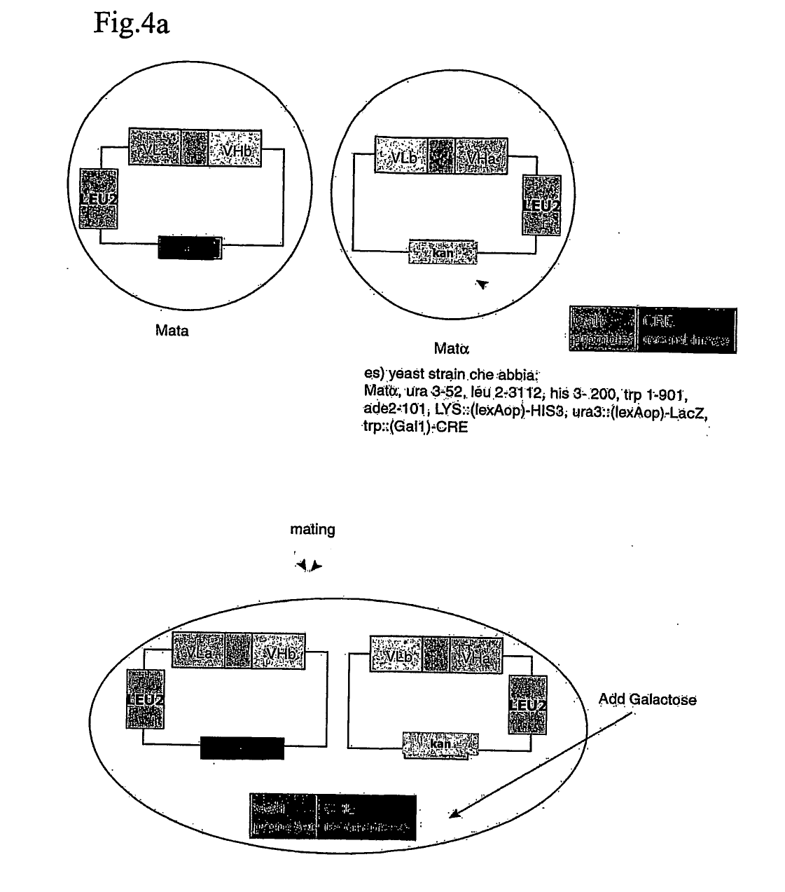

Notwithstanding the fact that we demonstrated here that it is possible to select functional intracellular antibodies from a SPLINT library of 10⁶-10⁷ clones, functional ICAbs could be more easily directly selected making a larger SPLINT library. This has been accomplished by directly scaling up (i.e. repetition a number of times of the procedure described above) or by recombination methods (FIG. 4 a-b), as has been done in bacteria (Sblattero and Bradbury, 2000) and in yeast for making large antibody libraries of surface displayed Fab fragments (Feldhaus et al., 2003). The BIG-SPLINT library obtained in this way allows not only to isolate stable intracellular antibodies but also to increase the number of possible antibody candidates for intracellular expression.

Consensus Sequence Framework-Based Library

A further refinement of the SPLINT library will be carried out with the study of scFv sequences isolated by IACT.

It has been noted that the set of antibodies selected with these technologies is characterized by a number of highly conservative residues. These critical residues represent a sort of trademark that identifies those antibodies capable of being expressed in the intracellular environment by a multitude of scFv which are otherwise unable to function there. IACT technology combined with SPLINT is also able to select the scFv that possess an optimum sequence very similar to a consensus sequence present in the database of immunoglobulins present in nature. As the database of intracellular antibodies selected with this technology grows, the number of conserved residues will decrease. It will therefore be possible to achieve a final generic framework on which an antibody library for intracellular use may be engineered. This will allow the creation of a library compatible with the low transformability of yeast and, more generally, a phagmid or phagic library of highly stable scFv that are functional for expression in any cellular or noncellular environment. It can be concluded that both IACT and SPLINT are two technologies with the capability to surpass their intrinsic potential and to thus create ever more sophisticated and validated libraries.

SPLINT Libraries as a Source of Super Stable Antibodies, that Can be Isolated Rapidly, Directly from Gene Sequences.

It has been demonstrated above that a SPLINT library, as described above, represents a good generic source of intracellular antibodies, that is of antibodies/antibody domains that are able to bind any antigen of interest under conditions of intracellular expression. In light of the fact that these validated intracellular antibodies fold in the intracellular environment despite the fact that they fail to form the intrachain disulfide bond that links the two cysteine residues present in all known antibody variable regions (Visintin et al 1999; Biocca et al 1995), and in light of the fact that this disulfide bond contributes approximately 4.5 kCal/mol to the folding stability of an antibody domain (Proba et al., 1997), it can be concluded that antibodies generated through the IACT procedure from SPLINT libraries are much more stable than average antibodies in any given repertoire. In fact, when SPLINT derived antibodies are expressed under the normal oxidising conditions, thus allowing their intrachain disulfide bonds to form, their folding stability under experimentally controlled denaturing conditions (such as urea, guanidinium or thermal denaturation) is much greater than that of average antibodies (data not shown). Thus, SPLINT libraries allow isolating antibodies of superior stability. This property, together with the possibility of isolating antibodies directly from gene sequences, makes the SPLINT libraries the tool of choice to solve the bottleneck for the high throughput generation of stable antibodies, in applications such as antibody arrays, to be used as advanced diagnostic tools and for protein expression profiling in proteomics.

Protein-Protein Interaction Targeted Antibodies from SPLINT Libraries:

The unexpected demonstration that a SPLINT library as described above represents a good source for intracellular antibodies represents the essential prerequisite for the final development of this invention, namely the exploitation of the SPLINT library, after suitable engineering, for the isolation of antibodies that are intrinsically neutralizing. In fact, the antibodies isolated from SPLINT are not necessarily endowed with the property of inhibiting the biological function of their target protein. Indeed, the neutralization of protein function (PKO) is an added-on property, that has to be engineered or implemented on an ad hoc case-by case basis, with strategies such as, for instance, traffic diversion. These methods are not general, and therefore only a subset of antibodies will be useable to neutralize protein function, notwithstanding their in built property of being validated intracellular antibodies.

We describe in the following the use of SPLINT libraries to generate rapidly (directly from gene sequences) antibodies that are intrinsically endowed with the ability to interfere with a given protein-protein interaction. These will be intrinsically neutralizing antibodies.

Protein interactions play a crucial role in the discovery of diverse biological functions. The interpretation of genes sequenced from the human genome is leading researchers to develop new technologies for the interpretation of unpredictable functions of yet undiscovered genes. Diverse interactomes have been explored (protein interactions in a single organism). It has been seen that the two-hybrid system can be used to create a vast network of connections that can be further validated by other biotechnology system such as 2D gels, mass spectrometry, etc. The currently available approaches to studying protein function are limited and poorly generic. In contrast, with the methodology adopted for DNA study, the proteins are so variable that the study of the genome by protein interaction cannot be undertaken using a single methodology.

For this reason, researchers are examining whether antibody intracellular technology may offer an approach suitable for various fields of functional genomics.

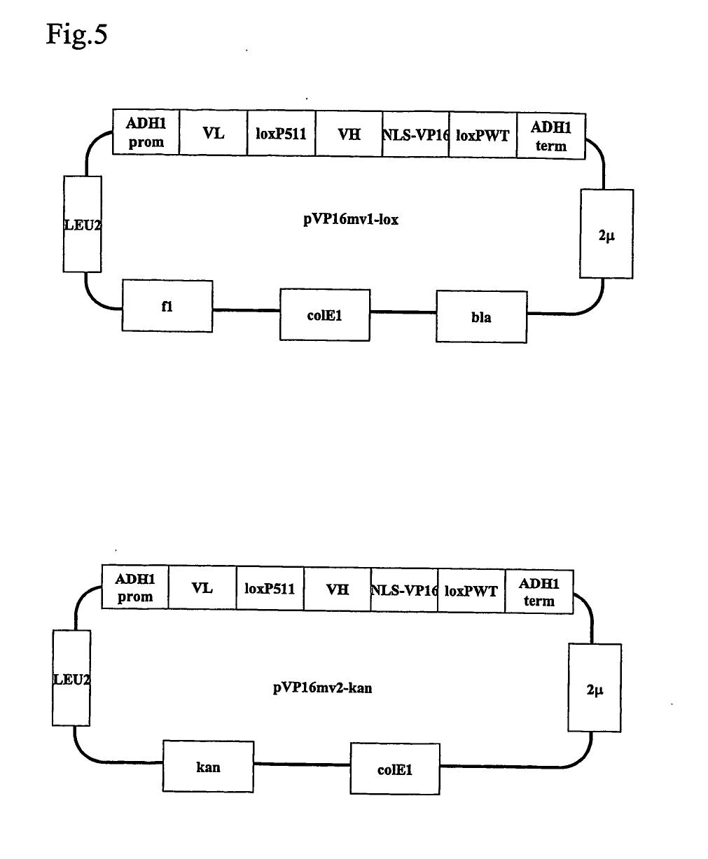

For example, one can imagine constructing an ad hoc library of antibody fragments selected on a certain proteome (FIG. 6). The technology would entail a first step in which a cDNA library is created from a cell type, a tissue, a virus or a bacterium, etc. The library would then be directly cloned in the two-hybrid vector fused to a protein that binds DNA (e.g. pMIC-BD2) and tested against a SPLINT library in vivo. After positive clones have been obtained, the scFv involved in an interaction are isolated and cloned (in pools in a library format) in a eukaryotic expression vector (e.g. scFvexpress). After the new sub-library is created, the scFv can be expressed in the cell type, tissue, virus or bacterium from which the cDNA library was originally constructed. Once the library is introduced, a protein extract is prepared and used in immunoprecipitation experiments. The immunoprecipitated proteins are separated with a bidirectional gel (2D gel) and the isolated proteins can then be analyzed by mass spectrometry. With this technology (IntrAP), antibodies directed against the entire cell proteome can be obtained in a single step.

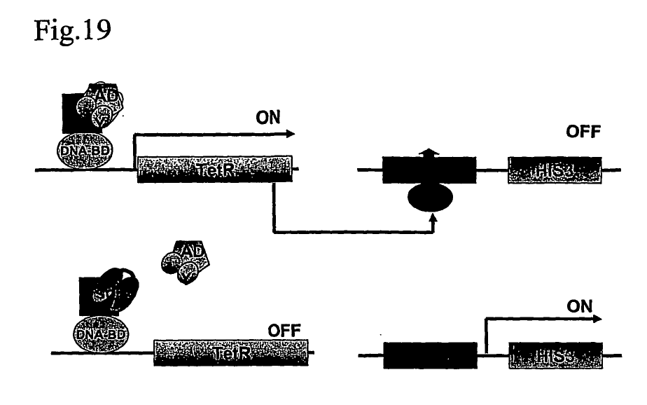

Another possible consideration is the interactions and networks of genetic regulation at the level of a complete genome. In this way, it would be possible to conceive of the genome as a complex of functions expressed by proteins programmed to stabilize specific interactions. In this light, the total number of genes in an organism would appear less important than the complete repertory of interactions that may be potentially encoded by the same genome (interactoma). For this reason, one can conceive of constructing a subset of scFv libraries (similar to that described in the paragraph above) by isolating only the scFv that recognize protein modules or peptide sequences recognized as being a functional part of an interaction. The library could then be used to directly interfere in a known interactome through a methodology based on the three-hybrid system (FIG. 19). The 3HY-SPLINT strategy draws on various publications from the field of three-hybrid systems (Vidal M, et al. 1996; Huang J, et al. 1997; Leanna C A, et al. 1996; Shi H M, et al. 1996; Vidal M, et al. 1999).

The strategy uses a genetic selection in which the dissociation of an interaction becomes a selective advantage for the yeast strain used for this purpose. To reiterate the concept, the binding between protein X-DNA-BD and protein Y-AD is lethal for a yeast cell because in this system a toxic gene is used as a reporter gene. The dissociation by an antibody that binds one of the two interaction domains between X and Y confers a selective advantage that may be conveniently identified.

In our 3-HY system, the expression of the tetracycline repressor represses the expression of the HIS3 gene. Under these conditions, the interaction between X and Y confers an auxotrophic phenotype for histidine. When an antibody disrupts the interaction between X and Y, the TetR repressor is not expressed and the strain can survive also in the absence of histidine since gene HIS3 transcription is no longer repressed.

A novelty of our system is the use of two vectors instead of the classical set of three vectors to express either the two interacting proteins and the library of neutralizing antibodies. This allow to simplify the methodology, avoiding the difficult engineering of three vectors with different nutritional markers and different antibiotic resistance and the need of a particular yeast strain to be also engineered in which more than 3 genes must be knocked-out. Moreover a highly optimized protocols for the transformation of the yeast cells should be assessed thus resulting in very poor reproducibility of the experiments. Our three hybrid methodology allow to maintain the current methodology of IAC technology as little modified and thus accessible to non specialized researchers.

The results obtained so far are:

Step 1:lexA-p65 and VP16-p65 Interact in Two-Hybrid System

Construction of the Bait and the Prey:

p65/MIC-BD1: the DNA fragment of p65 protein member of NF-kB/Rel family was amplified from pRSV NF-kB relA (p65) plasmid and cloned between BamHI/SalI restriction sites of pMIC-BD1.

p65/VP16c-t: the DNA fragment of p65 was amplified from pRSV NF-kB relA (p65) plasmid and cloned between BamHI/NotI restriction sites of VP16c-t.

Intracellular interaction of lexA-p65 and VP16-p65 fusion proteins: L40 yeast cells were cotransfected with bait and prey vectors by using lithium acetate transformation protocol. Positive interaction was verified by using auxotrophic markers for both plasmids and for histidine prototropy. Histidine-positive colonies and controls were lysed in liquid nitrogen and assayed for b-gal activity on filters as described (Visintin and Cattaneo, 2001).

Step 2: lexA-p65 and VP16-P65 Interact in Two-Hybrid System when Cloned in pBiDi3HYlexA-VP16 Vector

Construction of pBiDi3HY vector: to construct pBiDi3HY vector 2 vectors were used.

The pESC-TRP vector was PvuII cutted to isolate the bidirectional promoters Gal1-Gal10. The pMIC-BD1 vector was SphI cut and DNA polymerase I, Large (Klenow) fragment was subsequently used to remove the 3′ overhangs to form blunt ends. The vector was also dephosphorylated with calf intestinal alkaline phosphatase to prevent recircularization of cloning vector. Cloning of Gal1-Gal10 PvuII digested into pMIC-BD1 SphI cut and blunt generated pBiDi3HY.

Construction of pBiDi3HYlexA-VP16 vector: the DNA fragment VP16 was amplified from VP16* vector (Hollenberg et al., 1995) and cloned between the BamHI/ApaI of pBiDi3HY plasmid.

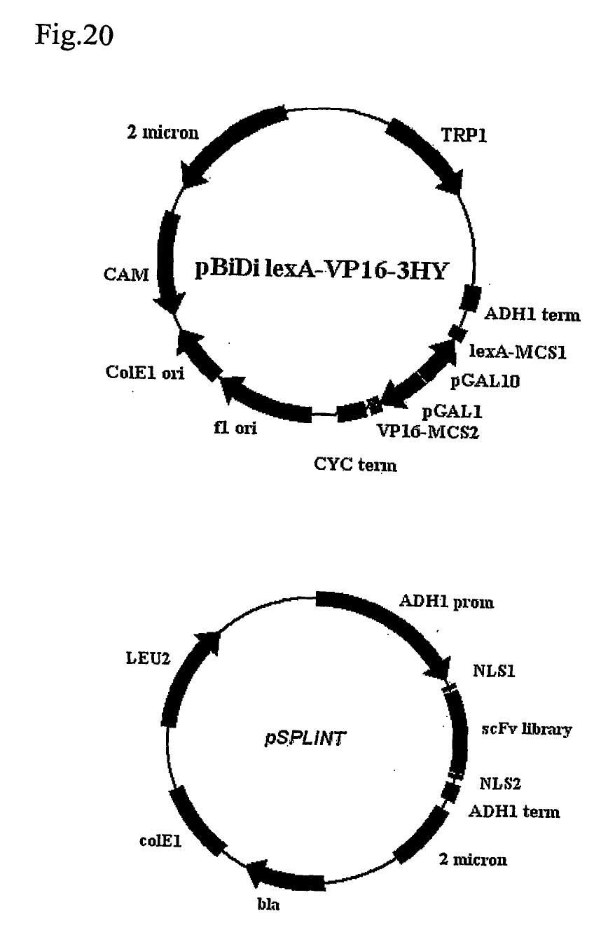

The DNA fragment lexA was amplified from pMIC-BD1 and cloned between the EcoRI/SpeI of pBiDi3HY-VP16 vector. The final vector pBiDi3HY-lexA-VP16 was sequenced and the expression of lexA and VP16 proteins was verified by western blot analysis of yeast crude extract after induction of promoters with galactose 20% (see FIG. 20).

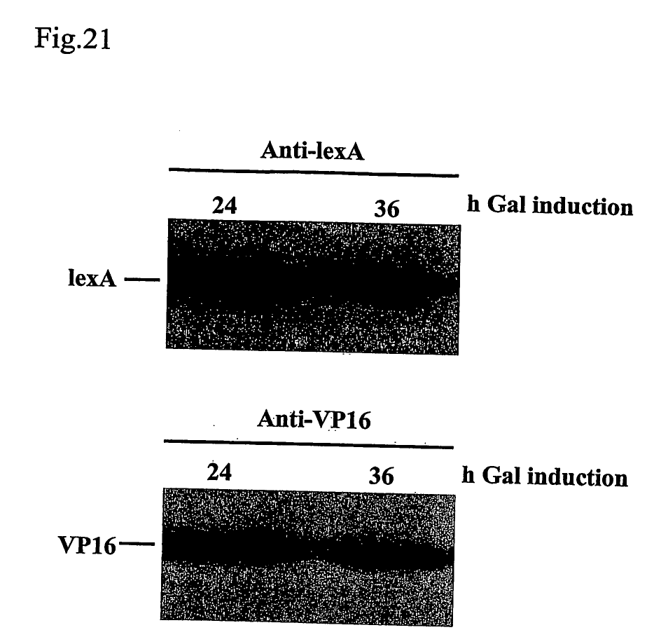

Construction of pBiDi3HYlexAp65-VP16p65 vector: the member of NF-kB/Rel family p65 protein, was cloned as C-terminal fusion protein with lexA and VP16 domains. The DNA fragment p65 was amplified from pRSV NF-kB relA (p65) plasmid (gently provided by Dr. Francesca Demarchi) and cloned into SpeI to produce lexA-p65 fusion protein and between ApaI/SalI to produce VP16-p65 fusion protein. The expression of both p65 fusion proteins were verified by western blot analysis and sequences (see FIG. 21).

All clones were sequenced, using the Epicentre Sequitherm Excel II kit (Alsbyte, Mill Valley, Calif.), with a Li-Cor 4000L automatic sequencer (Lincoln, Nebr.).

Construction of pSPLINT vector (FIG. 20): For construction of plasmid pSPLINT, the following cloning strategy was applied. A PCR Vk and VH cloned with 220 linker from pLINKER220 was performed by using these oligonucleotides: sense 5′-CATCATCATAAGCTTATTTAGGTGACACTA-3′ and antisense 5′ACCCGGGGATCCCTAATGGTGATGGTGATGGTGAGTACTATCCAGGCCCAG CAGTGGGTTTGGGATTGGTTTGCCGACCTTCCGCTTCTT-3′. The resulting PCR product was digested with HindIII/BamHI and ligated to HindIII/BamHI-digested vector VP16* (Hollenberg et al., 1995) to give pSPLINT. The activation domain VP16 was removed while maintaining both nuclear localization signals between scFv. A tag signal SV5 was added at the C-terminal of scFv linker.

Construction of SPLINT-3HY Library.

A pool of scFv assembled from SPLINT library was also cloned into BssHll/NheI-digested pSPLINT to obtain SPLINT/pSPLINT library of 1.5˜10⁵ different clones in E. coli.

Step 3: lexA-p65 and VP16-p65 Interaction Can be Abrogated by a Neutralizing Antibody in a SPLINT-3HY Selection Strategy

Co-Transformation of pBiDi3HYlexAp65-VP16p65 Vector with SPLINT-3HY Library in YI596 Yeast Strain.

The genotype of Saccharomyces cerevisiae reporter strain YI596 is MATa/α, his3Δ200/his3Δ200, trp1-901 leu 2-3, 112/leu2-3, 112ade2/ade2, URA::lexAOp)₈-TetRLYS2::ADH(Tet Op)₂-HIS.

The constructed system is a positive selection method designed to identify antibody domains that disrupt protein-protein interaction in vivo. The proteins of interest (p65 homodimers) are expressed as fusion with the lexA DNA binding domain and the transcriptional activator, VP16 under the control of the inducible bidirectional promoters Gal1-Gal10. Interaction between lexA-p65 and VP16-p65 leads the expression of the tetracycline repressor protein (TetR) which prevents transcription of the HIS3 reporter gene leading to the inability of yeast cells to grow on media lacking histidine. Disruption of homodimerization of p65 protein by a neutralizing antibody restores the ability to grow on such media LexA-p65 fusion protein was shown to display activation capability. In order to block histidine production suppressing background growth on media lacking histidine a modulation of the system with tetracycline/3-AT was performed. After the identification of growth conditions of lexAp65-VP16p65 homodimer this construct was used for the selection of SPLINT library in order to identify the neutralizing antibody that disrupt p65 homodimer formation in vivo.

SPLINT library is introduced into YI595 strain by a modified protocol of yeast transformation (Visintin and Cattaneo, 2001). Each transformant presumably contains an individual library plasmid encoding a scFv in addition to the p65 homodimer proteins. Cells containing the plasmid encoding a scFv that bind one or both p65 interacting proteins will be selected on SG-Raf-WHULK. The transformation procedures must be carefully followed to ensure a high transformation efficiency.

SPLINT-3HY Transformation

The following transformation protocol is a modification of published method (Visintin and Cattaneo, 2001).

Materials: 500 μg SPLINT/pSPLINT library; 150 ml YC-UKW; 2 l YPAD; 1 l YPA; 1.5 l YC-UKWL+10 YC-UKWL plates (100 mm); 1 l YC-WHULK; 1 l SG-Raf-WHULK+3AT 25 mM (see recipe below); 20 SG-Raf-WHULK+3AT 25 mM plates 100 ml 10×TE; 20 ml 10×LiAc; 1 ml of 10 mg/ml denatured salmon sperm; 150 ml 50% PEG 4000; 20 ml DMSO.

Procedure:

Day 1: grow YI595 yeast containing p65 homodimer plasmid in YC-UKW O/N

Day2: inoculate 100 ml of YC-UKW with an aliquot of the overnight culture in order to find a dilution that places the 100 ml culture to logarithmic phase the next day

Day 3: transfer enough overnight culture in 1 l of prewarmed to 30° C. YPAD to produce an OD₆₀₀=0.3. Grow at 30° C. for 3 hours. Centrifuge the cells at 1500×g for 5 min at room temperature. Wash pellet in 500 ml of 1×TE then centrifuge again the cells at 1500×g for 5 min at room temperature. Resuspend pellet in 20 ml 1×LiAc, 0.5×TE and transfer to a new flask. Add 500 μg DNA library and 1 ml denatured salmon sperm. Add 140 ml of IX LiAc, 40% PEG 3350, 1×TE; mix and incubate for 30 min at 30° C. with gently shaking. Add 17.6 ml of DMSO; swirl to mix. Heat shock for 10 minutes at 42° C. in a water bath swirl occasionally to mix. Rapidly cool at room temperature cells in a water bath diluting with 400 ml YPA. Pellet cells by centrifugation and wash with 500 ml YPA. After centrifugation resuspend pellet in 1 l of prewarmed YPAD. Incubate at for 1 hour at 30° C. with gently shaking. Pellet cells from 1 ml: resuspend in 1 ml YC-UKWL; spread 100 μl of a 1:1000, 1:100, 1:10 dilutions for transformation efficiency controls. Pellet cells from the remaining culture. Wash pellet with 500 ml YC-UWL. Resuspend in 1 l of prewarmed YC-UWL and incubate O/N at 30° C. with gently shaking.

Day 4: pellet cells and wash with 500 ml of YC-WHULK. Pellet cells and wash with 500 ml of SG-Raf-WHULK+3AT 25 mM. Resuspend final pellet in 10 ml of SG-Raf-WHULK+3AT 25 mM. Spread dilutions of the total on YC-UKWL plates to compare to the number of primary transformants Spread the remaining transformation suspension on SG-Raf-WHULK+3AT 25 mM plates.

Synthetic Galactose Minimal Medium (SG Dropout Media)

1. YNB w/o aa & (NH₄)₂SO₄: 1.2 g yeast nitrogen base, w/o amino acids and ammonium sulfate (Difco # 0335-15-9); 20 g bacto-agar; Add H₂O to 800 ml. Autoclave 121° C. for 15 min.

2. Salts: 5.4 g NaOH; 10 g succinic acid (Sigma # S-7501); 5 g ammonium sulfate (Sigma # A-3920).

3. Gal-Raf: 20 g galactose; 10 g raffinose

Add H₂O to 100 ml and dissolve all components one by one. Add galactose and raffinose and H₂O to make a final volume of 150 ml.

4. amino acids MIX: 5.8 g NaOH; 1 g Adenine hemisulfate salts; 1 g L-Arginine HCl (Sigma # A-5131); 1 g L-Cysteine (Sigma # C-8277); 1 g L-Threonine (Sigma # T-8625); 0.5 g L-Aspartic acid (Sigma # A-4534); 0.5 g L-Isoleucine (Sigma # I-7383) 0.5 g L-Methionine (Sigma # M-9625); 0.5 g L-Phenylalanine (Sigma # P-5030) 0.5 g L-Proline (Sigma # P4655); 0.5 g L-Serine (Sigma # S-5511). Dissolve in 80 ml H₂O

5. L-Tyrosine: 0.5 g L-Tyrosine (Sigma # T-3754); 0.2 g NaOH; Dissolve in 10 ml by heating.

6. Omitted amino acid solutions:

L-Histidine (Sigma # H-9511): 5 g/l H₂O

Uracil (Sigma # U-0750): 10 g/l H₂O (+2 pellets NaOH)

L-Leucine (Sigma # L-1512): 10 g/l H₂O

L-Lysine HCl (Sigma # L-1262): 10 g/l H₂O

L-Tryptophan (Sigma # T-0254): 10 g/l H₂O

Add to aa MIX (4.) the L-Tyrosine solution (5.) and H₂O to make a final volume of 100 ml. Filter-sterilize, aliquot and store at −20° C. for up to 1 year. Filter-sterilize and aliquot individually omitted amino acids (aa) solutions (H, W, L, K, U) and store at −20° C. for up to 1 year. Before preparing SG-Raf plates or media by mixing appropriate solutions, media must be adjusted to pH 5.8 and sterilized by filtering salts+aa final mix.

Results of SPLINT-2HY Selections

It was already demonstrated that IACT is a genetic selection method that allows the isolation of soluble intrabodies directly from antigen gene sequences (Visintin et al., 2002).

The major goal of IAC technology was to develop intracellular one-pot scFv libraries of sufficient size and diversity to facilitate isolation of antibodies of every conceivable specificity, including antibodies with high solubility, stability and good affinity for intracellular expression. An important determinant of the composition and diversity of this alternative in vitro immune system is the source of antibody genes used as building blocks to construct the library. In order to explore the probability of isolating intrabodies directly from primary mice antibody repertoire we have engineered a single pot antibody library in an activation domain vector and tested it in a two-hybrid selection strategy by using a wide panel of different antigens.

The results obtained from all the different selections have indicated that SPLINT library is a good source of antibody fragments. In fact, it was possible to select several scFv against each antigen challenged with the LAC technology. For some target antigens it was possible also to isolate several antibodies thus indicating that although the library is not very complex the diversity obtained is still sufficient to acquire immunological reagents that recognize particular antigens as for example, proteins that are highly conserved between species.

We have demonstrated that a small library which has proved to be enriched in functional antibodies can still provide a good source of antibody for ectopic expression because the method for selecting the antibody fragments act as a filtering funnel. SPLINT has demonstrated to contain a source of stable superior antibodies, naturally present in naïve repertoires but difficult to find if the methodology used is not specialized.

In the original format, SPLINT-2HY guarantee that the antibodies selected are good intracellular binder but cannot assure for neutralizing antibodies.

In order to generate a method that easily provide neutralizing antibodies, IAC technology and SPLINT library were modified to generate a novel system named SPLINT-3HY.

Results of the 3-HY Selections

In the original format of IAC technology, an antigen-antibody interaction brings the two hybrid proteins together and results in the activation of the reporter genes.

In the new generation of the technology, the three hybrid version, we can identify antibody domains that dissociate or abrogate defined macromolecular interactions.

In order to achieve the proof of principle of this technology we used SPLINT-3HY to undertake the de novo selection of scFv antibody fragments against NF-kB RelA p65 protein.

Mammalian NF-kB is a family of structurally related proteins, including p65/RelA, which form homo- and heterodimers. Regulation of gene expression by NF-kTB/rel family of transcription factors is controlled mainly by the inhibitory IkB proteins. The active complex of NF-kB is composed of homodimers and heterodimers of p50, RelA, RelB, and c-Rel. These complexes are sequestered in the cytoplas by IkBs. Extracellular signal-induced phosphorylation and subsequent degradation of IkBs is essential for nuclear translocation of NF-kB. NF-kB binds to the recognition elements in the promoter region of target genes and activate transcription. IkB proteins determine the duration of transactivation by NF-kB. IkBa is involved in transient activation of NF-kB because it is degraded rapidly upon stimulation and is resynthesized by activated NF-kB. Most of the inducers of NF-kB cause degradation of IkBα. The newly synthesized IkBα sequesters NF-kB in the cytoplasm and determines the signal.

p65 has a bipartite structure-a DNA-binding rel hologous region and a C-terminal transcription activation domain. These two functional regions are linked by a segment that contains a nuclear transport signal (Chen et al., 2000).

IκB degradation activates this PKAc that phosphorylates the NF-κB p65 subunit at Ser 276 rendering NF-κB that enters the nucleus transcriptionally active through recruitment of CREB binding protein (CBP)/p300 (Zhong et al., 1997; Zhong et al., 1998).

It is believed that p50 homodimers compete for κB site binding with NF-κB complexes containing subunits such as p65 that have transactivation domains; however, this is unlikely to be their primary mechanism of repression, as their affinity for classical κB sites is lower than that of heterodimers such as p50:p65 (Kunsch et al., 1992). One possible mechanism that has been demonstrated for other repressive DNA binding proteins (Glass and Rosenfeld, 2000) is that nuclear p50 may interact with separate inhibitory proteins that recruit corepressor complexes containing HDACs to gene promoters.

The homodimer of p65 protein was cotransformed into yeast cells YI595 with SPLINT/pSPLINT scFv library following the large scale procedure described in (Visintin and Cattaneo, 2001). The co-transformed library was spread onto SG-Raf-WHULK+25 mM plates to allow the activation of Gal 1-10 promoters and the selection of the plasmid encoding a scFv that bind one or both p65 interacting proteins due to repression of tetracycline repressor that restores the transcription of His3 gene. The high efficiency of transformation (2.6e10⁷) obtained in this experiment ensured that the yield of primary transformants was three times the complexity of the library, thus the library complexity ensures that 95% of the clones represented in the library have been examined (Clarke and Carbon, 1976). After three days 4 clones that grew on -HIS plates were picked and grown on a fresh -HIS plates grid for a second verification of the transcriptional activation of his gene. After 4 days only 2 clones out of the initial 4 clones selected in the first round of selection were able to be rescued on SG-Raf-WHULK+25 mM plates. Both clones from secondary screening were picked and grown for the isolation of DNA. Isolated scFv/pSPLINT plasmids were analysed by PCR-BstNI fingerprinting and sequences. The conclusion from this first part of the experiments is that both scFvs selected from SPLINT-3HY were able to abrogate the interaction between p65-p65 dimer. In order to verify that the two isolated scFvs were also able to recognise p65 as a monomer both antibody fragments were cloned in fusion with VP16 into pLINKR220 vector.

Step 4: Are Anti-p65 Isolated scFv Binders for p65 Monomers?

Construction of anti-p65 (A1 and A2)/pLinker220 plasmid. Anti-p65 scFvs fragments were subcloned into pLinker220 between BssHII-NheI restriction sites.

As shown in FIG. 23 clone A2 display a positive interaction with p65 monomer, thus indicating its specificity with the target protein.

On the contrary, clone A1 was only able to recognized DNA-binding domain lexA. Although A1 clone result to be specific for lexA protein the result obtained indicates that scFvA1 is probably able to inhibit p65-binding domain or p65-DNA-binding domain in a non conventional manner or by steric hindrance.

scFv A2 was subsequently cloned into mammalian expression vector scFvexcyto-SV5.

Step 5: In Vivo Mammalian Cells Studies

Construction of anti-p65A2/scFvexcytoSV5 plasmid. Anti-p65 scFvs fragments were subcloned into scFvexcyto-SV5 between BssH1H-NheI restriction sites.

Anti-p65 A2 was expressed in HEK cell line al leaderless cytoplasmic protein.

Transfected cells display a diffuse intracellular staining, typical of soluble cytoplasmic protein (see FIG. 24).

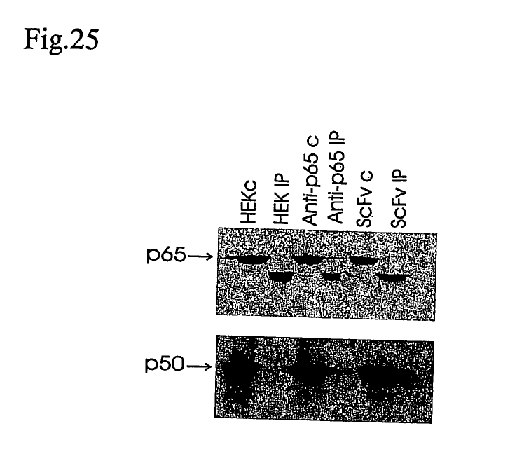

To assess whether anti-p65 A2 inhibition interferes with the physical association between p65 dimer and p50, a coimmunoprecipitation experiment was carried out (FIG. 25). FIG. 25 shows controls (lane 1-3-5-p65 and p50 expressed by HEK in non transfected (c), transfected with anti-p65 (lane 3) and transfected with an irrelevant scFv (lane 5) immunostained with anti-p65 (upper part of the picture) and immunostained with an anti-p50 (lower part). Lanes 4 show the coimmunoprecipitated band corresponding to the p65 monomer (upper part) and p50 protein (lower part). The conclusion for this experiment is that anti-p65 is able to recognize endogenous p65 in HEK cell lines. In this experiment also p50 protein was pulled down with p65 thus indicating that the interaction between anti-p65 and p65 does not interfere with the natural binding sites of p65 and p50. SPLINT-3HY was also challenge with a panel of interacting pairs (see Table IV). From each selection strategy several neutralizing antibodies were isolated (data not shown) thus indicating that the SPLINT-3HY strategy should provide a robust methodology to elucidate cellular mechanisms in numerous fields, of particular salience in the area of signal transduction. The assessment of gene function may be performed using the tools of protein knock-out including peptide, aptamers and antibodies. These approaches have been superseded by intracellular antibody technology, which exhibits much more potency for the investigation of protein function than the techniques listed above. In fact they can block or stabilize macromolecular interactions, modulate enzyme function by occluding an active site, sequestering substrate or fixing the enzyme in an active or inactive conformation, they can divert proteins from their usual cellular compartments, target specifically a post-transcriptionally modified version of a given protein (including heterodimerization), they can specifically target the subcellular localization of a given protein, and finally they can selectively target non-protein antigens.

SPLINT-3HY not only provides a good source of stable antibodies but also provides in one step of selection a good source of intracellular and neutralizing antibodies, thus becoming the first antibody-based selection strategy engineered for this aim.

TABLE IV
Panel of interacting pairs used for SPLINT-3HY selection

| Protein ligand x | Protein ligand y |
|---|---|
| p65 RelA | p65 RelA |
| p65 RelA | p50 NF-κB1 |
| Amyloid β aa. 1-42 | Amyloid β aa. 1-42 |
| JX-TK TrkA | PTB p66 Shc |
| Synuclein | Synphilin |

Consensus Sequence Framework-Based Library

A further refinement of the SPLINT library will be carried out with the study of scFv sequences isolated by IACT.

It has been noted that the set of antibodies selected with these technologies is characterized by a number of highly conservative residues. These critical residues represent a sort of trademark that identifies those antibodies capable of being expressed in the intracellular environment by a multitude of scFv which are otherwise unable to function there. IACT technology combined with SPLINT is also able to select the scFv that possess an optimum sequence very similar to a consensus sequence present in the database of immunoglobulins present in nature. As the database of intracellular antibodies selected with this technology grows, the number of conserved residues will decrease. It will therefore be possible to achieve a final generic framework on which an antibody library for intracellular use may be engineered. This will allow the creation of a library compatible with the low transformability of yeast and, more generally, a phagmid or phagic library of highly stable scFv that are functional for expression in any cellular or noncellular environment. It can be concluded that both IACT and SPLINT are two technologies with the capability to surpass their intrinsic potential and to thus create ever more sophisticated and validated libraries.

Sequences:

URA3 (nutritional marker that encodes the enzyme orotidine-5′ phosphate decarboxylase. This enzyme is active in the last step of uracil biosynthesis and is responsible for the conversion of compound C into uracil).

ATGTCGAAAGCTACATATAAGGAACGTGCTGCTACTCATCCTAGTCCTGT
TGCTGCCAAGCTATTTAATATCATGCACGAAAAGCAAACAAACTTGTGTG
CTTCATTGGATGTTCGTACCACCAAGGAATTACTGGAGTTAGTTGAAGCA
TTAGGTCCCAAAATTTGTTTACTAAAAACACATGTGGATATCTTGACTGA
TTTTTCCATGGAGGGCACAGTTAAGCCGCTAAAGGCATTATCCGCCAAGT
ACAATTTTTTACTCTTCGAAGACAGAAAATTTGCTGACATTGGTAATACA
GTCAAATTGCAGTACTCTGCGGGTGTATACAGAATAGCAGAATGGGCAGA
CATTACGAATGCACACGGTGTGGTGGGCCCAGGTATTGTTAGCGGTTTGA
AGCAGGCGGCAGAAGAAGTAACAAAGGAACCTAGAGGCCTTTGATGTTAG
CAGAATTGTCATGCAAGGGCTCCCTATCTACTGGAGAATATACTAAGGGT
ACTGTTGACATTGCGAAGAGCGACAAAGATTTTGTTATCGGCTTTATTGC
TCAAAGAGACATGGGTGGAAGAGATGAAGGTTACGATTGGTTGATTATGA
CACCCGGTGTGGGTTTAGATGACAAGGGAGACGCATTGGGTCAACAGTAT
AGAACCGTGGATGATGTGGTCTCTACAGGATCTGACATTATTATTGTTGG
AAGAGGACTATTTGCAAAGGGAAGGGATGCTAAGGTAGAGGGTGAACGTT
ACAGAAAGCAGGCTGGGAAGCATATTTGAGAAGATGCGGCCAGCAAACTA
A

TRP1 (nutritional marker that encodes the enzyme N-(5-phosphoribosyl) anthranilate isomerase. This enzyme is found in the next to last step of tryptophan).

ATGTCTGTTATTAATTTCACAGGTAGTTCTGGTCCATTGGTGAAAGTTTG
CGGCTTGCAGAGCACAGAGGCCGCAGAATGTGCTCTAGATTCCGATGCTG
ACTTGCTGGGTATTATATGTGTGCCCAATAGAAAGAGAACAATTGACCCG
GTTATTGCAAGGAAAATTTCAAGTCTTGTAAAAGCATATAAAAATAGTTC
AGGCACTCCGAAATACTTGGTTGGCGTGTTTCGTAATCAACCTAAGGAGG
ATGTTTTGGCTCTGGTCAATGATTACGGCATTGATATCGTCCAACTGCAT
GGAGATGAGTCGTGGCAAGAATACCAAGAGTTCCTCGGTTTGCCAGTTAT
TAAAAGACTCGTATTTCCAAAAGACTGCAACATACTACTCAGTGCAGCTT
CACAGAAACCTCATTCGTTTATTCCCTTGTTTGATTCAGAAGCAGGTGGG
ACAGGTGAACTTTTGGATTGGAACTCGATTTCTGACTGGGTTGGAAGGCA
AGAGAGCCCCGAAAGCTTACATTTTATGTTAGCTGGTGGACTGACGCCAG
AAAATGTTGGTGATGCGCTTAGATTAAATGGCGTTATTGGTGTTGATGTA
AGCGGAGGTGTGGAGACAAATGGTGTAAAAGACTCTAACAAAATAGCAAA
TTTCGTCAAAAATGCTAAGAAATAG

LEU2 (a nutritionally essential marker that encodes the enzyme β-isopropylamate dehydrogenase. Leu3p is a positive regulator of all 3 genes for the biosynthesis of leucine and is thought to activate the expression of the genes for isoleucyl-valine ILV2 and ILV5).

ATGTCTGCCCCTATGTCTGCCCCTAAGAAGATCGTCGTTTTGCCAGGTGA
CCACGTTGGTCAAGAAATCACAGCCGAAGCCATTAAGGTTCTTAAAGCTA
TTTCTGATGTTCGTTCCAATGTCAAGTTCGATTTCGAAAATCATTTAATT
GGTGGTGCTGCTATCGATGCTACAGGTGTCCCACTTCCAGATGAGGCGCT
GGAAGCCTCCAAGAAGGTTGATGCCGTTTTGTTAGGTGCTGTGGCTGGTC
CTAAATGGGGTACCGGTAGTGTTAGACCTGAACAAGGTTTACTAAAAATC
CGTAAAGAACTTCAATTGTACGCCAACTTAAGACCATGTAACTTTGCATC
CGACTCTCTTTTAGACTTATCTCCAATCAAGCCACAATTTGCTAAAGGTA
CTGACTTCGTTGTTGTCAGAGAATTAGTGGGAGGTATTTACTTTGGTAAG
AGAAAGGAAGACGATGGTGATGGTGTCGCTTGGGATAGTGAACAATACAC
CGTTCCAGAAGTGCAAAGAATCACAAGAATGGCCGCTTTCATGGCCCTAC
AACATGAGCCACCATTGCCTATTTGGTCCTTGGATAAAGCTAATCTTTTG
GCCTCTTCAAGATTATGGAGAAAAACTGTGGAGGAAACCATCAAGAACGA
ATTCCCTACATTGAAGGTTCAACATCAATTGATTGATTCTGCCGCCATGA
TCCTAGTTAAGAACCCAACCCACCTAAATGGTATTATAATCACCAGCAAC
ATGTTTGGTGATATCATCTCCGATGAAGCCTCCGTTATCCCAGGTTCCTT
GGGTTTGTTGCCATCTGCGTCCTTGGCCTCTTTGCCAGACAAGAACACCG
CATTTGGTTTGTACGAACCATGCCACGGTTCTGCTCCAGATTTGCCAAAG
AATAAGGTTGACCCTATCGCCACTATCTTGTCTGCTGCAATGATGTTGAA
ATTGTCATTGAACTTGCCTGAAGAAGGTAAGGCCATTGAAGATGCAGTTA
AAAAGGTTTTGGATGCAGGTATCAGAACTGGTGATTTAGGTGGTTCCAAC
AGTACCACCGAAGTCGGTGATGCTGTCGCCGAAGAAGTTAAGAAAATCCT
TGCTTAA

HIS3 (nutritional marker that encodes the enzyme imidazolglycerol phosphate dehydratase. This enzyme is involved in the regulation cycle of histidine biosynthesis).

ATGACAGAGCAGAAAGCCCTAGTAAAGCGTATTACAAATGAAACCAAGAT
TCAGATTGCGATCTCTTTAAAGGGTGGTCCCCTAGCGATAGAGCACTCGA
TCTTCCCAGAAAGAGGCAGAAGCAGTAGCAGAACAGGCCACACACAATCG
CAAGTGATTAACGTCCACACAGGTATAGGGTTTCTGGACCATATGATACA
TGCTCTGGCCAAGCATTCCGGCTGGTCGCTAATCGTTGAGTGCATTGGTG
ACTTACACATAGACGACCATCACACCACTGAAGACTGCGGGATTGCTCTC
GGTCAAGCTTTTAAAGAGGCCCTAGGGGCCGTGCGTGGAGTAAAAAGGTT
TGGATCAGGATTTGCGCCTTTGGATGAGGCACTTTCTAGAGCGGTGGTAG
ATCTTTCGAACAGGCCGTACGCAGTTGTCGAACTTGGTTTGCAAAGGGAG
AAAGTAGGAGATCTCTCTTGCGAGATGATCCCGCATTTTCTTGAAAGCTT
TGCAGAGGCTAGCAGAATTACCCTCCACGTTGATTGTCTGCGAGGCAAGA
ATGATCATCACCGTAGTGAGAGTGCGTTCAAGGCTCTTGCGGTTGCCATA
AGAGAAGCCACCTCGCCCAATGGTACCAACGATGTTCCCTCCACCAAAGG
TGTTCTTATGTAG

LYS2 (nutritional marker that encodes the enzyme α-aminoadipic semialdehyde. It is thought that the product of the reaction controlled by LYS2 acts as a co-inductor together with product LYS14 to stimulate the expression of numerous genes involved in the same cycle).

ATGACTAACGAAAAGGTCTGGATAGAGAAGTTGGATAATCCAACTCTTTC
AGTGTTACCACATGACTTTTTACGCCCACAACAAGAACCTTATACGAAAC
AAGCTACATATTCGTTACAGCTACCTCAGCTCGATGTGCCTCATGATAGT
TTTTCTAACAAATACGCTGTCGCTTTGAGTGTATGGGCTGCATTGATATA
TAGAGTAACCGGTGACGATGATATTGTTCTTTATATTGCGAATAACAAAA
TCTTAAGATTCAATATTCAACCAACGTGGTCATTTAATGAGCTGTATTCT
ACAATTAACAATGAGTTGAACAAGCTCAATTCTATTGAGGCCAATTTTTC
CTTTGACGAGCTAGCTGAAAAAATTCAAAGTTGCCAAGATCTGGAAAGGA
CCCCTCAGTTGTTCCGTTTGGCCTTTTTGGAAAACCAAGATTTCAAATTA
GACGAGTTCAAGCATCATTTAGTGGACTTTGCTTTGAATTTGGATACCAG
TAATAATGCGCATGTTTTGAACTTAATTTATAACAGCTTACTGTATTCGA
ATGAAAGAGTAACCATTGTTGCGGACCAATTTACTCAATATTTGACTGCT
GCGCTAAGCGATCCATCCAATTGCATAACTAAAATCTCTCGATCACCGCA
TCATCCAAGGATAGTTTACCTGATCCAACTAAGAACTTGGGCTGGTGCGA
TTTCGTGGGGTGTATTCACGACATTTTCCAGGACAATGCTGAAGCCTTCC
CAGAGAGAACCTGTGTTGTGGAGACTCCAACACTAAATTCCGACAAGTCC
CGTTCTTTCACTTATCGCGACATCAACCGCACTTCTAACATAGTTGCCCA
TTATTTGATTAAAACAGGTATCAAAAGAGGTGATGTAGTGATGATCTATT
CTTCTAGGGGTGTGGATTTGATGGTATGTGTGATGGGTGTCTTGAAAGCC
GGCGCAACCTTTTCAGTTATCGACCCTGCATATCCCCCAGCCAGACAAAC
CATTTACTTAGGTGTTGCTAAACCACGTGGGTTGATTGTTATTAGAGCTG
CTCGACAATTGGATCAACTAGTAGAAGATTACATCAATGATGAATTGGAG
ATTGTTTCAAGAATCAATTCCATCGCTATTCAAGAAAATGGTACCATTGA
AGGTGGCAAATTGGACAATGGCGAGGATGTTTTGGCTCCATATGATCACT
ACAAAGACACCAGAACAGGTGTTGTAGTTGGACCAGATTCCAACCCAACC
CTATCTTTCACATCTGGTTCCGAAGGTATTCCTAAGGGTGTTCTTGGTAG
ACATTTTTCCTTGGCTTATTATTTCAATTGGATGTCCAAAAGGTTCAACT
TAACAGAAAATGATAAATTCACAATGCTGAGCGGTATTGCACATGATCCA
ATTCAAAGAGATATGTTTACACCATTATTTTTAGGTGCCCAATTGTATGT
CCCTACTCAAGATGATATTGGTACACCGGGCCGTTTAGCGGAATGGATGA
GTAAGTATGGTTGCACAGTTACCCATTTAACACCTGCCATGGGTCAATTA
CTTACTGCCCAAGCTACTACACCATTCCCTAAGTTACATCATGCGTTCTT
TGTGGGTGACATTTTAACAAAACGTGATTGTCTGAGGTTACAAACCTTGG
CAGAAAATTGCCGTATTGTTAATATGTACGGTACCACTGAAACACAGCGT
GCAGTTTCTTATTTCGAAGTTAAATCAAAAAATGACGATCCAAACTTTTT
GAAAAAATTGAAAGATGTCATGCCTGCTGGTAAGGTATGTTGAACGTTCA
GCTACTAGTTGTTAACAGGAACGATCGTACTCAAATATGTGGTATTGGCG
AAATAGGTGAGATTTATGTTCGTGCAGGTGGTTTGGCCGAAGGTTATAGA
GGATTACCAGAATTGAATAAAGAAAAATTTGTGAACAACTGGTTTGTTGA
AAAAGATCACTGGAATTATTTGGATAAGGATAATGGTGAACCTTGGAGAC
AATTCTGGTTAGGTCCAAGAGATAGATTGTACAGAACGGGTGATTTAGGT
CGTTATCTACCAAACGGTGACTGTGAATGTTGCGGTAGGGCTGATGATCA
AGTTAAAATTCGTGGGTTCAGAATCGAATTAGGAGAAATAGATACGCACA
TTTCCCAACATCCATTGGTAAGAGAAAACATTACTTTAGTTCGCAAAAAT
GCCGACAATGAGCCAACATTGATCACATTTATGGTCCCAAGATTTGACAA
GCCAGATGACTTGTCTAATTCCAAAGTGATGTTCCAAAGGAGGTTGAAAC
TGACCCTATAGTTAAGGGCTTAATCGGTTACCATCTTTTATCCAAGGACA
TCAGGACTTTCTTAAAGAAAAGATTGGCTAGCTATGCTATGCCTTCCTTG
ATTGTGGTTATGGATAAACTACCATGAATCCAAATGGTAAAGTTGATAAG
CCTAAACTTCAATTCCCAACTCCCAAGCAATTAAATTTGGTAGCTGAAAA
TACAGTTTCTGAAACTGACGACTCTCAGTTTACCAATGTTGAGCGCGAGG
TTAGAGACTTATGGTTAAGTATATTACCTACCAAGCCAGCATCTGTATCA
CCAGATGATTCGTTTTTCGATTTAGGTGGTCATTCTATCTTGGCTACCAA
AATGATTTTTACCTTAAAGAAAAAGCTGCAAGTTGATTTACCATTGGGCA
CAATTTTCAAGTATCCAACGATAAAGGCCTTTGCCGCGGAAATTGACAGA
ATTAAATCATCGGGTGGATCATCTCAAGGTGAGGTCGTCGAAAATGTCAC
TGCAAATTATGCGGAAGACGCCAAGAAATTGGTTGAGACGCTACCAAGTT
CGTACCCCTCTCGAGAATATTTTGTTGAACCTAATAGTGCCGAAGGAAAA
ACAACAATTAATGTGTTGTTACCGGTGTCACAGGATTTCTGGGCTCCTAC
ATCCTTGCAGATTTGTTAGGACGTTCTCCAAAGAACTACAGTTTCAAAGT
GTTTGCCCACGTCAGGGCCAAGGATGAAGAAGCTGCATTTGCAAGATTAC
AAAAGGCAGGTATCACCTATGGTACTTGGAACGAAAAATTTGCCTCAAAT
ATTAAAGTTGTATTAGGCGATTTATCTAAAAGCCAATTTGGTCTTTCAGA
TGAGAAGTGGATGGATTTGGCAAACACAGTTGATATAATTATCCATAATG
GTGCGTTAGTTCACTGGGTTTATCCATATGCCAAATTGAGGGATCCAAAT
GTTATTTCAACTATCAATGTTATGAGCTTAGCCGCCGTCGGCAAGCCAAA
GTTCTTTGACTTTGTTTCCTCCACTTCTACTCTTGACACTGAATACTACT
TTAATTTGTCAGATAAACTTGTTAGCGAAGGGAAGCCAGGCATTTTAGAA
TCAGACGATTTAATGAACTCTGCAAGCGGGCTCACTGGTGGATATGGTCA
GTCCAAATGGGCTGCTGAGTACATCATTAGACGTGCAGGTGAAAGGGGCC
TACGTGGGTGTATTGTCAGACCAGGTTACGTAACAGGTGCCTCTGCCAAT
TGGTTCTTCAAACACAGATGATTTCTTATTGAGATTTTTGAAAGGTTCAG
TCCAATTAGGTAAGATTCCAGATATCGAAAATTCCGTGAATATGGTTCCA
GTAGATCATGTTGCTCGTGTTGTTGTTGCTACGTCTTTGAATCCTCCCAA
AGAAAATGAATTGGCCGTTGCTCAAGTAACGGGTCACCCAAGAATATTAT
TCAAAGACTACTTGTATACTTTACACGATTATGGTTACGATGTCGAAATC
GAAAGCTATTCTAAATGGAAGAAATCATTGGAGGCGTCTGTTATTGACAG
GAATGAAGAAAATGCGTTGTATCCTTTGCTACACATGGTCTTAGACAACT
TACCTGAAAGTACCAAAGCTCCGGAACTAGACGATAGGAACGCCGTGGCA
TCTTTAAAGAAAGACACCGCATGGACAGGTGTTGATTGGTCTAATGGAAT
AGGTGTTACTCCAGAAGAGGTTGGTATATATATTGCATTTTTAAACAAGG
TTGGATTTTTACCTCCACCAACTCATAATGACAAACTTCCACTGCCAAGT
ATAGAACTAACTCAAGCGCAAATAAGTCTAGTTGCTTCAGGTGCTGGTGC
TCGTGGAAGCTCCGCAGCAGCTTA

KAN (antibiotic resistance: it is an aminoglycosidase that acts on protein synthesis by binding to the ribosome subunit 30S to prevent the start of the complex with ‘mRNA. It can also cause a messenger misreading, leading to the formation of a nonsense peptide. Another important function of aminoglycosidase is to increase membrane permeability).

ATGATTGAACAAGATGGATTGCACGCAGGTTCTCCGGCCGCTTGGGTGGA
GAGGCTATTCGGCTATGACTGGGCACAACAGACAATCGGCTGCTCTGATG
CCGCCGTGTTCCGGCTGTCAGCGCAGGGGCGCCCGGTTCTTTTTGTCAAG
ACCGACCTGTCCGGTGCCCTGAATGAACTCCAAGACGAGGCAGCGCGGCT
ATCGTGGCTGGCCACGACGGGCGTTCCTTGCGCAGCTGTGCTCGACGTTG
TCACTGAAGCGGGAAGGGACTGGCTGCTATTGGGCGAAGTGCCGGGGCAG
GATCTCCTGTCATCTCACCTTGCTCCTGCCGAGAAAGTATCCATCATGGC
TGATGCAATGCGGCGGCTGCATACGCTTGATCCGGCTACCTGCCCATTCG
ACCACCAAGCGAAACATCGCATCGAGCGAGCACGTACTCGGATGGAAGCC
GGTCTTGTCGATCAGGATGATCTGGACGAAGAGCATCAGGGGCTCGCGCC
AGCCGAACTGTTCGCCAGGCTCAAGGCGCGGATGCCCGACGGCGAGGATC
TCGTCGTGACCCATGGCGATGCCTGCTTGCCGAATATCATGGTGGAAAAT
GGCCGCTTTTCTGGATTTCATCGACTGTGGCCGGCTGGGTGTGGCGGACC
GCTATCAGGACATAGCGTTGGCTACCCGTGATATTGCTGAAGAGCTTGGC
GGCGAATGGGCTGACCGCTTCCTCGTGCTTTACGGTATCGCCGCTCCCGA
TTCGCAGCGCATCGCCTTCTATCGCCTTCTTGACGAGTTCTTCTGA

BLA (β-lactamase: antibiotic resistance. The product of this gene inhibits certain enzymes involved in bacterial cell wall synthesis. β-lactamase hydrolyzes the β-lactame contained in the antibiotic ampicillin).

ATGAGTATTCAACATTTCCGTGTCGCCCTTATTCCCTTTTTTGCGGCATT
TTGCCTTCCTGTTTTTGCTCACCCAGAAACGCTGGTGAAAGTAAAAGATG
CTGAAGATCAGTTGGGTGCACGAGTGGGTTACATCGAGCTGGATCTCAAC
AGCGGTAAGATCCTTGAGAGTTTTCGCCCCGAAGAACGTTTTCCAATGAT
GAGCACTTTTAAAGTTCTGCTATGTGGTGCGGTATTATCCCGTGTTGACG
CCGGGCAAGAGCAACTCGGTCGCCGCATACACTATTCTCAGAATGACTTG
GTTGAGTACTCACCAGTCACAGAAAAGCATCTTACGGATGGCATGACAGT
AAGAGAATTATGCAGTGCTGCCATAACCATGAGTGATAACACTGCGGCCA
ACTTACTTCTGACAACGATCGGAGGACCGAAGGAGCTAACCGCTTTTTTG
CACAACATGGGGGATCATGTAACCCGCCTTGATCGTTGGGAACCGGAGCT
GAATGAAGCCATACCAAACGACGAGCGTGACACCACGATGCCTGCAGCAA
TGGCAACAACGTTGCGCAAACCTATTAACTGGCGAACTACTTACTCTAGC
TTCCCGGCAACAATTAATAGACTGGATGGAGGCGGATAAAGTTGCAGGAC
CACTTCTGCGCTCGGCCCTTCCGGCTGGCTGGTTTATTGCTGATAAATCT
GGAGCCGGTGAGCGTGGATCTCGCGGTATCATTGCAGCACTGGGGCCAGA
TGGTAAGCCCTCCCGTATCGTAGTTATCTACACGACGGGGAGTCAGGCAA
CTATGGATGAACGAAATAGACAGATCGCTGAGATAGGTGCCTCACTGATT
AAGCATTGGTAA

CAM (antibiotic resistance: the product of this gene acts by binding to the ribosome subunit 50S, thus blocking the formation of peptide binding and inhibiting the activity of peptidyl transferase. It is a potent inhibitor of protein synthesis in eukaryotic cells).

ATGGAGAAAAAAATCACTGGATATACCACCGTTGATATATCCCAATGGCA
TCGTAAAGAACATTTTGAGGCATTTCAGTCAGTTGCTCAATGTACCTATA
ACCAGACCGTTCAGCTGGATATTACGGCCTTTTTAAAGACCGTAAAGAAA
AATAAGCACAAGTTTTATCCGGCCTTTATTCACATTCTTGCCCGCCTGAT
GAATGCTCATCCGGAATTTCGTATGGCAATGAAAGACGGTGAGCTGGTGA
TATGGGATAGTGTTCACCCTTGTTACACCGTTTTCCATGAGCAAACTGAA
ACGTTTTCATCGGTCTGGAGTGAATACCACGACGATTTCCGGCAGTTTCT
ACACATATATTCGCAAGATGTGGCGTGTTACGGTGAAAACCTGGCCTATT
TCCCTAAAGGGTTTATTGAGAATATGTTTTTCGTCTCAGCCAATCCCTGG
GTGAGTTTCACCAGTTTTGATTTAAACGTGGCCAATATGGACAACTTCTT
CGCCCCCGTTTTCACCATGGGCAAATATTATACGCAAGGCGACAAGGTGC
TGATGCCGCTGGCGATTCAGGTTCATCATGCCGTTTGTGATGGCTTCCAT
GTCGGCAGAATGCTTAATGAATTACAACAGTACTGCGATGAGTGGCAGGG
CGGGGCGTAA

Tet R (antibiotic resistance: inhibits the binding of aminoacyl TRNA to the ribosome subunit 30S in bacteria).

ATAGTGATGGCACGACTAAGCTTGGACGACGTAATTTCAATGGCGCTCAC
CCTGCTGGACAGCGAAGGGCTAGAGGGCTTGACTACGCGTAAGCTGGCGC
AGTCCCTAAAAATTGAGCAACCGACTCTGTATTGGCACGTGCGCAACAAG
CAGACTCTTATGAACATGCTTTCAGAGGCAATACTGGCGAAGCATCACAC
CCGTTCAGCACCGTTACCGACTGAGAGTTGGCAGCAGTTTCTCCAGGAAA
ATGCTCTGAGTTTCCGTAAAGCATTACTGGTCCATCGTGATGGAGCCCGA
TTGCATATAGGGACCTCTCCTACGCCCCCCCAGTTTGAACAAGCAGAGGC
GCAACTACGCTGTCTATGCGATGCAGGGTTTTCGGTCGAGGAGGCTCTTT
TCATTCTGCAATCTATCAGCCATTTTACGTTGGGTGCAGTATTAGAGGAG
CAAGCAACAAACCAGATAGAAAATAATCATGTGATAGACGCTGCACCACC
ATTATTACAAGAGGCATTTAATATTCAGGCGAGAACCTCTGCTGAAATGG
CCTTCCATTTCGGGCTGAAATCATTAATATTTGGATTTTCTGCACAGTTA
GATGAAAAAAAGCATACACCCATTGAGGATGGTAATAAATGA

G418-Neomycin (antibiotic resistance. It is an aminogycoside phosphotransferase. It is used in eukaryotic, mammalian and yeast vectors).

ATGAGCCATATTCAACGGGAAACGTCTTGCTCGAGGCCGCGATTAAATTC
CAACATGATGCTGATTTATATGGGTATAAATGGGCTCGCGATAATGTCGG
GCAATCAGGTGCACAATCTATCGATTGTATGGGAAGCCCGATGCGCCAGA
GTTGTTTCTGAAACATGGAAAGGTAGCGTTGCCCAATGATGTTACAGATG
AGATGGTCAGACTAAACTGGCTGACGAATTTATGCCTCTTCCGACCATCA
AGCATTTTATCCGTACTCCTGATGGCATGGTACTCACCACTGCGATCCCC
GGGAAAACAGCATTCCAGGTATTAGAAGAATATCCTGATCAGGTGAAAAT
ATTGTTGATGCGCTGGCAGTGTTCCTGCGCCGGTTGCATTCGATCCTGTT
TGTAATTGTCCTTTTAACAGCGATCGCGTATTTCGTCTCGCTCAGGCGCA
ACACGAATGAATAACGGTTTGGTTGATGCGAGTGATTTTGATGACGAGCG
TAATGGCGGCCTGTTGAACAAGTCTGGAAAGAAATGCATAAGCTTTTGCC
ATTCTCACCGGAATTAGTCGTCACTCATGGTGATTTCTCACTTGATAACC
TTATTTTTGACGAGGGGAAATTATAGGTTGTATTGATGTTGGACGAGTCG
GAATCGCAGACCGATACCAGGATCTTGCCTCCTATGGAACTGCCTCGGTG
AGTTTTCTCCTTCATTACAGAAACGGCTTTTTCAAAATATGGTATTGATA
ATCCTGATATGAATAAATTGCAGTTTCATTTGATGCTCGATGAGTTTTCT
A
ColE1 (origin of replication in E.coli)
CTGTCAGACCAAGTTTACTCATATATACTTTAGATTGATTTAAAACTTCA
TTTTTAATTTAAAAGGATCTAGGTGAAGATCCTTTTTGATAATCTCATGA
CCAAAATCCCTTAACGTGAGTTTTCGTTCCACTGAGCGTCAGACCCCGTA
GAAAAGATCAAAGGATCTTCTTGAGATCCTTTTTTTCTGCGCGTAATCTG
CTGCTTGCAAACAAAAAAACCACCGCTACCAGCGGTGGTTTGTTTGCCGG
ATCAAGAGCTACCAACTCTTTTTCCGAAGGTAACTGGCTTCAGCAGAGCG
CAGATACCAAATACTGTCCTTCTAGTGTAGCCGTAGTTAGGCCACCACTT
CAAGAACTCTGTAGCACCGCCTACATACCTCGCTCTGCTAATCCTGTTAC
CAGTGGCTGCTGCCAGTGGCGATAAGTCGTATCTTACCGGGTTGGACTCA
AGACGATAGTTACCGGATAAGGCGCAGCGGTCGGGCTGAACGGGGGGTTC
GTGCACACAGCCCAGCTTGGAGCGAACGACCTACACCGAACTGAGATACC
TACAGCGTGAGCTATGAGAAAGCGCCACGCTTCCCGAAGGGAGAAAGGCG
GACAGGTATCCGGTAAGCGGCAGGGTCGGAACAGGAGAGCGCACGAGGGA
GCTTCCAGGGGGAAACGCCTGGTATCTTTATAGTCCTGTCGGGTTTCGCC
ACCTCTGACTTGAGCGTCGATTTTTGTGATGCTCGTCAGGGGGGCGGAGC
CTATGGAAAAACGCCAGCAACGCGGCCTTTTTACGGTTCCTGGCCTTTTG
CTGGCCTTTTGCTCACATGTTCTTTCCTGCGTTATCCCCTGATTCTGTGG
ATAACCGTATTACCGCCTTTGAGTGAGCTGATACCGCTCGCCGCAGCCGA
ACGACCGAGCGCAGCGAGTCAGTGAGCGAGGAAGCGGAAGA
2μ (origin of replication in S.cerevisiae)
CATTTAAGCATAAACACGCACTATGCCGTTCTTCTCATGTATATATATAT
ATCAGGCAACACGCAGATATAGGTGCGACGTGAACAGTGAGCTGTATGTG
CGCAGCTCGCGTTGCATTTTCGGAAGCGCTCGTTTTCGGAAACGCTTTGA
AGTTCCTATTCCGAAGTTCCTATTCTCTAGCTAGAAAGTATAGGAACTTC
AGAGCGTTTTGAAAACCAAAAGCGCTCTGAAGACGCACTTTCAAAAAACC
AAAAACGCACCGGACTGTAACGAGCTACTAAAATATTGCGAATACCGCTT
CCACAAACATTGCTCAAAAGTATCTCTTTGCTATATATCTCTGTGCTATA
TCCCTATATAACCTACCCATCCACCTTTCGCTCCTTGAACTTGCATCTAA
ACTCGACCTCTACATTTTTTATGTTTATCTCTAGTATTACTCTTTAGACA
AAAAAATTGTAGTAAGAACTATTCATAGAGTGAATCGAAAACAATACGAA
AATGTAAACATTTCCTATACGTAGTATATAGAGACAAAATAGAAGAAACC
GTTCATAATTTTCTGACCAATGAAGAATCATCAACGCTATCACTTTCTGT
TCACAAAGTATGCGCAATCCACATCGGTATAGAATATAATCGGGGATGCC
TTTATCTTGAAAAAATGCACCCGCAGCTTCGCTAGTAATCAGTAAACGCG
GGAAGTGGAGTCAGGCTTTTTTTATGGAGAGAAAATAGACACCAAAGTAG
CCTTCTTCTAACCTTAACGGACCTACAGTGCAAAAAGTTATCAAGAGACT
GCATTATAGAGCGCACAAAGGAGAAAAAAAGTAATCTAAGATGCTTTGTT
AGAAAAATAGCGCTCTCGGGATGCATTTTTGTAGAACAAAAAAGAAGTAT
AGATTCTTTGTTGGTAAAATAGCGCTCTCGCGTTGCATTTCTGTTCTGTA
AAAATGCAGCTCAGATTCTTTGTTTGAAAAATTAGCGCTCTCGCGTTGCA
TTTTTGTTTTACAAAAATGAAGCACAGATTCTTCGTTGGTAAAATAGCGC
TTTCGCGTTGCATTTCTGTTCTGTAAAAATGCAGCTCAGATTCTTTGTTT
GAAAAATTAGCGCTCTCGCGTTGCATTTTTGTTCTACAAAATGAAGCACA
GATGCTTCGTT
LexA (DNA-binding domain)
ATGAAAGCGTTAACGGCCAGGCAACAAGAGGTGTTTGATCTCATCCGTGA
TCACATCAGCCAGACAGGTATGCGGCCGACGCGTGCGGAAATCGCGCAGC
GTTTGGGGGTTCCGTTCCCCAAACGCGGCTGAAGAACATCTGAAGGCGCT
GGCACGCAAAGGCGTTATTGAAATTGTTTCCGGCGCATCACGCGGGATTC
GTCTGTTGCAGGAAGAGGAAGAAGGGTTGCCGCTGGTAGGTCGTGTGGCT
GCCGGTGAACCACTTCTGGCGCAACAGCATATTGAAGGTCATTATCAGGT
CGATCCTTCCTTATTCAAGCCGAATGCTGATTTCCTGCTGCGCGTCAGCG
GGATGTCGATGAAAGATATCGGCATTATGGATGGTGACTTGGTGGCAGTG
CATAAAACTCAGGATGTACGTAACGGTCAGGTCGTTGTCGCACGTATTGA
TGACGAAGTTACCGTTAAGCGCCTGAAAAAACAGGGCAATAAAGTCGAAC
TGTTGCCAGAAAATAGCGAGTTTAAACCAATTGTCGTTGACCTTCGTCAG
CAGAGCTTCACCATTGAAGGGCTGGCGGTTGGGGTTATTCGCAACGGCGA
CTGGCTG
VP16 (activation domain)
CGGCCCCCCCGACCGATGTCAGCCTGGGGGACGAGCTCCACTTAGACGGC
GAGGACGTGGCGATGGCGCATGCCGACGCGCTAGACGATTTCGATCTGGA
CATGTTGGGGGACGGGGATTCCCCGGGGCCGGGATTTACCCCCCACGACT
CCGCCCCCTACGGCGCTCTGGATATGGCCGACTTCGAGTTTGAGCAGATG
TTTACCGATGCCCTTGGAATTGACGAGTACGGTGGG
B42 (activation domain)
ATGGGTGCTCCTCCAAAAAAGAAGAGAAAGGTAGCTGGTATCAATAAAGA
TATCGAGGAGTGCAATGCCATCATTGAGCAGTTTATCGACTACCTGCGCA
CCGGACAGGAGATGCCGATGGAAATGGCGGATCAGGCGATTAACGTGGTG
CCGGGCATGACGCCGAAAACCATTCTTCACGCCGGGCCGCCGATCCAGCC
TGACTGGCTGAAATCGAATGGTTTTCATGAAATTGAAGCGGATGTTAACG
ATACCAGCCTCTTGCTGAGTGGAGATGCCTCCTACCCTTATGA
ADH1 prom (promoter)
ATGAAAGCGTTAACGGCCAGGCAACAAGAGGTGTTTGATCTCATCCGTGA
TCACATCAGCCAGACAGGTATGCCGCCGACGCGTGCGGAAATCGCGCAGC
GTTTGGGGTTCCGTTCCCCAAACGCGGCTGAAGAACATCTGAAGGCGCTG
GCACGCAAAGGCGTTATTGAAATTGTTTCCGGCGCATCACGCGGATTCGT
CTGTTGCAGGAAGAGGAAGAAGGGTTGCCGCTGGTAGGTCGTGTGGCTGC
CGGTGAACCACTTCTGGCGCAACAGCATATTGAAGGTCATTATCAGGTCG
ACCTTCCTTATTCAAGCCGAATGCTGATTTCCTGCTGCGCGTCAGCGGGA
TGTCGATGAAAGATATCGGCATTATGGATGGTGACTTGCTGGCAGTGCAT
AAAACTCAGGATGTACGTAACGGTCAGGTCGTTGTCGCACGTATTGATGA
CGAAGTTACCGTTAAGCGCCTGAAAAAACAGGGCAATAAAGTCGAACTGT
TGCCAGAAAATAGCGAGTTTAAACCAATTGTCGTAGATCTTCGTCAGCAG
AGCTTCACCATTGAAGGGCTGGCGGTTGGGGTTATTCGCAACGGCGACTG
GCTGGAATTCCCGGGGATCCGTCGACCATGGCGGCCGCTCGAGTCGACCT
GCAGCCAAGCTAATTCCGGGCGAATTTCTTATGATTTATGA
GAL-10 bi-directional prom (inducible bi-
directional promoter)
GGATCCCCTTTCAAAAATTCTTACTTTTTTTTTGGATGGACGCAAAGAAG
TTTAATAATCATATTACATGGCATTACCACCATATACATATCCATATACA
TATCCATATCTAATCTTACTTATATGTTGTGGAAATGTAAAGAGCCCCAT
TATCTTAGCCTAAAAAAACCTTCTCTTTGGAACTTTCAGTAATACGCTTA
ACTGCTCATTGCTATATTGAAGTACGGATTAGAAGCCGCCGAGCGGGTGA
CAGCCCTCCGAAGGAAGACTCTCCTCCGTGCGTCCTCGTCTTCACCGGTC
GCGTTCCTGAAACGCAGATGTGCCTCGCGCCGCACTGCTCCGAACAATAA
AGATTCTACAATACTAGCTTTTATGGTTATGAAGAGGAAAAATTGGCAGT
AACCTGGCCCCACAAACCTTCAAATGAACGAATCAAATTAACAACCATAG
GATGATAATGCGATTAGTTTTTTAGCCTTATTTCTGGGTAATTAATCAGC
GAAGCGATGATTTTTGATCTATTAACAGATATATAAATGCAAAAACTGCA
TAACCACTTTAACTAATACTTTCAACATTTTCGGTTTGTATTACTTCTTA
TTCAAATGTAATAAAAGTATCAACAAAAAATTGTTAATATACCTCTATAC
TTTAACGTCAAGGAGAAAAAACCCGGG
GAL1 prom (inducible promoter)
ACGGATTAGAAGCCGCCGAGCGGGTGACAGCCCTCCGAAGGAAGACTCTC
CTCCGTGCGTCCTCGTCTTCACCGGTCGCGTTCCTGAAACGCAGATGTGC
CTCGCGCCGCACTGCTCCGAACAATAAAGATTCTACAATACTAGCTTTTA
TGGTTATGAAGAGGAAAAATTGGCAGTAACCTGGCCCCACAAACCTTCAA
ATGAACGAATCAAATTAACAACCATAGGATGATAATGCGATTAGTTTTTT
AGCCTTATTTCTGGGGTAATTAATCAGCGAAGCGATGATTTTTGATCTAT
TAACAGATATATAAATGCAAAAACTGCATAACCACTTTAACTAATACTTT
CAACATTTTCGGTTTGTATTACTTCTTATTCAAATGTAATAAAAGTATCA
ACAAAAAATTGTTAATATACCTCTATACTTTAACGTCAAGGAGAAAAAAC
C
ADH1 term (transcription stop sequence)
AAGCTTTTCATAGGGTAGGGGAATTTCGGGCATGCCGGTAGAGGTGTGGT
CAATAAGAGCGACCTCATGCTATACCTGAGAAAGCAACCTGACCTACAGG
AAAGAGTTACTCAAGAACAAGAATTTTCGTTTTAAAACCTAAGAGTCACT
TAAAATTTGTATACACTTATTTTTTTTATAACTTATTTAATAATAAAAAT
CATAAATCATAAGAAATTCGCTTATTTAGAAGTGTCAACAACGTATCTAC
CAACGATTTGACCCTTTTCCATCTTTTCGTAAATTTCTGGCAAGGTAGAC
AAGCCGACAACCTTGATTGGAGACTTGACCAAACCTCTGGCGAAGAA GT
CCA
ADH2 term (transcription stop sequence)
GAATTCGACACTTCTAAATAAGCGGATCTCCTATGCCTTCACGATTTATA
GTTTCCATTATCAAGTATGCCTATATTAGTATATAGCATCTTTAGATGAC
AGTGTTCGAAGTTTCACGAATAAAAGATAATATTCTACTTTTTGCTCCCA
CCGCGTTTGCTAGCACGAGTGAACACCATCCCTCGCCTGTGAGTTGTACC
CATTCCTCTAAACTGTAGACATGGTAGCTTCAGCAGTGTTCGTTATGTAC
GGCATCCTCCAACAAACAGTCGGTTATAGTTTGTCCTGCTCCTCTGAATC
GTCTCCCTCGATATTTCTCATTTTCCTTCGCATGCCCTCGAG
CRE GENE
ATGTCCAATTTACTGACCGTACACCAAAATTTGCCTGCATTACCGGTCGA
TGCAACGAGTGATGAGTTCGCAAGAACCTGATGGACATGTTCAGGGATCG
CCAGGCGTTTTCTGAGCATACCTGGAAAATGCTTCTGTCCGTTTGCCGGT
CGTGGGCGGCATGGTGCAAGTTGAATAACCGGAAATGGTTTCCCGCAGAA
CCTGAAGATGTTCGCGATTATCTTCTATATCTTCAGGCGCGCGGTCTGGC
AGTAAAAACTATCCAGCAACATTTGGGCCAGCTAAACATGCTTCATCGTC
GGTCCGGGCTGCCACGACCAAGTGACAGCAATGCTGTTTCACTGGTTATG
CGGCGGATCCGAAAAGAAAACGTTGATGCCGGTGAACGTGCAAAACAGGC
TCTAGCGTTCGAACGCACTGATTTCGACCAGGTTCGTTCACTCATGGAAA
ATAGCGATCGCTGCCAGGATATACGTAATCTGGCATTTCTGGGGATTTGC
TTATAACACCCTGTTACGTATAGCCGAAATTGCCAGGATCAGGGTTAAAG
ATATCTACAGTACTGACGGTGGGAGAATGTTAATCCATATTGGCAGAACG
AAAACGCTGGTTAGCACCGCAGGTGTAGAGAAGGCACTTAGCCTGGGGGT
AACTAAACTGGTCGAGCGATGGATTTCCGTCTCTGGTGTAGCTGATGATC
CGAATAACTACCTGTTTTGCCGGGTCAGAAAAAATGGTGTTGCCGCGCCA
TCTGCCACCAGCCAGCTATCAACTCGCGCCCTGGAAGGGATTTTTGAAGC
AACTCATCGATTGATTTACGGCGCTAAGGATGACTCTGGTCAGAGATACC
TGGCCTGGTCTGGACACAGTGCCCGTGTCGGAGCCGCGCGAGATATGGCC
CGCGCTGGAGTTTCAATACCGGAGATCATGCAAGCTGGTGGCTGGACCAA
TGTAAATATTGTCATGAACTATATCCGTACCCTGGATAGTGAAACAGGGG
CAATGGTGCGCCTGCTGGAAGATGGCGATTAG
PolyLINKER pMIC-BD1 and pMIC-BD2 and pBTM116
GAATTCCCGGGGATCCGTCGACCTGCAG
POLYLINKER pVP16
GGCCCAGCCGGCCGTCGACGCGGCCGCCTCGAG
POLYLINKERS plinker220 and pVP16mv1
GCGCGCATGCC....(VL)....TCCGGAGGGTCGACCAGCGGTTCTGGG
AAACCAGGTTCCGGTGAAGGCTCGAGCGGTACC....(VH)....GCTAG
CGGCAQACCAATCCCAAACCCACTGCTGGGCCTGGATAGTACT

### REFERENCES

Baird, G. S., Zacharias, D. A. and Tsien, R. Y. (1999) Circular permutation and receptor insertion within green fluorescent proteins. Proc Natl Acad Sci USA 96, 11241-6.
Bartel, P. L., Chien, C., Sternglanz, R. and Fields, S. (1993) Using the two-hybrid system to detect protein-protein interaction. In: D. A. Hartley (Ed) Cellular interaction in development: a practical approach. IRL Press, Oxford, p. 153-179.
Biocca, S., Neuberger, M. S. and Cattaneo, A. (1990) Expression and targeting of intracellular antibodies in mammalian cells. Embo J 9, 101-8.
Biocca, S., Ruberti, F., Tafani, M., Pierandrei-Amaldi, P. and Cattaneo, A. (1995) Redox state of single chain Fv fragments targeted to the endoplasmic reticulum, cytosol and mitochondria. Biotechnology (N Y) 13, 1110-5.
Capecchi, M. R. (1989) Altering the genome by homologous recombination. Science 244, 1288-92.
Cattaneo, A. and Biocca, S. (1997) Intracellular Antibodies: Development and Applications.
Cattaneo, A. and Biocca, S. (1999) The selection of intracellular antibodies. Trends in Biotechnology 17, 115-121.
Chen, Y. Q., Sengchanthalangsy, L. L., Hackett, A. and Ghosh, G. (2000) NF-kappaB p65 (ReIA) homodimer uses distinct mechanisms to recognize DNA targets. Structure Fold Des 8, 419-28.
Clarke, L. and Carbon, J. (1976) A colony bank containing synthetic Col E1 hybrid plasmids representative of the entire E. coli genome. Cell 9, 91-9.
Engberg, J., Andersen, P. S., Nielsen, L. K., Dziegiel, M., Johansen, L. K. and Albrechtsen, B. (1996) Phage-display libraries of murine and human antibody Fab fragments. Mol Biotechnol 6,287-310.
Feldhaus, M. J., Siegel, R. W., Opresko, L. K., Coleman, J. R., Feldhaus, J. M., Yeung, Y. A., Cochran, J. R., Heinzelman, P., Colby, D., Swers, J., Graff, C., Wiley, H. S. and Wittrup, K. D. (2003) Flow-cytometric isolation of human antibodies from a nonimmune Saccharomyces cerevisiae surface display library. Nat Biotechnol 21, 163-70.
Fire, A. (1999) RNA-triggered gene silencing. Trends Genet 15, 358-63.
Glass, C. K and Rosenfeld, M. G. (2000) The coregulator exchange in transcriptional functions of nuclear receptors. Genes Dev 14, 121-41.
Griffiths, A. D., Malmqvist, M., Marks, J. D., Bye, J. M., Embleton, M. J., McCafferty, J., Baier, M., Holliger, K. P., Gorick, B. D., Hughes-Jones, N. C. and et al. (1993) Human anti-self antibodies with high specificity from phage display libraries. Embo J 12, 725-34.
Griffiths, A. D., Williams, S. C., Hartley, O., Tomlinson, I. M., Waterhouse, P., Crosby, W. L., Kontermann, P. E., Jones, P. T., Low, N. M., Allison, T. J. and et al. (1994) Isolation of high affinity human antibodies directly from large synthetic repertoires. Embo J 13, 3245-60.
Hollenberg, S. M., Sternglanz, R., Cheng, P. F. and Weintraub, H. (1995) Identification of a new family of tissue-specific basic helix-loop-helix proteins with a two-hybrid system. Molecular and Cellular Biology 15, 3813-3822.
Kortt, A. A., Dolezal, O., Power, B. E. and Hudson, P. J. (2001) Dimeric and trimeric antibodies: high avidity scFvs for cancer targeting. Biomol Eng 18, 95-108.
Kunsch, C., Ruben, S. M. and Rosen, C. A. (1992) Selection of optimal kappa B/Rel DNA-binding motifs: interaction of both subunits of NF-kappa B with DNA is required for transcriptional activation. Mol Cell Biol 12, 4412-21.
Orlandi, R., Gussow, D. H., Jones, P. T. and Winter, G. (1992) Cloning immunoglobulin variable domains for expression by the polymerase chain reaction. 1989. Biotechnology 24,527-31.
Persic, L., Righi, M., Roberts, A., Hoogenboom, H. R., Cattaneo, A. and Bradbury, A. (1997) Targeting vectors for intracellular immunisation. Gene 187, 1-8.
Prasher, D. C., Eckenrode, V. K., Ward, W. W., Prendergast, F. G. and Cormier, M. J. (1992) Primary structure of the Aequorea victoria green-fluorescent protein. Gene 111, 229-33.
Proba, K., Honegger, A. and Pluckthun, A. (1997) A natural antibody missing a cysteine in VH: consequences for thermodynamic stability and folding. J Mol Biol 265, 161-72.
Proba, K., Worn, A., Honegger, A. and Pluckthun, A. (1998) Antibody scFv fragments without disulfide bonds made by molecular evolution. J Mol Biol 275, 245-53.
Rhee, Y., Gurel, F., Gafni, Y., Dingwall, C. and Citovsky, V. (2000) A genetic system for detection of protein nuclear import and export. Nat Biotechnol 18, 433-7.
Rossi, J. J. (1999) Ribozymes, genomics and therapeutics. Chem Biol 6, R33-7.
Sblattero, D. and Bradbury, A. (2000) Exploiting recombination in single bacteria to make large phage antibody libraries. Nat Biotechnol 18, 75-80.
Sheets, M. D., Amersdorfer, P., Finnem, R, Sargent, P., Lindquist, E., Schier, R., Hemingsen, G., Wong, C., Gerhart, J. C., Marks, J. D. and Lindqvist, E. (1998) Efficient construction of a large nonimmune phage antibody library: the production of high-affinity human single-chain antibodies to protein antigens (Sheets et al.). Proc Natl Acad Sci USA 95, 6157-62.
Siegel, M. S. and Isacoff, E. Y. (1997) A genetically encoded optical probe of membrane voltage. Neuron 19, 735-41.
Tanaka, T., Chung, G. T., Forster, A., Lobato, M. N. and Rabbitts, T. H. (2003) De novo production of diverse intracellular antibody libraries. Nucleic Acids Res 31, e23.
Tavernarakis, N., Wang, S. L., Dorovkov, M., Ryazanov, A. and Driscoll, M. (2000) Heritable and inducible genetic interference by double-stranded RNA encoded by transgenes. Nat Genet 24, 180-3.
Todorovska, A., Roovers, R. C., Dolezal, O., Kortt, A. A., Hoogenboom, H. R. and Hudson, P. J. (2001) Design and application of diabodies, triabodies and tetrabodies for cancer targeting. J Immunol Methods 248, 47-66.
Tomlinson, I. and Holliger, P. (2000) Methods for generating multivalent and bispecific antibody fragments. Methods Enzymol 326, 461-79.
Uetz, P., Giot, L., Cagney, G., Mansfield, T. A., Judson, R. S., Knight, J. R., Lockshon, D., Narayan, V., Srinivasan, M., Pochart, P., Qureshi-Emili, A., Li, Y., Godwin, B., Conover, D., Kalbfleisch, T., Vijayadamodar, G., Yang, M., Johnston, M., Fields, S. and Rothberg, J. M. (2000) A comprehensive analysis of protein-protein interactions in Saccharomyces cerevisiae. Nature 403, 623-7.
Vaughan, T. J., Williams, A. J., Pritchard, K., Osbourn, J. K., Pope, A. R., Earnshaw, J. C., McCafferty, J., Hodits, R. A., Wilton, J. and Johnson, K. S. (1996) Human antibodies with sub-nanomolar affinities isolated from a large non-immunized phage display library (Uetz et al.). Nat Biotechnol 14, 309-14.
Visintin, M. and Cattaneo, A. (2001) Selecting intracellular antibodies using the two-hybrid system. In: R. Kontermann, & Dubel, S., eds (Ed) Antibody Engineering, Vol. 1, Springer Lab Manual. Springer, Heidelberg, Germany, p. 790.
Visintin, M., Settanni, G., Maritan, A., Graziosi, S., Marks, J. D. and Cattaneo, A. (2002) The intracellular antibody capture technology (IACT): towards a consensus sequence for intracellular antibodies. J Mol Biol 317, 73-83.
Visintin, M., Tse, E., Axelson, H., Rabbitts, T. H. and Cattaneo, A. (1999) Selection of antibodies for intracellular function using a two-hybrid in vivo system. In: Proc Natl Acad Sci USA, Vol. 96, p. 11723-8.
Visintin, M., Tse, E., Axelson, H., Rabbitts, T. H. and Cattaneo, A, (1999) Selection of antibodies for intracellular function using a two-hybrid in vivo system. In: Proc Natl Acad Sci USA, Vol. 96, p. 11723-8.
Wu, A. M. and Yazaki, P. J. (2000) Designer genes: recombinant antibody fragments for biological imaging. Q J Nucl Med 44,268-83.
Zhong, H., SuYang, H., Erdjument-Bromage, H., Tempst, P. and Ghosh, S. (1997) The transcriptional activity of NF-kappaB is regulated by the IkappaB-associated PKAc subunit through a cyclic AMP-independent mechanism. Cell 89, 413-24.
Zhong, H., Voll, R. E. and Ghosh, S. (1998) Phosphorylation of NF-kappa B p65 by PKA stimulates transcriptional activity by promoting a novel bivalent interaction with the coactivator CBP/p300. Mol Cell 1, 661-71.

1. A method to isolate intracellular antibodies able to neutralize an interaction between a known protein ligand x and a known protein ligand y inside a cell, comprising the steps of:
a) obtaining a recombinant yeast strain wherein:
i) the protein ligand x and the protein ligand y are expressed, but
ii) at least one of x or y is expressed in an inducible manner, and
iii) the interaction between the protein ligand x and the protein ligand would lead to the production either of a repressor of an essential function of the yeast cell or of a toxic agent, so that non viable yeast cells would be obtained;
b) constructing an expression library of intracellular antibodies in the recombinant yeast strain of point a);
c) selecting transformed yeast clones by inducing the expression of both ligand x and ligand y; and
d) isolating recipient yeast clones able to grow.

2. A method to isolate intracellular antibodies able to neutralize an interaction between a known protein ligand x and a known protein ligand y inside a cell, comprising the steps of:
a) obtaining an expression library of intracellular antibodies in a yeast strain with mat-a or mat-alpha sexual competence;
b) obtaining a recombinant yeast strain having a sexually competence opposite to that of the yeast strain in point a) wherein:
i) the protein ligand x and the protein ligand y are expressed, but
ii) at least one of x or y is expressed in an inducible manner, and
iii) the interaction between the protein ligand x and the protein ligand would lead to the production either of a repressor of an essential function of the yeast cell or of a toxic agent, so that non viable yeast cells would be obtained;
c) exposing yeasts of point a) and recombinant yeasts of point b) to conditions able to promote sexual mating and the expression of the ligands x and y;
d) selecting transformed yeast clones by inducing the expression of both ligand x and ligand y; and
e) isolating recipient yeast clones able to grow.

3. The method according to claim 1 wherein the recombinant yeast strain is obtained by:
a) cloning a first sequence encoding the protein ligand x and a second sequence encoding the protein ligand y into a yeast expression vector, each first and second sequence being under the control of each one of two portions of a bidirectional promoter, the first sequence being fused to a sequence encoding a first molecule, and the second sequence being fused to a sequence encoding a second molecule, so that when the protein ligand x and the protein ligand y interact said first molecule and said second molecule interact too in a way to induce the production either of a repressor of an essential function of the yeast cell or of a toxic agent; b) transforming the recipient yeast strain with the vector of point a); and c) selecting transformed yeasts.

4. The method according to claim 3 wherein the expression vector in yeast comprises as a bidirectional promoter the promoters Gal 1 and Gal 10.

5. The method according to claim 3 wherein the first and the second molecule leads to the production of a repressor able to shut down the transcription of the yeast HIS3 gene.

6. The method according claim 1 in which the expression library of intracellular antibodies in yeast is obtained from mouse or human lymphocytes.

7. The method according claim 1 in which the expression library of intracellular antibodies in yeast is obtained in a scFv or in a single domain antibody format.

8. An intracellular antibody able to neutralize an interaction between a protein ligand x and a protein ligand y inside a cell obtainable according to the method of any of previous claims.

9. The intracellular antibody according to claim 8 wherein the protein ligand x and the protein ligand y are p65 RelA and p65 RelA, respectively.

10. The intracellular antibody according to claim 8 wherein the protein ligand x and the protein ligand y are p65 RelA and p50 NF-KB1, respectively.

11. The intracellular antibody according to claim 8 wherein the protein ligand x and the protein ligand y are Aβ1-42 and Aβ 1-42, respectively.

12. The intracellular antibody according to claim 8 wherein the protein ligand x and the protein ligand y are JX-TK TrkA and PTB p66 Shc, respectively.

13. The intracellular antibody according to claim 8 wherein the protein ligand x and the protein ligand y are Synuclein and Synphilin, respectively.

14. A nucleotide sequence encoding the intracellular antibody according to claim 8.

15. A yeast expression vector for cloning a sequence encoding a protein ligand x and a sequence encoding a protein ligand y able to interact each other, comprising a bidirectional promoter wherein the first promoter portion is 5′ to 3′ followed by appropriate restriction cloning sites for the sequence encoding the protein ligand x and a first sequence encoding a first molecule; and the second promoter portion is 5′ to 3′ followed by appropriate restriction cloning sites for the sequence encoding the protein ligand y and a second sequence encoding a second molecule, so that when the protein ligand x and the protein ligand y interact, said first molecule and said second molecule interact too in a way to induce the production either of a repressor of an essential function of the yeast cell or of a toxic agent.

16. A method to simultaneously identify both a protein ligand x able to bind to a known protein ligand y inside an eukaryotic cell, and an intracellular antibody able to neutralize said interaction between the protein ligand x and the known protein ligand y, comprising the steps of:
a) obtaining an expression library of intracellular antibodies in a yeast strain with mat-a or mat-alpha sexual competence;
b) obtaining a recombinant yeast strain having a sexually competence opposite to that of the yeast strain in point a) wherein:
i) the protein ligand y is expressed in an inducible manner, and
ii) the interaction between the protein ligand x and the protein ligand y would lead to the production either of a repressor of an essential function of the yeast cell or of a toxic agent, so that non viable yeast cells would be obtained;
c) cloning into a suitable yeast expression vector a cDNA library containing the sequence encoding the protein ligand x;
d) transforming the yeast strain of point b) with the cDNA library of point c),
e) selecting transformed yeasts;
f) submitting the yeasts of point a) and the yeasts of point e) to such conditions to promote sexual reproduction and the expression of the bidirectional promoter in an environment able to induce the expression of the protein ligand x and protein ligand y;
g) selecting viable yeast clones in which the interaction between the protein ligand x and the protein ligand y is disrupted by the intracellular antibody.

17. A method to simultaneously identify both a protein ligand x able to bind to a known protein ligand y inside an eukaryotic cell, and an intracellular antibody able to neutralize said interaction between the protein ligand x and the known protein ligand y, comprising the steps of:
a) obtaining an expression library of intracellular antibodies in a yeast strain with mat-a or mat-alpha sexual competence;
b) cloning a cDNA library containing the sequence encoding the protein ligand x and a sequence encoding the protein ligand y into a yeast expression vector, the cDNA library sequences being under the control of one of two portions of a bidirectional inducible promoter, the cDNA library sequences being fused to a sequence encoding a first molecule; and the sequence encoding the protein ligand y being under the control of the other of two portions of the bidirectionzl promoter, and being fused to a sequence encoding a second molecule, so that when the protein ligand x and the protein ligand y interact said first molecule and said second molecule interact too, in a way to induce the production either of a repressor of an essential function of the yeast cell or of a toxic agent;
c) transforming a yeast strain having a sexually competence opposite to that of the yeast strain in point a) with the recombinant yeast expression vector of point b);
d) selecting transformed yeasts;
e) submitting the yeasts of point a) and the yeasts of point d) to such conditions to promote sexual reproduction and the expression of the bidirectional promoter in an environment able to induce the expression of the protein ligand x and protein ligand y;
g) selecting viable yeast clones in which the interaction between the protein ligand x and the protein ligand y is disrupted by the intracellular antibody.


SEQUENCE LISTING (104 sequences)

SEQ ID NO: 1 - DNA, 69 bp, Artificial
  synthetic
tcgatttccaccatggcgccgaaaaaaaagagaaaagtggcccagccgagcgcgcatgccgatattgtg

SEQ ID NO: 2 - DNA, 56 bp, Artificial
  synthetic
ttcttgggtgccatggcggagctcgaaacgctagctgaggagacggtgaccgtggt

SEQ ID NO: 3 - DNA, 37 bp, Artificial
  synthetic
tcgagcggtaccgctagcgtttcgagctccgccatgg

SEQ ID NO: 4 - DNA, 38 bp, Artificial
  synthetic
cggccagtgaattcctactacccaccgtactcgtcaat

SEQ ID NO: 5 - DNA, 36 bp, Artificial
  synthetic
caaaccgaaaagcttatgagcgcgcatgccgatatc

SEQ ID NO: 6 - DNA, 78 bp, Artificial
  synthetic
caaaccgctagcgcacccaagaagaagcggaaggtcgcacccaagaagaagcggaaggtcccaggtgtaccgagctcg

SEQ ID NO: 7 - DNA, 38 bp, Artificial; identical to SEQ ID NO: 4
  synthetic

SEQ ID NO: 8 - DNA, 33 bp, Artificial
  synthetic
gttaccgttaagcgcctgaaaaaacagggcaat

SEQ ID NO: 9 - protein, 11 aa, Artificial
  Synthetic Construct
VTVKRLKKQGN

SEQ ID NO: 10 - DNA, 33 bp, Artificial
  synthetic
gttaccgttaagggcctggaaaaacagggcaat

SEQ ID NO: 11 - protein, 11 aa, Artificial
  Synthetic Construct
VTVKGLEKQGN

SEQ ID NO: 12 - DNA, 36 bp, Artificial
  synthetic
aagatgaaagcgttaacggccaggcaacaagaggtg

SEQ ID NO: 13 - DNA, 78 bp, Artificial
  synthetic
aacgacaattggtttaaactcgctattttctggcaacagttcgactttattgccctgtttttccaggcccttaacggt

SEQ ID NO: 14 - DNA, 34 bp, Artificial
  synthetic
ataacttcgtataatgtatactatacgaagttat

SEQ ID NO: 15 - DNA, 34 bp, Artificial
  synthetic
ataacttcgtataatgtatgctatacgaagttat

SEQ ID NO: 16 - DNA, 63 bp, Artificial
  synthetic
tccggagggtcgaccataacttcgtataatgtatactatacgaagttatcctcgagcggtacc

SEQ ID NO: 17 - DNA, 58 bp, Artificial
  synthetic
ggagggtcgaccataacttcgtataatgtatactatacgaagttatcctcgagcggta

SEQ ID NO: 18 - DNA, 38 bp, Artificial
  synthetic
ccaggcccagcagtgggtttgggattggtttgccgcta

SEQ ID NO: 19 - DNA, 57 bp, Artificial
  synthetic
accgctcgaggataacttcgtatagtatacattatacgaagttatggtcgaccctcc

SEQ ID NO: 20 - DNA, 40 bp, Artificial
  synthetic
cgctggattgttattactcgcagcaagcggcgcgcatgcc

SEQ ID NO: 21 - DNA, 69 bp, Artificial
  synthetic
ctatctatctaggatccataacttcgtatagcatacattatacgaagttatcccaccgtactcgtcaat

SEQ ID NO: 22 - DNA, 27 bp, Artificial
  synthetic
ggctaaagcttatttaggtgacactat

SEQ ID NO: 23 - DNA, 44 bp, Artificial
  synthetic
ccgatcggacaccaggtgctgtcagaagaactcgtcaagaaggc

SEQ ID NO: 24 - DNA, 44 bp, Artificial
  synthetic
aatgaaatgcatcgggacgtccttccgcttcctcgctcactgac

SEQ ID NO: 25 - DNA, 38 bp, Artificial
  synthetic
ttatcctcgagcggtaccgakgtrmagcttcaggagtc

SEQ ID NO: 26 - DNA, 38 bp, Artificial
  synthetic
ttatcctcgagcggtaccgaggtbcagctbcagcagtc

SEQ ID NO: 27 - DNA, 38 bp, Artificial
  synthetic
ttatcctcgagcggtacccaggtgcagctgaagsastc

SEQ ID NO: 28 - DNA, 38 bp, Artificial
  synthetic
ttatcctcgagcggtaccgaggtccarctgcaacartc

SEQ ID NO: 29 - DNA, 38 bp, Artificial
  synthetic
ttatcctcgagcggtacccaggtycagctbcagcartc

SEQ ID NO: 30 - DNA, 38 bp, Artificial
  synthetic
ttatcctcgagcggtacccaggtycarctgcagcagtc

SEQ ID NO: 31 - DNA, 36 bp, Artificial
  synthetic
ttatcctcgagcggtacccaggtccacgtgaagcag

SEQ ID NO: 32 - DNA, 37 bp, Artificial
  synthetic
ttatcctcgagcggtaccgaggtgaasstggtggaat

SEQ ID NO: 33 - DNA, 38 bp, Artificial
  synthetic
ttatcctcgagcggtaccgavgtgawgytggtggagtc

SEQ ID NO: 34 - DNA, 38 bp, Artificial
  synthetic
ttatcctcgagcggtaccgaggtgcagskggtggagtc

SEQ ID NO: 35 - DNA, 38 bp, Artificial
  synthetic
ttatcctcgagcggtaccgakgtgcamctggtggagtc

SEQ ID NO: 36 - DNA, 38 bp, Artificial
  synthetic
ttatcctcgagcggtaccgaggtgaagctgatggartc

SEQ ID NO: 37 - DNA, 38 bp, Artificial
  synthetic
ttatcctcgagcggtaccgaggtgcarcttgttgagtc

SEQ ID NO: 38 - DNA, 38 bp, Artificial
  synthetic
ttatcctcgagcggtaccgargtraagcttctcgagtc

SEQ ID NO: 39 - DNA, 38 bp, Artificial
  synthetic
ttatcctcgagcggtaccgaagtgaarsttgaggagtc

SEQ ID NO: 40 - DNA, 40 bp, Artificial
  synthetic
ttatcctcgagcggtacccaggttactctraaagwgtstg

SEQ ID NO: 41 - DNA, 38 bp, Artificial
  synthetic
ttatcctcgagcggtacccaggtccaactvcagcarcc

SEQ ID NO: 42 - DNA, 38 bp, Artificial
  synthetic
ttatcctcgagcggtaccgatgtgaacttggaagtgtc

SEQ ID NO: 43 - DNA, 38 bp, Artificial
  synthetic
ttatcctcgagcggtaccgaggtgaaggtcatcgagtc

SEQ ID NO: 44 - DNA, 39 bp, Artificial
  synthetic
gattggtttgccgctagctgaggagacggtgaccgtggt

SEQ ID NO: 45 - DNA, 39 bp, Artificial
  synthetic
gattggtttgccgctagctgaggagactgtgagagtggt

SEQ ID NO: 46 - DNA, 39 bp, Artificial
  synthetic
gattggtttgccgctagctgcagagacagtgaccagagt

SEQ ID NO: 47 - DNA, 39 bp, Artificial
  synthetic
gattggtttgccgctagctgaggagacggtgactgaggt

SEQ ID NO: 48 - DNA, 39 bp, Artificial
  synthetic
agcaagcggcgcgcatgccgayatccagctgactcagcc

SEQ ID NO: 49 - DNA, 39 bp, Artificial
  synthetic
agcaagcggcgcgcatgccgayattgttctcwcccagtc

SEQ ID NO: 50 - DNA, 39 bp, Artificial
  synthetic
agcaagcggcgcgcatgccgayattktgmtvactcagtc

SEQ ID NO: 51 - DNA, 39 bp, Artificial
  synthetic
agcaagcggcgcgcatgccgayattgtgytracacagtc

SEQ ID NO: 52 - DNA, 39 bp, Artificial
  synthetic
agcaagcggcgcgcatgccgayattgtratgacmcagtc

SEQ ID NO: 53 - DNA, 39 bp, Artificial
  synthetic
agcaagcggcgcgcatgccgayattmagatramccagtc

SEQ ID NO: 54 - DNA, 39 bp, Artificial
  synthetic
agcaagcggcgcgcatgccgayattcagatgaydcagtc

SEQ ID NO: 55 - DNA, 38 bp, Artificial
  synthetic
agcaagcggcgcgcatgccgayatycagatgacacaga

SEQ ID NO: 56 - DNA, 39 bp, Artificial
  synthetic
agcaagcggcgcgcatgccgayattgttctcawccagtc

SEQ ID NO: 57 - DNA, 39 bp, Artificial
  synthetic
agcaagcggcgcgcatgccgayattgwgctsacccaatc

SEQ ID NO: 58 - DNA, 39 bp, Artificial
  synthetic
agcaagcggcgcgcatgccgayattstratgacccartc

SEQ ID NO: 59 - DNA, 39 bp, Artificial
  synthetic
agcaagcggcgcgcatgccgayrttktgatgacccarac

SEQ ID NO: 60 - DNA, 39 bp, Artificial
  synthetic
agcaagcggcgcgcatgccgayattgtgatgacbcagkc

SEQ ID NO: 61 - DNA, 39 bp, Artificial
  synthetic
agcaagcggcgcgcatgccgayattgtgataacycagga

SEQ ID NO: 62 - DNA, 39 bp, Artificial
  synthetic
agcaagcggcgcgcatgccgayattgtgatgacccagwt

SEQ ID NO: 63 - DNA, 39 bp, Artificial
  synthetic
agcaagcggcgcgcatgccgayattgtgatgacacaacc

SEQ ID NO: 64 - DNA, 44 bp, Artificial
  synthetic
agcaagcggcgcgcatgccgacaggctgttgtgactcaggaatc

SEQ ID NO: 65 - DNA, 43 bp, Artificial
  synthetic
gaagttatggtcgaccctccggaacgtttkatttccagcttgg

SEQ ID NO: 66 - DNA, 43 bp, Artificial
  synthetic
gaagttatggtcgaccctccggaacgttttatttccaactttg

SEQ ID NO: 67 - DNA, 43 bp, Artificial
  synthetic
gaagttatggtcgaccctccggaacgtttcagctccagcttgg

SEQ ID NO: 68 - DNA, 43 bp, Artificial
  synthetic
gaagttatggtcgaccctccggaacctaggacagtcagtttgg

SEQ ID NO: 69 - DNA, 33 bp, Artificial
  synthetic
ccggtcgaattcatggtgagcaagggcgaggag

SEQ ID NO: 70 - DNA, 36 bp, Artificial
  synthetic
tgatctggatccgcggccgctttaagtgatcccggc

SEQ ID NO: 71 - DNA, 55 bp, Artificial
  synthetic
ggagggtcgaccagcggttctgggaaaccaggttccggtgaaggctcgagcggta

SEQ ID NO: 72 - DNA, 38 bp, Artificial; identical to SEQ ID NO: 18
  synthetic

SEQ ID NO: 73 - DNA, 54 bp, Artificial
  synthetic
accgctcgagccttcaccggaacctggtttcccagaaccgctggtcgaccctcc

SEQ ID NO: 74 - DNA, 40 bp, Artificial; identical to SEQ ID NO: 20
  synthetic

SEQ ID NO: 75 - DNA, 40 bp, Artificial
  synthetic
tggtgatggtgagtactatccaggcccagcagtgggtttg

SEQ ID NO: 76 - DNA, 39 bp, Artificial
  synthetic
tacctattgcctacggcagccgctggattgttattactc

SEQ ID NO: 77 - DNA, 30 bp, Artificial
  synthetic
catcatcataagcttatttaggtgacacta

SEQ ID NO: 78 - DNA, 90 bp, Artificial
  synthetic
acccggggatccctaatggtgatggtgatggtgagtactatccaggcccagcagtgggtttgggattggtttgccgaccttccgcttctt

SEQ ID NO: 79 - DNA, 804 bp, Artificial
  synthetic
atgtcgaaagctacatataaggaacgtgctgctactcatcctagtcctgttgctgccaagctatttaatatcatgcacgaaaagcaaacaaacttgtgtgcttcattggatgttcgtaccaccaaggaattactggagttagttgaagcattaggtcccaaaatttgtttactaaaaacacatgtggatatcttgactgatttttccatggagggcacagttaagccgctaaaggcattatccgccaagtacaattttttactcttcgaagacagaaaatttgctgacattggtaatacagtcaaattgcagtactctgcgggtgtatacagaatagcagaatgggcagacattacgaatgcacacggtgtggtgggcccaggtattgttagcggtttgaagcaggcggcagaagaagtaacaaaggaacctagaggccttttgatgttagcagaattgtcatgcaagggctccctatctactggagaatatactaagggtactgttgacattgcgaagagcgacaaagattttgttatcggctttattgctcaaagagacatgggtggaagagatgaaggttacgattggttgattatgacacccggtgtgggtttagatgacaagggagacgcattgggtcaacagtatagaaccgtggatgatgtggtctctacaggatctgacattattattgttggaagaggactatttgcaaagggaagggatgctaaggtagagggtgaacgttacagaaaagcaggctgggaagcatatttgagaagatgcggccagcaaaactaa

SEQ ID NO: 80 - DNA, 675 bp, Artificial
  synthetic
atgtctgttattaatttcacaggtagttctggtccattggtgaaagtttgcggcttgcagagcacagaggccgcagaatgtgctctagattccgatgctgacttgctgggtattatatgtgtgcccaatagaaagagaacaattgacccggttattgcaaggaaaatttcaagtcttgtaaaagcatataaaaatagttcaggcactccgaaatacttggttggcgtgtttcgtaatcaacctaaggaggatgttttggctctggtcaatgattacggcattgatatcgtccaactgcatggagatgagtcgtggcaagaataccaagagttcctcggtttgccagttattaaaagactcgtatttccaaaagactgcaacatactactcagtgcagcttcacagaaacctcattcgtttattcccttgtttgattcagaagcaggtgggacaggtgaacttttggattggaactcgatttctgactgggttggaaggcaagagagccccgaaagcttacattttatgttagctggtggactgacgccagaaaatgttggtgatgcgcttagattaaatggcgttattggtgttgatgtaagcggaggtgtggagacaaatggtgtaaaagactctaacaaaatagcaaatttcgtcaaaaatgctaagaaatag

SEQ ID NO: 81 - DNA, 1107 bp, Artificial
  synthetic
atgtctgcccctatgtctgcccctaagaagatcgtcgttttgccaggtgaccacgttggtcaagaaatcacagccgaagccattaaggttcttaaagctatttctgatgttcgttccaatgtcaagttcgatttcgaaaatcatttaattggtggtgctgctatcgatgctacaggtgtcccacttccagatgaggcgctggaagcctccaagaaggttgatgccgttttgttaggtgctgtggctggtcctaaatggggtaccggtagtgttagacctgaacaaggtttactaaaaatccgtaaagaacttcaattgtacgccaacttaagaccatgtaactttgcatccgactctcttttagacttatctccaatcaagccacaatttgctaaaggtactgacttcgttgttgtcagagaattagtgggaggtatttactttggtaagagaaaggaagacgatggtgatggtgtcgcttgggatagtgaacaatacaccgttccagaagtgcaaagaatcacaagaatggccgctttcatggccctacaacatgagccaccattgcctatttggtccttggataaagctaatcttttggcctcttcaagattatggagaaaaactgtggaggaaaccatcaagaacgaattccctacattgaaggttcaacatcaattgattgattctgccgccatgatcctagttaagaacccaacccacctaaatggtattataatcaccagcaacatgtttggtgatatcatctccgatgaagcctccgttatcccaggttccttgggtttgttgccatctgcgtccttggcctctttgccagacaagaacaccgcatttggtttgtacgaaccatgccacggttctgctccagatttgccaaagaataaggttgaccctatcgccactatcttgtctgctgcaatgatgttgaaattgtcattgaacttgcctgaagaaggtaaggccattgaagatgcagttaaaaaggttttggatgcaggtatcagaactggtgatttaggtggttccaacagtaccaccgaagtcggtgatgctgtcgccgaagaagttaagaaaatccttgcttaa

SEQ ID NO: 82 - DNA, 661 bp, Artificial
  synthetic
atgacagagcagaaagccctagtaaagcgtattacaaatgaaaccaagattcagattgcgatctctttaaagggtggtcccctagcgatagagcactcgatcttcccagaaagaggcagaagcagtagcagaacaggccacacaatcgcaagtgattaacgtccacacaggtatagggtttctggaccatatgatacatgctctggccaagcattccggctggtcgctaatcgttgagtgcattggtgacttacacatagacgaccatcacaccactgaagactgcgggattgctctcggtcaagcttttaaagaggccctaggggccgtgcgtggagtaaaaaggtttggatcaggatttgcgcctttggatgaggcactttctagagcggtggtagatctttcgaacaggccgtacgcagttgtcgaacttggtttgcaaagggagaaagtaggagatctctcttgcgagatgatcccgcattttcttgaaagctttgcagaggctagcagaattaccctccacgttgattgtctgcgaggcaagaatgatcatcaccgtagtgagagtgcgttcaaggctcttgcggttgccataagagaagccacctcgcccaatggtaccaacgatgttccctccaccaaaggtgttcttatgtag

SEQ ID NO: 83 - DNA, 4178 bp, Artificial
  synthetic
atgactaacgaaaaggtctggatagagaagttggataatccaactctttcagtgttaccacatgactttttacgcccacaacaagaaccttatacgaaacaagctacatattcgttacagctacctcagctcgatgtgcctcatgatagtttttctaacaaatacgctgtcgctttgagtgtatgggctgcattgatatatagagtaaccggtgacgatgatattgttctttatattgcgaataacaaaatcttaagattcaatattcaaccaacgtggtcatttaatgagctgtattctacaattaacaatgagttgaacaagctcaattctattgaggccaatttttcctttgacgagctagctgaaaaaattcaaagttgccaagatctggaaaggacccctcagttgttccgtttggcctttttggaaaaccaagatttcaaattagacgagttcaagcatcatttagtggactttgctttgaatttggataccagtaataatgcgcatgttttgaacttaatttataacagcttactgtattcgaatgaaagagtaaccattgttgcggaccaatttactcaatatttgactgctgcgctaagcgatccatccaattgcataactaaaatctctctgatcaccgcatcatccaaggatagtttacctgatccaactaagaacttgggctggtgcgatttcgtggggtgtattcacgacattttccaggacaatgctgaagccttcccagagagaacctgtgttgtggagactccaacactaaattccgacaagtcccgttctttcacttatcgcgacatcaaccgcacttctaacatagttgcccattatttgattaaaacaggtatcaaaagaggtgatgtagtgatgatctattcttctaggggtgtggatttgatggtatgtgtgatgggtgtcttgaaagccggcgcaaccttttcagttatcgaccctgcatatcccccagccagacaaaccatttacttaggtgttgctaaaccacgtgggttgattgttattagagctgctggacaattggatcaactagtagaagattacatcaatgatgaattggagattgtttcaagaatcaattccatcgctattcaagaaaatggtaccattgaaggtggcaaattggacaatggcgaggatgttttggctccatatgatcactacaaagacaccagaacaggtgttgtagttggaccagattccaacccaaccctatctttcacatctggttccgaaggtattcctaagggtgttcttggtagacatttttccttggcttattatttcaattggatgtccaaaaggttcaacttaacagaaaatgataaattcacaatgctgagcggtattgcacatgatccaattcaaagagatatgtttacaccattatttttaggtgcccaattgtatgtccctactcaagatgatattggtacaccgggccgtttagcggaatggatgagtaagtatggttgcacagttacccatttaacacctgccatgggtcaattacttactgcccaagctactacaccattccctaagttacatcatgcgttctttgtgggtgacattttaacaaaacgtgattgtctgaggttacaaaccttggcagaaaattgccgtattgttaatatgtacggtaccactgaaacacagcgtgcagtttcttatttcgaagttaaatcaaaaaatgacgatccaaactttttgaaaaaattgaaagatgtcatgcctgctggtaaaggtatgttgaacgttcagctactagttgttaacaggaacgatcgtactcaaatatgtggtattggcgaaataggtgagatttatgttcgtgcaggtggtttggccgaaggttatagaggattaccagaattgaataaagaaaaatttgtgaacaactggtttgttgaaaaagatcactggaattatttggataaggataatggtgaaccttggagacaattctggttaggtccaagagatagattgtacagaacgggtgatttaggtcgttatctaccaaacggtgactgtgaatgttgcggtagggctgatgatcaagttaaaattcgtgggttcagaatcgaattaggagaaatagatacgcacatttcccaacatccattggtaagagaaaacattactttagttcgcaaaaatgccgacaatgagccaacattgatcacatttatggtcccaagatttgacaagccagatgacttgtctaagttccaaagtgatgttccaaaggaggttgaaactgaccctatagttaagggcttaatcggttaccatcttttatccaaggacatcaggactttcttaaagaaaagattggctagctatgctatgccttccttgattgtggttatggataaactaccattgaatccaaatggtaaagttgataagcctaaacttcaattcccaactcccaagcaattaaatttggtagctgaaaatacagtttctgaaactgacgactctcagtttaccaatgttgagcgcgaggttagagacttatggttaagtatattacctaccaagccagcatctgtatcaccagatgattcgtttttcgatttaggtggtcattctatcttggctaccaaaatgatttttaccttaaagaaaaagctgcaagttgatttaccattgggcacaattttcaagtatccaacgataaaggcctttgccgcggaaattgacagaattaaatcatcgggtggatcatctcaaggtgaggtcgtcgaaaatgtcactgcaaattatgcggaagacgccaagaaattggttgagacgctaccaagttcgtacccctctcgagaatattttgttgaacctaatagtgccgaaggaaaaacaacaattaatgtgtttgttaccggtgtcacaggatttctgggctcctacatccttgcagatttgttaggacgttctccaaagaactacagtttcaaagtgtttgcccacgtcagggccaaggatgaagaagctgcatttgcaagattacaaaaggcaggtatcacctatggtacttggaacgaaaaatttgcctcaaatattaaagttgtattaggcgatttatctaaaagccaatttggtctttcagatgagaagtggatggatttggcaaacacagttgatataattatccataatggtgcgttagttcactgggtttatccatatgccaaattgagggatccaaatgttatttcaactatcaatgttatgagcttagccgccgtcggcaagccaaagttctttgactttgtttcctccacttctactcttgacactgaatactactttaatttgtcagataaacttgttagcgaagggaagccaggcattttagaatcagacgatttaatgaactctgcaagcgggctcactggtggatatggtcagtccaaatgggctgctgagtacatcattagacgtgcaggtgaaaggggcctacgtgggtgtattgtcagaccaggttacgtaacaggtgcctctgccaatggttcttcaaacacagatgatttcttattgagatttttgaaaggttcagtccaattaggtaagattccagatatcgaaaattccgtgaatatggttccagtagatcatgttgctcgtgttgttgttgctacgtctttgaatcctcccaaagaaaatgaattggccgttgctcaagtaacgggtcacccaagaatattattcaaagactacttgtatactttacacgattatggttacgatgtcgaaatcgaaagctattctaaatggaagaaatcattggaggcgtctgttattgacaggaatgaagaaaatgcgttgtatcctttgctacacatggtcttagacaacttacctgaaagtaccaaagctccggaactagacgataggaacgccgtggcatctttaaagaaagacaccgcatggacaggtgttgattggtctaatggaataggtgttactccagaagaggttggtatatatattgcatttttaaacaaggttggatttttacctccaccaactcataatgacaaacttccactgccaagtatagaactaactcaagcgcaaataagtctagttgcttcaggtgctggtgctcgtggaagctccgcagcagctta

SEQ ID NO: 84 - DNA, 795 bp, Artificial
  synthetic
atgattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactccaagacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagagcatcaggggctcgcgccagccgaactgttcgccaggctcaaggcgcggatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagagcttggcggcgaatgggctgaccgcttcctcgtgctttacggtatcgccgctcccgattcgcagcgcatcgccttctatcgccttcttgacgagttcttctga

SEQ ID NO: 85 - DNA, 861 bp, Artificial
  synthetic
atgagtattcaacatttccgtgtcgcccttattcccttttttgcggcattttgccttcctgtttttgctcacccagaaacgctggtgaaagtaaaagatgctgaagatcagttgggtgcacgagtgggttacatcgagctggatctcaacagcggtaagatccttgagagttttcgccccgaagaacgttttccaatgatgagcacttttaaagttctgctatgtggtgcggtattatcccgtgttgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaacccgccttgatcgttgggaaccggagctgaatgaagccataccaaacgacgagcgtgacaccacgatgcctgcagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtggatctcgcggtatcattgcagcactggggccagatggtaagccctcccgtatcgtagttatctacacgacggggagtcaggcaactatggatgaacgaaatagacagatcgctgagataggtgcctcactgattaagcattggtaa

SEQ ID NO: 86 - DNA, 660 bp, Artificial
  synthetic
atggagaaaaaaatcactggatataccaccgttgatatatcccaatggcatcgtaaagaacattttgaggcatttcagtcagttgctcaatgtacctataaccagaccgttcagctggatattacggcctttttaaagaccgtaaagaaaaataagcacaagttttatccggcctttattcacattcttgcccgcctgatgaatgctcatccggaatttcgtatggcaatgaaagacggtgagctggtgatatgggatagtgttcacccttgttacaccgttttccatgagcaaactgaaacgttttcatcgctctggagtgaataccacgacgatttccggcagtttctacacatatattcgcaagatgtggcgtgttacggtgaaaacctggcctatttccctaaagggtttattgagaatatgtttttcgtctcagccaatccctgggtgagtttcaccagttttgatttaaacgtggccaatatggacaacttcttcgcccccgttttcaccatgggcaaatattatacgcaaggcgacaaggtgctgatgccgctggcgattcaggttcatcatgccgtttgtgatggcttccatgtcggcagaatgcttaatgaattacaacagtactgcgatgagtggcagggcggggcgtaa

SEQ ID NO: 87 - DNA, 642 bp, Artificial
  synthetic
atagtgatggcacgactaagcttggacgacgtaatttcaatggcgctcaccctgctggacagcgaagggctagagggcttgactacgcgtaagctggcgcagtccctaaaaattgagcaaccgactctgtattggcacgtgcgcaacaagcagactcttatgaacatgctttcagaggcaatactggcgaagcatcacacccgttcagcaccgttaccgactgagagttggcagcagtttctccaggaaaatgctctgagtttccgtaaagcattactggtccatcgtgatggagcccgattgcatatagggacctctcctacgcccccccagtttgaacaagcagaggcgcaactacgctgtctatgcgatgcagggttttcggtcgaggaggctcttttcattctgcaatctatcagccattttacgttgggtgcagtattagaggagcaagcaacaaaccagatagaaaataatcatgtgatagacgctgcaccaccattattacaagaggcatttaatattcaggcgagaacctctgctgaaatggccttccatttcgggctgaaatcattaatatttggattttctgcacagttagatgaaaaaaagcatacacccattgaggatggtaataaatga

SEQ ID NO: 88 - DNA, 801 bp, Artificial
  synthetic
atgagccatattcaacgggaaacgtcttgctcgaggccgcgattaaattccaacatgatgctgatttatatgggtataaatgggctcgcgataatgtcgggcaatcaggtgcacaatctatcgattgtatgggaagcccgatgcgccagagttgtttctgaaacatggaaaggtagcgttgccaatgatgttacagatgagatggtcagactaaactggctgacgaatttatgcctcttccgaccatcaagcattttatccgtactcctgatgatgcatggtactcaccactgcgatccccgggaaaacagcattccaggtattagaagaatatcctgatcaggtgaaaatattgttgatgcgctggcagtgttcctgcgccggttgcattcgatcctgtttgtaattgtccttttaacagcgatcgcgtatttcgtctcgctcaggcgcaacacgaatgaataacggtttggttgatgcgagtgattttgatgacgagcgtaatggcggcctgttgaacaagtctggaaagaaatgcataagcttttgccattctcaccggattagtcgtcactcatggtgatttctcacttgataaccttatttttgacgaggggaaattataggttgtattgatgttggacgagtcggaatcgcagaccgataccaggatcttgcctcctatggaactgcctcggtgagttttctccttcattacagaaacggctttttcaaaatatggtattgataatcctgatatgaataaattgcagtttcatttgatgctcgatgagttttcta

SEQ ID NO: 89 - DNA, 941 bp, Artificial
  synthetic
ctgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaaga

SEQ ID NO: 90 - DNA, 1162 bp, Artificial
  synthetic
catttaagcataaacacgcactatgccgttcttctcatgtatatatatatacaggcaacacgcagatataggtgcgacgtgaacagtgagctgtatgtgcgcagctcgcgttgcattttcggaagcgctcgttttcggaaacgctttgaagttcctattccgaagttcctattctctagctagaaagtataggaacttcagagcgcttttgaaaaccaaaagcgctctgaagacgcactttcaaaaaaccaaaaacgcaccggactgtaacgagctactaaaatattgcgaataccgcttccacaaacattgctcaaaagtatctctttgctatatatctctgtgctatatccctatataacctacccatccacctttcgctccttgaacttgcatctaaactcgacctctacattttttatgtttatctctagtattactctttagacaaaaaaattgtagtaagaactattcatagagtgaatcgaaaacaatacgaaaatgtaaacatttcctatacgtagtatatagagacaaaatagaagaaaccgttcataattttctgaccaatgaagaatcatcaacgctatcactttctgttcacaaagtatgcgcaatccacatcggtatagaatataatcggggatgcctttatcttgaaaaaatgcacccgcagcttcgctagtaatcagtaaacgcgggaagtggagtcaggctttttttatggaagagaaaatagacaccaaagtagccttcttctaaccttaacggacctacagtgcaaaaagttatcaagagactgcattatagagcgcacaaaggagaaaaaaagtaatctaagatgctttgttagaaaaatagcgctctcgggatgcatttttgtagaacaaaaaagaagtatagattctttgttggtaaaatagcgctctcgcgttgcatttctgttctgtaaaaatgcagctcagattctttgtttgaaaaattagcgctctcgcgttgcatttttgttttacaaaaatgaagcacagattcttcgttggtaaaatagcgctttcgcgttgcatttctgttctgtaaaaatgcagctcagattctttgtttgaaaaattagcgctctcgcgttgcatttttgttctacaaaatgaagcacagatgcttcgtt

SEQ ID NO: 91 - DNA, 606 bp, Artificial
  synthetic
atgaaagcgttaacggccaggcaacaagaggtgtttgatctcatccgtgatcacatcagccagacaggtatgccgccgacgcgtgcggaaatcgcgcagcgtttggggttccgttccccaaacgcggctgaagaacatctgaaggcgctggcacgcaaaggcgttattgaaattgtttccggcgcatcacgcgggattcgtctgttgcaggaagaggaagaagggttgccgctggtaggtcgtgtggctgccggtgaaccacttctggcgcaacagcatattgaaggtcattatcaggtcgatccttccttattcaagccgaatgctgatttcctgctgcgcgtcagcgggatgtcgatgaaagatatcggcattatggatggtgacttgctggcagtgcataaaactcaggatgtacgtaacggtcaggtcgttgtcgcacgtattgatgacgaagttaccgttaagcgcctgaaaaaacagggcaataaagtcgaactgttgccagaaaatagcgagtttaaaccaattgtcgttgaccttcgtcagcagagcttcaccattgaagggctggcggttggggttattcgcaacggcgactggctg

SEQ ID NO: 92 - DNA, 236 bp, Artificial
  synthetic
cggcccccccgaccgatgtcagcctgggggacgagctccacttagacggcgaggacgtggcgatggcgcatgccgacgcgctagacgatttcgatctggacatgttgggggacggggattccccggggccgggatttaccccccacgactccgccccctacggcgctctggatatggccgacttcgagtttgagcagatgtttaccgatgcccttggaattgacgagtacggtggg

SEQ ID NO: 93 - DNA, 293 bp, Artificial
  synthetic
atgggtgctcctccaaaaaagaagagaaaggtagctggtatcaataaagatatcgaggagtgcaatgccatcattgagcagtttatcgactacctgcgcaccggacaggagatgccgatggaaatggcggatcaggcgattaacgtggtgccgggcatgacgccgaaaaccattcttcacgccgggccgccgatccagcctgactggctgaaatcgaatggttttcatgaaattgaagcggatgttaacgataccagcctcttgctgagtggagatgcctcctacccttatga

SEQ ID NO: 94 - DNA, 691 bp, Artificial
  synthetic
atgaaagcgttaacggccaggcaacaagaggtgtttgatctcatccgtgatcacatcagccagacaggtatgccgccgacgcgtgcggaaatcgcgcagcgtttggggttccgttccccaaacgcggctgaagaacatctgaaggcgctggcacgcaaaggcgttattgaaattgtttccggcgcatcacgcggattcgtctgttgcaggaagaggaagaagggttgccgctggtaggtcgtgtggctgccggtgaaccacttctggcgcaacagcatattgaaggtcattatcaggtcgaccttccttattcaagccgaatgctgatttcctgctgcgcgtcagcgggatgtcgatgaaagatatcggcattatggatggtgacttgctggcagtgcataaaactcaggatgtacgtaacggtcaggtcgttgtcgcacgtattgatgacgaagttaccgttaagcgcctgaaaaaacagggcaataaagtcgaactgttgccagaaaatagcgagtttaaaccaattgtcgtagatcttcgtcagcagagcttcaccattgaagggctggcggttggggttattcgcaacggcgactggctggaattcccggggatccgtcgaccatggcggccgctcgagtcgacctgcagccaagctaattccgggcgaatttcttatgatttatga

SEQ ID NO: 95 - DNA, 678 bp, Artificial
  synthetic
ggatcccctttcaaaaattcttactttttttttggatggacgcaaagaagtttaataatcatattacatggcattaccaccatatacatatccatatacatatccatatctaatcttacttatatgttgtggaaatgtaaagagccccattatcttagcctaaaaaaaccttctctttggaactttcagtaatacgcttaactgctcattgctatattgaagtacggattagaagccgccgagcgggtgacagccctccgaaggaagactctcctccgtgcgtcctcgtcttcaccggtcgcgttcctgaaacgcagatgtgcctcgcgccgcactgctccgaacaataaagattctacaatactagcttttatggttatgaagaggaaaaattggcagtaacctggccccacaaaccttcaaatgaacgaatcaaattaacaaccataggatgataatgcgattagttttttagccttatttctggggtaattaatcagcgaagcgatgatttttgatctattaacagatatataaatgcaaaaactgcataaccactttaactaatactttcaacattttcggtttgtattacttcttattcaaatgtaataaaagtatcaacaaaaaattgttaatatacctctatactttaacgtcaaggagaaaaaacccggg

SEQ ID NO: 96 - DNA, 451 bp, Artificial
  synthetic
acggattagaagccgccgagcgggtgacagccctccgaaggaagactctcctccgtgcgtcctcgtcttcaccggtcgcgttcctgaaacgcagatgtgcctcgcgccgcactgctccgaacaataaagattctacaatactagcttttatggttatgaagaggaaaaattggcagtaacctggccccacaaaccttcaaatgaacgaatcaaattaacaaccataggatgataatgcgattagttttttagccttatttctggggtaattaatcagcgaagcgatgatttttgatctattaacagatatataaatgcaaaaactgcataaccactttaactaatactttcaacattttcggtttgtattacttcttattcaaatgtaataaaagtatcaacaaaaaattgttaatatacctctatactttaacgtcaaggagaaaaaacc

SEQ ID NO: 97 - DNA, 353 bp, Artificial
  synthetic
aagcttttcatagggtaggggaatttcgggcatgccggtagaggtgtggtcaataagagcgacctcatgctatacctgagaaagcaacctgacctacaggaaagagttactcaagaacaagaattttcgttttaaaacctaagagtcactttaaaatttgtatacacttattttttttataacttatttaataataaaaatcataaatcataagaaattcgcttatttagaagtgtcaacaacgtatctaccaacgatttgacccttttccatcttttcgtaaatttctggcaaggtagacaagccgacaaccttgattggagacttgaccaaacctctggcgaagaagtcca

SEQ ID NO: 98 - DNA, 342 bp, Artificial
  synthetic
gaattcgacacttctaaataagcggatctcctatgccttcacgatttatagtttccattatcaagtatgcctatattagtatatagcatctttagatgacagtgttcgaagtttcacgaataaaagataatattctactttttgctcccaccgcgtttgctagcacgagtgaacaccatccctcgcctgtgagttgtacccattcctctaaactgtagacatggtagcttcagcagtgttcgttatgtacggcatcctccaacaaacagtcggttatagtttgtcctgctcctctgaatcgtctccctcgatatttctcattttccttcgcatgccctcgag

SEQ ID NO: 99 - DNA, 1032 bp, Artificial
  synthetic
atgtccaatttactgaccgtacaccaaaatttgcctgcattaccggtcgatgcaacgagtgatgaggttcgcaagaacctgatggacatgttcagggatcgccaggcgttttctgagcatacctggaaaatgcttctgtccgtttgccggtcgtgggcggcatggtgcaagttgaataaccggaaatggtttcccgcagaacctgaagatgttcgcgattatcttctatatcttcaggcgcgcggtctggcagtaaaaactatccagcaacatttgggccagctaaacatgcttcatcgtcggtccgggctgccacgaccaagtgacagcaatgctgtttcactggttatgcggcggatccgaaaagaaaacgttgatgccggtgaacgtgcaaaacaggctctagcgttcgaacgcactgatttcgaccaggttcgttcactcatggaaaatagcgatcgctgccaggatatacgtaatctggcatttctggggattgcttataacaccctgttacgtatagccgaaattgccaggatcagggttaaagatatctcacgtactgacggtgggagaatgttaatccatattggcagaacgaaaacgctggttagcaccgcaggtgtagagaaggcacttagcctgggggtaactaaactggtcgagcgatggatttccgtctctggtgtagctgatgatccgaataactacctgttttgccgggtcagaaaaaatggtgttgccgcgccatctgccaccagccagctatcaactcgcgccctggaagggatttttgaagcaactcatcgattgatttacggcgctaaggatgactctggtcagagatacctggcctggtctggacacagtgcccgtgtcggagccgcgcgagatatggcccgcgctggagtttcaataccggagatcatgcaagctggtggctggaccaatgtaaatattgtcatgaactatatccgtaccctggatagtgaaacaggggcaatggtgcgcctgctggaagatggcgattag

SEQ ID NO: 100 - DNA, 28 bp, Artificial
  synthetic
gaattcccggggatccgtcgacctgcag

SEQ ID NO: 101 - DNA, 33 bp, Artificial
  synthetic
ggcccagccggccgtcgacgcggccgcctcgag

SEQ ID NO: 102 - DNA, 11 bp, Artificial
  synthetic
gcgcgcatgcc

SEQ ID NO: 103 - DNA, 60 bp, Artificial
  synthetic
tccggagggtcgaccagcggttctgggaaaccaggttccggtgaaggctcgagcggtacc

SEQ ID NO: 104 - DNA, 48 bp, Artificial
  synthetic
gctagcggcaaaccaatcccaaacccactgctgggcctggatagtact